(19) United States
(12) Patent Application Publication
(10) Pub. No.: US 2005/0098926 A1
(43) Pub. Date: May 12, 2005

(54) Method of manufacturing hot formed object, and device and method for continous high-frequency heating

(76) Inventors: Tomoya Tamura, Osaka-shi (JP); Naoyuki Okuda, Osaka-shi (JP); Yoshiyuki Otani, Osaka-shi (JP); Tsutomu Kosaka, Osaka-shi (JP); Yasuo Shinomiya, Osaka-shi (JP); Toshitaka Haruta, Osaka-shi (JP); Taizo Karasawa, Osaka-shi (JP); Yoshio Akesaka, Osaka-shi (JP); Masato Yanagitani, Osaka-shi (JP); Tsuneo Nagata, Osaka-shi (JP); Yasuji Yamamoto, Osaka-shi (JP)

Correspondence Address: HARNESS, DICKEY & PIERCE, P.L.C., P.O. BOX 8910, RESTON, VA, 20195, US

(21) Appl. No.: 10/477,114

(22) PCT Filed: May 7, 2002
(86) PCT No.: PCT/JP02/04437

(30) Foreign Application Priority Data
May 9, 2001 (JP) 2001-139254
May 9, 2001 (JP) 2001-139256
May 9, 2001 (JP) 2001-139257

(51) Int. Cl. A23L 1/00

(52) U.S. Cl. 264/402; 426/512; 99/324

(57) ABSTRACT

Raw materials are portioned in a plurality of molds, which are continuously moved and transferred to a heating area by a conveyer. The heating area is divided into a plurality of sub-areas, each of which has power source means and power feeding means. The raw materials are heated and molded by applying high frequency to the molds from the power feeding means. Even if the heating apparatus is large, it is possible to restrain or prevent concentration of high-frequency energy since the heating area is divided into sub-areas.

### TECHNICAL FIELD

The present invention relates to a method for manufacturing heated and molded articles by heating raw materials fed in molds, especially a method for manufacturing heated and molded articles, including a process for dielectrically heating raw materials by applying high-frequency alternating current to molds. In addition, the present invention relates to an apparatus and a method for high-frequency heating to heat objects placed between electrodes by applying high-frequency alternating current, especially a continuous dielectric heating apparatus and a continuous high-frequency heating method, wherein the objects can be dielectrically heated by applying high-frequency alternating current to the continuously moving electrodes with no contact, for example, which can be desirably used as a method for manufacturing the heated and molded articles.

### BACKGROUND ART

A high-frequency heating method has been known as an art capable of effectively performing heat treatment on an object to be heated. More particularly, a high-frequency heating method is, in general, a method to dielectrically heat the object by applying high-frequency alternating current (hereinafter referred to as high frequency) to a pair of opposite electrodes which the object is placed between. This art has an advantage not only that the object can be uniformly heated, but also that it is easier to control heating, by using dielectric heating.

Generally, in the heating technique using high frequency, the position of the heating electrodes is almost fixed. When the objects to be heated are transferred to the heating electrodes and stopped therein, high frequency is applied for heating. For example, this high-frequency heating technique is used for manufacturing plywood or veneer, disclosed in (A) “Patent No. Hei 11-42755 (publication dated Feb. 16, 1999)” of the Japanese unexamined patent application publication.

The above art (A) uses an apparatus equipped with two high-frequency heating parts; a first high-frequency heating part performing high-frequency heating, where a plate-type material to be heated is placed between a pair of plate-type opposite electrodes (heating electrodes or electrodes), and a second high-frequency heating part performing high-frequency heating where a material to be heated is placed between an upper latticed electrode and a lower latticed electrode, consisting of bar-type electrodes placed in parallel facing to a surface of the plate-type material to be heated.

For example, an adhesive is applied to a surface on a core material consisting of a wood frame and a metal frame, and another surface material is attached to the core material to make materials to be heated. The materials are transferred to the first high-frequency heating part by a conveyer in order to be applied to high frequency heating, and then transferred to the second high-frequency heating part in order to be applied to high frequency heating again.

Thus, in this art, high-frequency heating is performed on the material to be heated by combination of different heating electrodes, not only by high-frequency heating. Even if a core material included in the material to be heated, consists of several kinds of materials having a different electrical property, it is possible to effectively attach a surface material to the core material by performing a combination of high-frequency heating parts with a different heating property.

The high-frequency heating part in the above art (A), will be particularly explained below. A pair of electrodes is used in combination both on the first high-frequency heating part and on the second high-frequency heating part. One electrode is a feeder electrode block connected to a power source section, and the other electrode is a grounding electrode block connected to the earth. Each of the blocks may consist of an electrode or electrodes.

When high frequency is applied, the objects to be heated are placed between the blocks being insulated from each other. Accordingly, high frequency applied between the blocks can heat the objects.

If there is any electrification between the feeder electrode and the grounding electrode to be insulated from each other, a spark is generated between the electrodes, which cause problems of damage to the electrodes or a scorch on the objects to be heated. Usually, a spark-detecting circuit anticipates a spark between the electrodes. More specifically, the spark-detecting circuit detects a spark by applying direct current between the electrodes and measuring a resistance value therein to check for any electrification.

For example, as shown in FIG. 51, five heating units 10 consisting of the electrodes 11 and 12 with the objects 14 to be heated in between, are fixed in a heating zone to apply high frequency from the power source section 2. The spark-detecting circuit 51 is connected to the feeder electrode block and the grounding electrode block in the heating units 10 in order to anticipate a spark. To prevent high frequency from flowing into the spark-detecting circuit 51, a high-frequency filter 52 is provided.

The above heating condition is shown as a parallel circuit of a condenser in FIG. 52. More specifically, the part corresponding to each of the heating units 10 constitutes a condenser. Each condenser is in parallel on the circuit. While the electrode 12 (feeder electrode) constituting the condenser (heating unit 10) is connected to the power source section 2, the other electrode 13 (grounding electrode) is grounded to the earth. In addition, the spark-detecting circuit 51 is connected to the electrodes 12 and 13. The high-frequency filter 52 and a direct current power source section 54 are provided between the electrode 12 (feeder electrode) and the spark-detecting circuit 51.

In the above structure, the spark-detecting circuit 51 checks for electrification by applying direct current between the electrodes 12 and 13 insulated from each other, that is, in the heating units 10. Since any electrification is more likely to generate a spark, the spark-detecting circuit 51 anticipates a spark, sends out a kind of control signal, and stops applying high frequency from the power source section 2.

By the way, an art for manufacturing molded articles by using molds such as metal molds, portioning raw materials for molding (raw materials) in the molds and heating (hereinafter referred to as a method for heating molds), has been widely used.

The above method for heating molds has been widely used also for manufacturing molded and baked confectioneries including edible containers such as cones, Monaka, and wafers, etc. In a technical field of manufacturing the molded and baked confectioneries, various kinds of starch is a main ingredient. A mixture of water and starch, for example, viscose dough or slurry dough, is used.

A technical field of molding the watery mixture primarily containing starch through the method for heating molds, is applied not only to make the molded and baked confectioneries, but also to make biodegradable molded articles. In this specification, the articles attained by heating and molding the watery mixture primarily containing starch, for example, molded and baked confectioneries and biodegradable molded articles, are referred to as baked and molded articles.

In the above method for heating molds, an external heating method that metal molds are simply heated and raw materials are heated and molded through thermal conduction, was conventionally utilized. However, the conventional external heating method needs a long molding time with less production efficiency. It also causes uneven baking and thereby uneven molded articles due to unequal temperature inside or between molds. Thus, in recent years the above-mentioned high-frequency heating method has been widely used as the method for heating molds.

In general, the high-frequency heating method is a method to dielectrically heat raw materials by applying high frequency to molds (equivalent to heating electrodes), which has advantages of uniformly heating and molding raw materials and easy heating control.

The above-mentioned method to temporarily suspend the objects to be heated for application of high frequency is effective for objects of relatively large size and relatively high unit cost, such as plywood or veneer, as the above-mentioned art (A). However, this method is ineffective for objects of relatively small size and relatively low unit cost, as the above molded articles.

To solve the above problems, the applicants previously proposed an art using a continuous manufacturing process that many molds are continuously transferred and heated in order to improve production efficiency in production of biodegradable molded articles by high-frequency heating, disclosed in (B) “Patent No. Hei 10-230527 (publication dated Sep. 2, 1998)” of the Japanese unexamined patent application publication.

In the production of baked and molded articles including baked and molded confectioneries, the continuous manufacturing process that many metal molds are continuously transferred and heated, is generally used to improve production efficiency. According to the above art (B), in the continuous manufacturing process, no contact on method is adopted that high frequency is applied to heating electrodes (i.e. generically called heating units including metal molds or molds) without direct contact on thereof.

For example, as shown in FIG. 24, in the manufacturing apparatus disclosed in the above unexamined patent application publication, the metal molds 7 are moved to the direction of the arrow shown in the figure by a conveyer 6 (moving means or conveyer means) disposed in no-end plate-type layout. In a heating zone B (heating area) performing dielectric heating, a power feeding section 3 (power feeding means) is placed along the conveyer 6. Also, a power receiving section (power receiving means) matching to the power feeding section 3 with no contact is provided on the metal molds 7 (not shown in FIG. 24). The power feeding section 3 and the power receiving section constitute a high-frequency power feeding and receiving section.

When the metal molds 7 wherein the raw materials are fed are transferred by the conveyer 6 and reach the heating zone B, high frequency is applied to the metal molds 7 from the power feeding section 3 with no contact, and the raw materials inside the metal molds 7 (raw materials for molding) are dielectrically heated. In result, the raw materials can be heated effectively and steadily, and the molded articles can be made with excellent moldability and physical property.

Namely, in the above art (B), it is possible to apply high frequency to the continuously moving metal molds 7 from the power feeding section 3 provided in the heating zone B. Thus, when applying high frequency, it is possible to dielectrically heat the raw materials inside the metal molds 7 without suspending the application. In result, the manufacturing process can be easily controlled and production efficiency of the biodegradable molded articles is also improved.

Especially, in the continuous manufacturing process according to the above art (B), a “no contact on” method is used that high frequency is applied to heat the metal molds 7, i.e., the heating electrodes, without direct contact on with the power feeding section 3, giving an advantage that generation of a spark can be restrained between the power feeding section 3 and the metal molds 7 in the heating zone.

Thus, it is possible not only to heat all of the objects to be heated uniformly through high-frequency heating, transferring and continuously heating the objects by the moving means, but also to reduce a heating time for some kinds of objects.

Whereas in the art (B), for example, making a large-scale manufacturing equipment for improving production efficiency practically causes problems of generation of a spark, dielectric breakdown and an arc, as mentioned below.

First, in the art (B), when high frequency is applied to the entire heating zone B, localization of high frequency is found on part of the heating zone B. Therefore, if a manufacturing apparatus becomes larger, concentration of high-frequency energy is generated due to the localization of high frequency, thereby giving problems such as overheating of the raw materials wherein high frequency is localized, a spark or dielectric breakdown between the metal molds 7 (electrodes) in the localized area, as well as generation of a spark at the power feeding and receiving section even with no contact.

In other words, in the large-scale manufacturing apparatus, the apparatus becomes very large on a whole. Moreover, for the purpose of improving production efficiency, not only in the large-scale apparatus, but also in many apparatuses, a united metal mold is used which consists of many metal molds 7, for example, placed in parallel and transferred by the conveyer 6. Thus, the number of metal molds 7 transferred to the heating zone B significantly increases accordingly.

Therefore, if the manufacturing apparatus becomes larger, the number of raw materials in the metal molds 7 significantly increases. In the heating zone B, a larger output of high frequency must be applied in proportion to the number of raw materials.

More particularly, for example, in a small manufacturing apparatus, as shown in FIG. 24, twenty-two metal molds 7 are mounted on an outer periphery of the conveyer 6, and eleven metal molds 7 may be heated in the heating zone B. If a high-frequency output applied from the power source section 2 is set at 9 kW, the high-frequency output applied to each of the metal molds 7 is about 0.8 kW.

In this case, since the high-frequency output is not so large in the entire heating zone B, large high-frequency energy does not concentrate even if high frequency is localized on a certain position in the heating zone B. Accordingly, overheating or a spark is not generated, and there is little influence on the production of the molded articles. In other words, the art disclosed in the above Japanese unexamined patent application publication is a very preferable art for a small-scale manufacturing apparatus.

On the other hand, in a large-scale manufacturing apparatus, a high-frequency output in the entire heating zone becomes very large, and high-frequency energy increasingly concentrates on part of the heating zone. In result, concentration of high-frequency energy, which is not almost found in a small-scale manufacturing apparatus, causes overheating, a spark or dielectric breakdown. It is thus difficult to use the art disclosed in the above-mentioned unexamined patent application publication for a large-scale manufacturing apparatus.

More particularly, as shown in FIG. 25, thirty-six united metal molds 5 are mounted on an outer periphery of the conveyer 6 and twenty-five united metal molds 5 may be heated in the heating zone B. If the united metal mold 5 is, for example, a unit consisting of five metal molds 7, an output from the power source section 2 should be set at 100 kW to apply about 0.8 kW high frequency to each of the metal molds 7, as the above small manufacturing apparatus. In the above example, it is simply calculated that high-frequency energy up to more than 10 times as that of the small manufacturing apparatus may be concentrated.

In addition, in the large-scale manufacturing apparatus, a length of the power feeding section 3 located in the heating zone B is longer than that for a small-scale manufacturing apparatus. For example, a length of the power feeding section 3 equals to eleven metal molds 7 in FIG. 24, while it equals to twenty-five metal molds 7 (united metal molds 5) in FIG. 25. Depending on a shape of the power feeding section 3, a high-frequency potential is more likely to be localized, thereby practically making it difficult to provide the power feeding section 3 longer than a specific length.

Namely, high-frequency energy more than what can be simply calculated from the length (width) of the heating zone B or the number of united metal molds 5 is more likely to concentrate. To prevent the concentration of high-frequency energy, it is necessary to limit a length of the power feeding section 3, that is, a length of the heating zone B, and thereby significantly reducing efficiency of heating and molding.

Next, utilization of the above spark-detecting circuit 51 in the above art (B) gives problems that an arc is generated at part of the feeder electrode of the heating units 10 at the moment of contacting or leaving a contactor terminal to apply direct current to the heating units 10.

More specifically, when the spark-detecting circuit 51 is used for a continuous heating process, as shown in FIG. 53, a plurality of spark-sensing parts (contactor terminals) 53 is disposed along the moving passage of the heating units 10. The spark-sensing parts 53 are brought to contact on an optional position on the feeder electrode of the heating units 10 (power receiving section 4 in FIG. 53) from the power receiving section 4 to anticipate a spark with the spark-detecting circuit 51. The power feeding section 3 and the power receiving section 4 constitute the power feeding and receiving section 11. For convenience, the position where the spark-sensing part 53 contacts, that is, the optional position on the feeder electrode of the heating units 10 including the power receiving section 4 is named a contact position of the spark-sensing part.

A circuit diagram of the above structure is basically the same as that of the fixed circuit diagram (FIG. 52) as shown in FIG. 54, while in the above continuous heating process, the power feeding section 3 and power receiving section 4, that is, the power feeding and receiving section 11 makes a condenser, since high frequency is applied with no contact. The heating units 10 move to the direction of the arrow for both in FIG. 53 and FIG. 54.

In the structure of the continuous heating process, the heating units 10 continuously transferred along the moving passage, and in the heating zone, the spark-sensing parts 53 are disposed so that the heating units 10 may contact on at least more than one of the spark-sensing parts 53, wherever the heating units 10 are positioned. Thus, it is possible to continuously anticipate a spark on each of the heating units 10 in the heating zone also in the continuous heating process.

In the structure of the spark-detecting circuit 51, taking notice of the spark-sensing parts 53, they do not always contact on with the power receiving section 4, repeating contact and no contact condition with the movement of the heating units 10. Furthermore, in the continuous heating process' there is a big potential difference between the adjacent heating units 10 and 10 (power receiving sections 4 and 4) when the heating units 10 enter or leave the heating zone or at an initial heating stage. In result, an arc is generated at the moment when the spark-sensing parts 53 contact on or leave the heating units 10 and 10.

For example, as shown in FIG. 53, there is a big potential difference between the heating unit 10-1 just before entering into the heating zone (the left-most heating unit 10 in the figure) and the heating unit 10-2 just after high frequency starts to be applied from the power feeding section 3 (the heating unit 10 adjacent to the heating unit 10-1). Then, a potential of the spark-sensing part 53a increases, before contacting the contact position of the spark-sensing part of the heating unit 10-1 having a lower potential, connected to the spark-sensing part 53b contacting the contact position of the spark-sensing part of the heating unit 10-2 having a higher potential. Accordingly, an arc is generated between the spark-sensing part 53a and the heating unit 10-1 at the moment when the spark-sensing part 53a contacts the heating unit 10-1.

As described above, when an arc is generated between the heating unit 10-1 and the spark-sensing part 53a, the spark-detecting circuit 51 malfunctions or the contact position of the spark-sensing part 53a gets damages or imperfect contact, giving a problem that a resistance value thereat increases and a spark cannot be anticipated correctly.

The present invention was made in consideration with the above problems. An objective of the present invention is to provide a method and an apparatus for continuous high-frequency heating, and a method for manufacturing heated and molded articles, accomplishing effective and safe heating which can effectively restrain or prevent concentration of high-frequency energy when in a large-scale equipment continuously moving objects to be heated, for example, raw materials fed in molds, are heated through high frequency heating. Another objective of the present invention is to further effectively perform continuous dielectric heating by using a new spark-detecting method to prevent an arc at a spark-sensing part and to monitor a spark exactly, when the spark-detecting method is used for the continuous high-frequency heating.

### DISCLOSURE OF INVENTION

After full consideration, the applicants of the present invention learned that the above objectives can be accomplished and the present invention can be completed by dividing a heating area into sub-areas and by using spark-detecting means equipped with independent filters for each of the spark-sensing parts.

In other words, in the method for manufacturing heated and molded articles in accordance with the present invention, wherein raw materials are fed in electrically conductive molds, continuously transferring the molds along a moving passage, and the continuously applying high frequency alternating current to the moving molds with no contact from the heating area provided along the moving passage in order to mold the raw materials through dielectric heating, the heating area is divided into sub-areas, each of which has power source means and power feeding means.

In the above method, when high-frequency alternating current (high frequency) is continuously applied to the continuously moving molds with no contact, the heating area wherein high frequency is applied, is divided into sub-areas, each of which has power source means and power feeding means, thereby restraining or preventing concentration of high-frequency energy in the heating zone. In result, overheating or dielectric breakdown is effectively prevented, and heated and molded articles can be produced very efficiently and steadily.

Additionally, in a continuous high-frequency heating apparatus in accordance with the present invention, comprising heating units where the objects to be heated are placed between a pair of electrodes, moving means which continuously transfer the heating units along a moving passage, and power feeding means provided along the moving passage, and dielectrically heating the objects by continuously applying high frequency to the moving heating units from the power feeding means, additional power feeding means are included, each of which has power source means, and the heating area is formed by continuously disposing the power feeding means.

According to the above structure, when high-frequency alternating current (high frequency) is continuously applied to the continuously moving heating units, the heating area wherein high frequency is applied, is divided into sub-areas, each of which has power source means and power feeding means, thereby preventing concentration of high-frequency energy in the heating area. In result, it is possible to prevent overheating of the object to be heated or dielectric breakdown effectively and to perform very quality heating treatment.

Or in another continuous high-frequency heating apparatus in accordance with the present invention, comprising heating units where the objects to be heated are placed between a pair of electrodes, conveyer means which continuously transfers the heating units along a moving passage, and power feeding means disposed in correspondence to a heating area provided along the moving passage, and dielectrically heating the objects by continuously applying high frequency to the moving heating units from the power feeding means, spark-detecting means to anticipate a spark between the electrodes is provided. The spark-detecting means includes a plurality of spark-sensing parts to be placed near the heating area along the moving direction of the heating units in order to be contacted on either of the electrodes in the moving heating units, and a high-frequency filter individually provided for the spark-sensing part at least on a position corresponding to a position having a potential difference between the adjacent heating units, out of the above spark-sensing parts.

In the above structure, it is possible to prevent high frequency from flowing between the spark-sensing parts connected on the circuit, thereby preventing an arc generated at the moment when the spark-sensing parts contact on or leave the contact position of the spark-sensing parts of the heating units. In result, it is possible to effectively prevent malfunctioned detection of a spark or damages on the spark-sensing parts.

Additionally, in a continuous high-frequency heating method in accordance with the present invention, having the heating units where the objects to be heated are placed between a pair of electrodes, continuously moving the heating units along the moving passage, and dielectrically heating the objects by continuously applying high frequency to the heating units with no contact from the heating area provided along the moving passage, a spark is anticipated between the electrodes by the spark-detecting means including a plurality of spark-sensing parts placed near the heating area along the moving direction of the heating units so that the spark-sensing parts contact on either of the electrodes in the moving heating units, and the high-frequency filter for the spark-sensing parts individually placed at least on a position corresponding to a position having a potential difference between the adjacent heating units, out of the above spark-sensing parts.

According to the above method, it is possible to prevent high frequency from flowing between the spark-sensing parts connected on the circuit, and to prevent an arc at the moment when the spark-sensing parts contact on or leave the contact position of the spark-sensing parts of the heating units, which can effectively prevent malfunctioned detection of a spark and damages on the spark-sensing parts.

Another objects, features, and merits will appear more fully from the following description. Also, advantages of the present invention will be apparent from the following description taken in connection with the accompanying drawings wherein.

### BRIEF DESCRIPTION OF DRAWINGS

FIG. 1 is a diagrammatic illustration showing an example of an outlined structure of a manufacturing apparatus used in a manufacturing method in accordance with an embodiment in the present invention.

FIG. 2 is a circuit diagram showing an outlined structure of the manufacturing apparatus shown in FIG. 1.

FIGS. 3(a) and (b) are perspective views showing an example of united metal molds used for the manufacturing apparatus shown in FIG. 1.

FIGS. 4(a) and (b) are perspective views showing another example of united metal molds used for the manufacturing apparatus shown in FIG. 1.

FIG. 5 is a bird's-eye view showing an example of a configuration of cone cups as molded articles made by a manufacturing method in accordance with the present invention. FIG. 5(b) is a cross sectional view as seen along the line D-D of FIG. 5 (a).

FIG. 6(a) is a bird's-eye view of an example of a configuration of a waffle cone as a molded article made by a manufacturing method in accordance with the present invention. FIG. 6(b) is a cross sectional view as seen along the line E-E of FIG. 6(a).

FIG. 7(a) is a bird's-eye view showing an example of a configuration of a tray as a molded article made by a manufacturing method in accordance with the present invention. FIG. 7(b) is a cross sectional view as seen along the line F-F of FIG. 7(a).

FIGS. 8(a) and (b) are diagrammatic illustrations showing an example of a layout of the conveyer included in the manufacturing apparatus shown in FIG. 1.

FIGS. 9(a) and (b) are diagrammatic illustrations showing an example of a structure for a gas heating section as external heating means included in the manufacturing apparatus shown in FIG. 1.

FIGS. 10(a), (b), and (c) are diagrammatic illustrations showing an example of a structure of a power feeding and receiving section included in the manufacturing apparatus shown in FIG. 1.

FIGS. 11(a) and (b) are diagrammatic illustrations showing an example of a more specific structure of the power feeding and receiving section shown in FIG. 10.

FIG. 12 is a diagrammatic illustration showing another example of an outlined structure of the manufacturing apparatus shown in FIG. 1.

FIG. 13 is a diagrammatic illustration showing still another example of an outlined structure of the manufacturing apparatus shown in FIG. 1.

FIG. 14 is a diagrammatic illustration showing an example of an outlined structure of a manufacturing apparatus used in a manufacturing method in accordance with another embodiment in the present invention.

FIG. 15 is a diagrammatic illustration showing another example of an outlined structure of the manufacturing apparatus shown in FIG. 14.

FIG. 16 is a diagrammatic illustration showing another example of an outlined structure of the manufacturing apparatus shown in FIG. 14.

FIG. 17 is a diagrammatic illustration showing an example of an outlined structure of a manufacturing apparatus used in a manufacturing method in accordance with still another embodiment in the present invention.

FIG. 18 is a diagrammatic illustration showing another example of an outlined structure of the manufacturing apparatus shown in FIG. 17.

FIGS. 19(a) and (b) are diagrammatic illustrations showing an example of a structure of the gas heating section as external heating means included in the manufacturing apparatus shown in FIG. 18.

FIGS. 20(a) and (b) are diagrammatic illustrations showing an example of a disposition of a conveyer included in a manufacturing apparatus used in a manufacturing method in accordance with still another embodiment in the present invention.

FIGS. 21(a) and (b) are diagrammatic illustrations showing another example of a disposition of the conveyer included in the manufacturing apparatus used in the manufacturing method in accordance with still another embodiment in the present invention.

FIGS. 22(a) and (b) are diagrammatic illustrations showing still another example of a disposition of the conveyer included in the manufacturing apparatus used in the manufacturing method in accordance with still another embodiment in the present invention.

FIGS. 23(a) and (b) are diagrammatic illustrations showing still another example of the layout for the conveyer included in the manufacturing apparatus used in the manufacturing method in accordance with still another embodiment in the present invention.

FIG. 24 is a diagrammatic illustration showing an example of an outlined structure of a conventional manufacturing apparatus.

FIG. 25 is a diagrammatic illustration showing an example of an outlined structure in case that the conventional manufacturing apparatus is made larger.

FIG. 26 is a diagrammatic illustration showing an example of an outlined structure of a manufacturing apparatus used in a manufacturing method in accordance with still another embodiment in the present invention.

FIG. 27 is a diagrammatic illustration showing another example of an outlined structure of the manufacturing apparatus shown in FIG. 26.

FIGS. 28(a) and (b) are diagrammatic illustrations showing a condition in case that plate-type power receiving sections are inserted in the neighborhood of an inlet at a rail-shaped power feeding section shown in FIG. 10 (a) to (c).

FIGS. 29(a) and (b) are diagrammatic illustrations showing a condition in case that plate-type power receiving sections are inserted in the neighborhood of an inlet at a rail-shaped power feeding section for a manufacturing apparatus used in a manufacturing method in accordance with still another embodiment in the present invention.

FIGS. 30(a) and (b) are diagrammatic illustrations showing another example of a condition in case that plate-type power receiving sections are inserted in the neighborhood of an outlet at a rail-shaped power feeding section for a manufacturing apparatus shown in FIGS. 29(a) and (b).

FIGS. 31(a) and (b) are diagrammatic illustrations showing a condition in case that the plate-type power receiving sections are inserted in the neighborhood of an outlet at the rail-shaped power feeding section shown in FIG. 10(a) to (c).

FIGS. 32(a) and (b) are diagrammatic illustrations showing a condition in case that plate-type power receiving sections are inserted in the neighborhood of an outlet at a rail-shaped power feeding section for a manufacturing apparatus used in a manufacturing method in accordance with still another embodiment in the present invention.

FIGS. 33(a) and (b) are diagrammatic illustrations showing another example of a condition in case that the plate-type power receiving sections are inserted in the neighborhood of an inlet at the rail-shaped power feeding section for the manufacturing apparatus shown in FIGS. 32(a) and (b).

FIG. 34(a) is a diagrammatic illustration showing a change in the number of power receiving sections inserted into the rail-shaped power feeding section including R-member for a manufacturing apparatus used in a manufacturing method in accordance with still another embodiment in the present invention. FIG. 34(b) is a graph showing a change in anode current accompanying a change in the number of the power receiving sections inserted.

FIG. 35(a) is a diagrammatic illustration showing a change in the number of power receiving sections inserted in a rail-shaped power feeding section including R-member for a manufacturing apparatus used in a manufacturing method in accordance with still another embodiment in the present invention. FIG. 35(b) is a graph showing a change in anode current accompanying a change in the number of the power receiving sections inserted.

FIG. 36(a) is a diagrammatic illustration showing a change in the number of the power receiving sections inserted in the rail-shaped power feeding section consisting of straight-line members for the manufacturing apparatus used in the manufacturing method in accordance with still another embodiment in the present invention. FIG. 36(b) is a graph showing a change in anode current accompanying a change in the number of the power receiving sections inserted.

FIG. 37 is a diagrammatic illustration showing an example of an outlined structure for a heating apparatus in accordance with still another embodiment in the present invention.

FIGS. 38(a) and (b) are diagrammatic illustrations showing an example of a layout for the conveyer included in the heating apparatus shown in FIG. 37.

FIG. 39 is a diagrammatic illustration showing an example of an outlined structure of a heating apparatus in accordance with still another embodiment in the present invention.

FIG. 40 is a diagrammatic illustration showing an example of an outlined structure of a heating apparatus in accordance with still another embodiment in the present invention.

FIG. 41 is a diagrammatic illustration showing an example of an outlined structure of main parts for a heating apparatus in accordance with still another embodiment in the present invention.

FIG. 42 is a circuit diagram showing an outlined structure of the entire heating apparatus shown in FIG. 41.

FIG. 43 is a diagrammatically sectional view showing an example of a metal mold and a power feeding and receiving section for the heating apparatus shown in FIG. 41.

FIG. 44 is a circuit diagram schematically corresponding to the main parts for the heating apparatus shown in FIG. 41.

FIG. 45 is a diagrammatic illustration showing another example of the main parts for the heating apparatus shown in FIG. 41.

FIG. 46 is a circuit diagram schematically corresponding to the main parts for the heating apparatus shown in FIG. 45.

FIG. 47 is a diagrammatic illustration showing an example of an outlined structure of main parts for a heating apparatus in accordance with still another embodiment in the present invention.

FIG. 48 is a circuit diagram schematically corresponding to the main parts for the heating apparatus shown in FIG. 47.

FIG. 49 is a diagrammatic illustration showing another example of the main parts for the heating apparatus shown in FIG. 47.

FIG. 50 is a circuit diagram schematically corresponding to the main parts for the heating apparatus shown in FIG. 49.

FIG. 51 is an explanatory illustration showing an outlined structure of main parts for a conventional heating apparatus.

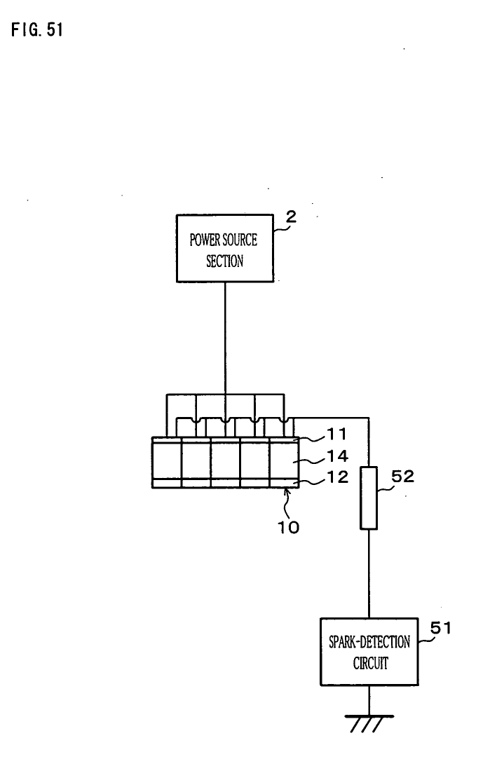

FIG. 52 is a circuit diagram schematically corresponding to the main parts for the conventional heating apparatus shown in FIG. 51.

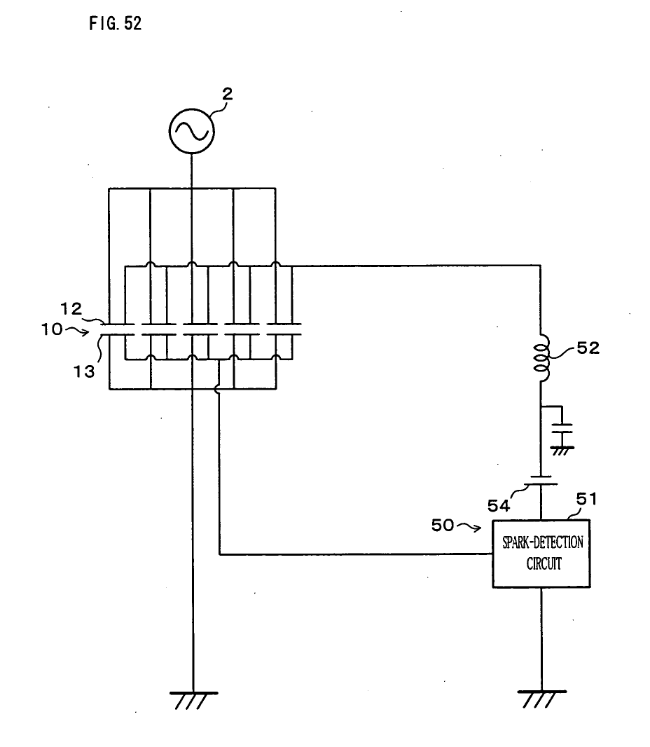

FIG. 53 is a diagrammatic illustration showing an outlined structure of the main parts in case that the conventional heating apparatus shown in FIG. 51 is used for a continuous heating apparatus.

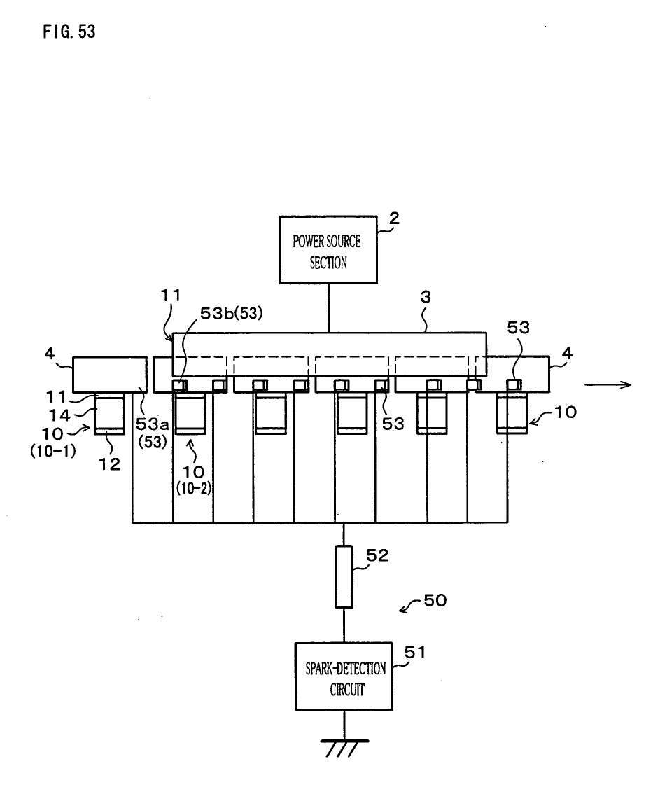

FIG. 54 is a circuit diagram schematically corresponding to the main parts for the heating apparatus shown in FIG. 53.

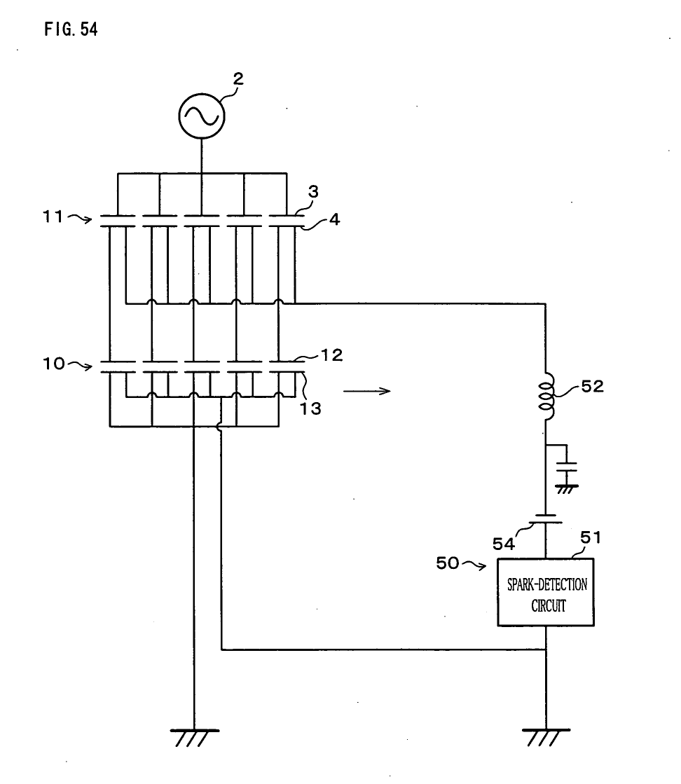

FIG. 55(a) is an explanatory illustration showing an example of a condition whereat a potential difference is generated between the metal molds in the heating apparatus shown in FIG. 53. FIG. 55(b) is a graph showing a potential corresponding to the position of the metal molds in FIG. 55(a).

FIG. 56 is an explanatory illustration showing another example of a condition whereat a potential difference is generated between the metal molds in the heating apparatus shown in FIG. 53. FIG. 56(b) is a graph showing a potential corresponding to the position of the metal molds in FIG. 56(a).

### BEST MODE FOR CARRYING OUT THE INVENTION

### EMBODIMENT 1

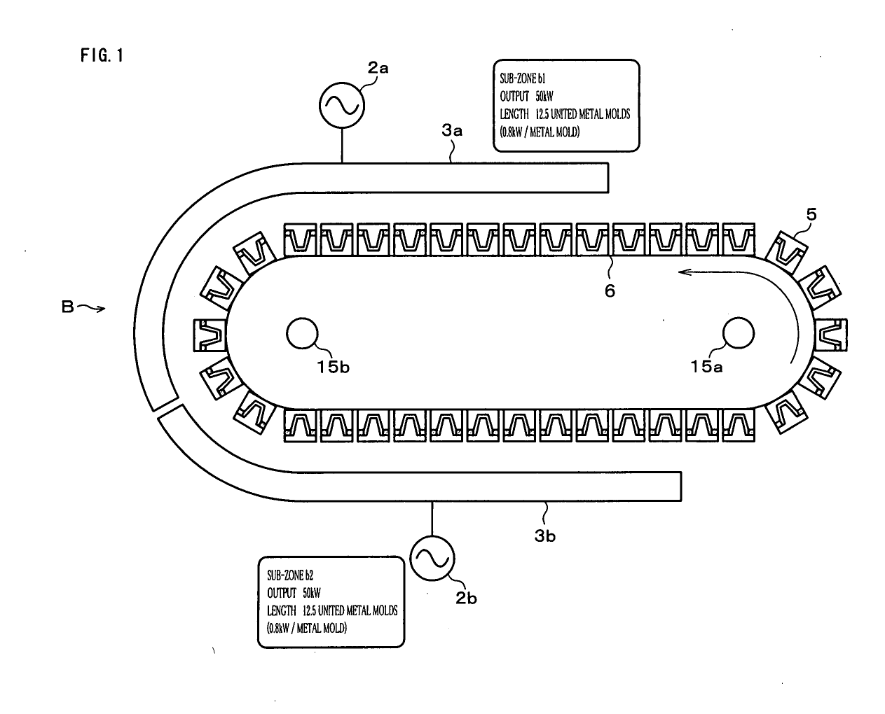

An embodiment of the present invention is explained below referring to FIG. 1 to FIG. 13. However, the present invention is not limited to this embodiment.

In a method for manufacturing heated and molded articles in accordance with the present invention, continuously transferring the molds wherein raw materials for molding are placed, passing through an area where high-frequency alternating current is applied (heating zone), and heating and molding the raw materials by generating dielectric heating, in particular, the heating zone is divided into sub-zones, each of which has a power source section (an oscillator).

Also, in a continuous high-frequency heating apparatus in accordance with the present invention, continuously transferring objects to be heated with electrodes, passing through an area where high-frequency alternating current is applied (heating zone), and generating dielectric heating on the objects, this heating zone is divided into sub-zones, each of which has a power source section (oscillator).

The present invention may be used as long as dielectric heating is generated on the objects to be heated by applying high-frequency alternating current, especially heat treatment is continuously and efficiently performed on the objects.

For example, the above heat treatment is used for; food processing, including cooking, heat sterilization, heating and molding for baked confectioneries, defrosting of frozen foods and materials, heat maturation and cure (for defrosting thick foods and materials); wood processing, including drying wood, heat bonding and heat pressing for making wood products; resinification, including dissolution of resin, melting and bonding of resin films, and heat pressing and molding of resin.

In the following description including this embodiment, an example is given wherein as heat treatment, dielectric heating is performed for heating and molding the raw materials by applying high-frequency alternating current, especially for manufacturing heated and molded articles continuously and efficiently. More specifically, the present invention is explained giving an example of mass and efficient production of edible containers such as cone cups for ice cream and Monaka, baked and molded confectioneries made in a specific shape such as cookies, biscuits and wafers, or biodegradable molded articles mainly composed of starch. However, the present invention is not limited to those above.

In the following description, molded articles attained by heating and molding a starchy and watery mixture mainly composed of starch such as baked and molded confectioneries and biodegradable molded articles are referred to as baked and molded articles. Accordingly, the starchy and watery mixture corresponds to the object to be heated. Also, in this embodiment, as described below, molds are electrically conductive electrodes and the raw materials for molding are the above watery mixture containing water. Thus, high-frequency alternating current generates dielectric heating, and the electro-conductive heating is also performed whereby electric current directly flows in the watery mixture, raising temperature thereof. In the following description, the term “dielectric heating” includes not only the above dielectric heating in narrow sense, but also the electro-conductive heating performed at the same time.

Also, in the following description, an apparatus and a method for continuous high-frequency heating in accordance with the present invention are used for manufacturing the baked and molded articles, which may be referred to as a manufacturing apparatus and a manufacturing method, respectively. High-frequency alternative current may be referred to as high frequency. The heated and molded articles are simply referred to as molded articles.

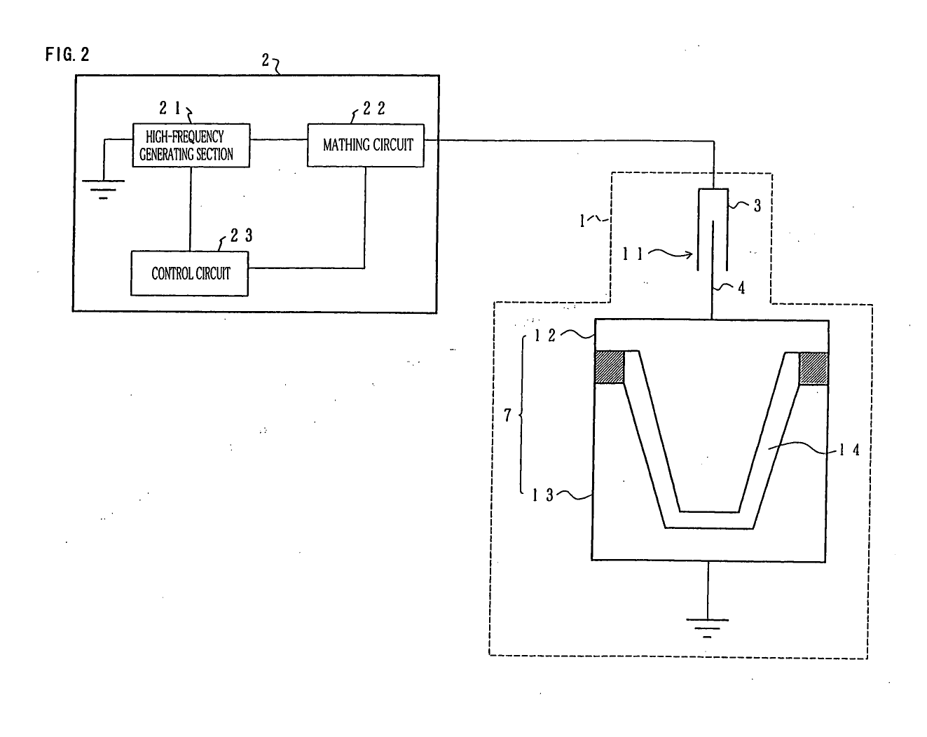

The manufacturing apparatus used in this embodiment has a heating section 1 and a power source section (power source means) 2, as shown in the outlined circuit diagram of FIG. 2. The heating section 1 includes a power feeding section 3 and metal molds (molds) 7 in correspondence therewith. The power source section 2 includes a high-frequency generating section 21, a matching circuit 22, and a control circuit 23. In the metal molds 7, the raw materials 14 are fed. For convenience, just one of the metal molds 7 is shown in FIG. 2.

The structure of the above high-frequency generating part (oscillator) 21 is not specifically limited as long as it generates high frequency. For example, a publicly known device such as a vacuum tube type oscillator may be used. This oscillator may include the matching circuit 22 or the control circuit 23.

For example, the matching circuit 22 may have a variable condenser or a variable coil. The matching circuit 22 varies electrostatic capacity or inductance depending on the raw materials 14 to be heated, thereby attaining an optimal high-frequency output or tuning. The variable condenser or variable coil may be a publicly known variable condenser or variable coil, and is not specifically limited. In addition, the matching circuit 22 is not limited to the above structure equipped with a variable condenser or a variable coil.

Publicly known control means may be used for the control circuit 23 as long as a high-frequency output in the heating section 1, that is, high frequency applied to the heating zone (heating area) described below is properly controlled.

The metal mold 7 included in the heating section 1 can be divided into a pair of electrodes 12 and 13 where the raw materials 14 as objects to be heated are placed in between. As described below, the electrode block 12 has a power receiving section 4, constituting a power feeding and receiving section 11 with a power feeding section 3. The electrode blocks 12 and 13 are insulated from each other, and dielectric heating is generated on the raw materials 14 by high frequency applied through the power feeding and receiving section 11.

Out of the electrode blocks 12 and 13, the electrode block 12 is a feeder electrode connected to the power feeding and receiving section 11, and the electrode block 13 is a grounding electrode grounded to the earth. The structure of the feeder electrode and the grounding electrode, that is, these electrode blocks 12 and 13 are not specifically limited as long as the electrically conductive mold is formed in combination of the electrode blocks. In general, metal molds 7 consisting of several kinds of metals are used. The shape of the metal molds 7 is not specifically limited as long as it corresponds to the shape of the molded articles.

In other words, the metal molds 7 are preferably used as the electrically conductive molds used in this embodiment. The metal molds 7, regardless of the shape, can be divided into two electrode blocks 12 and 13 in order to correspond to the above feeder electrode and grounding electrode.

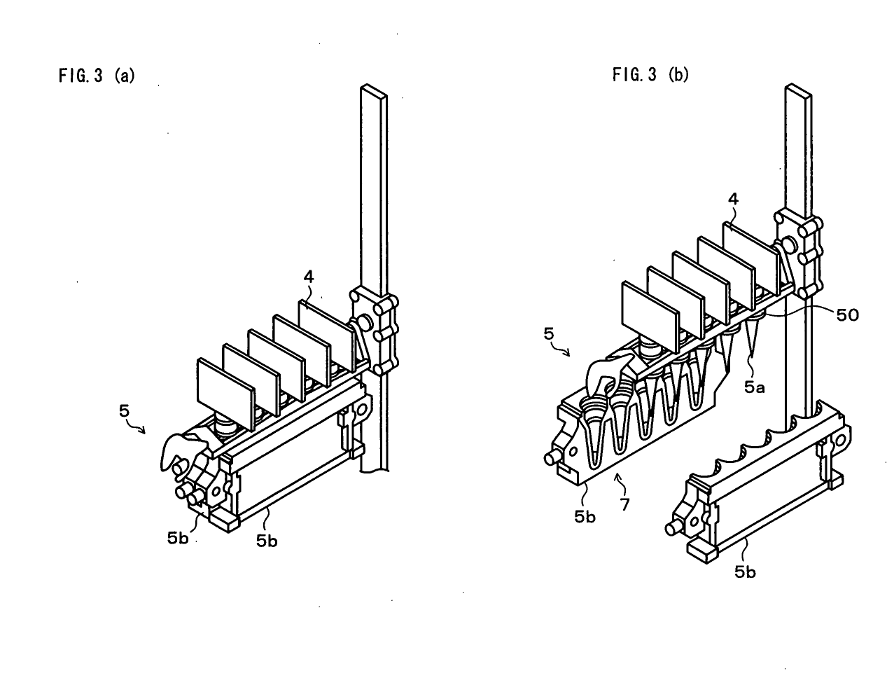

More specifically, for example, if the molded articles are cone cups for serving ice cream or soft serve products, united metal molds (united molds) 5 can be used which the metal molds 7 for cone cups (five in the figure) are combined and arranged in line, shown in FIGS. 3(a) and (b). The united metal mold 5, as shown in FIG. 3(b), is divided into three in total; an inside metal mold half 5a to mold an inside surface of the cone cups and two outside metal mold halves 5b and 5b to mold an outside surface of the cone cups. The inside metal mold half 5a is formed in rough conical shape corresponding to an inner space of the cone cups, while an outside metal mold halves 5b and 5b are equally divided into two along the longitudinally extending side of the cone cups in order to easily pick up the conical cone cups extending to one side.

Thus, in the structure of FIGS. 3(a) and (b), the united metal mold 5 is divided into three for picking up the cone cups. Also in this case, it consists of two blocks so that the inside metal mold half 5a corresponds to the feeder electrode (electrode block 12) and two outside metal mold halves 5b and 5b correspond to the grounding electrode block (electrode block 13). In addition, in the inside metal mold half 5a, the plate-type power receiving section 4 is provided in correspondence with each of the metal molds 7.

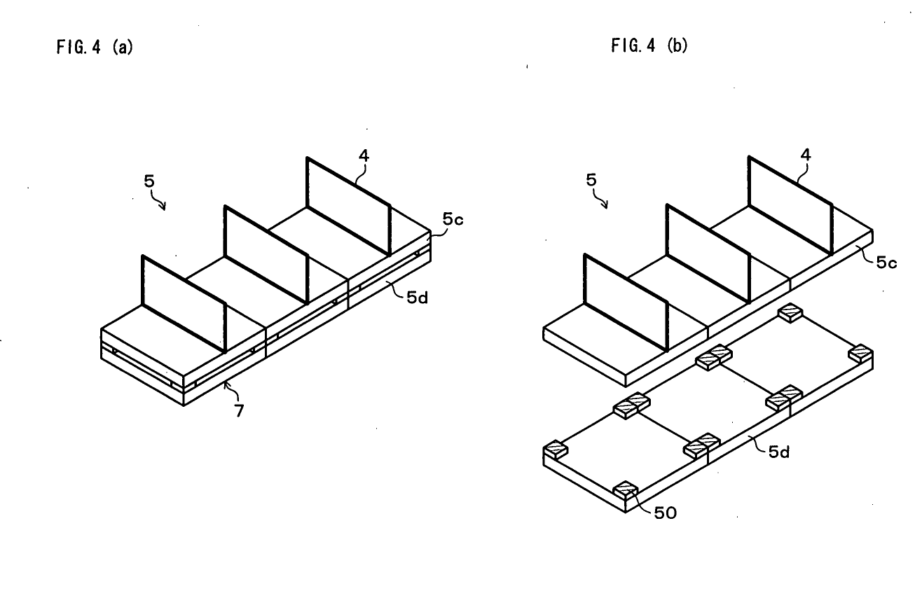

Or, as shown in FIGS. 4(a) and (b), in case of making plate-shaped molded articles, the united metal mold 5 that the plate-type metal molds 7 (three in the figure) are combined and arranged in line, may be used. This structure consists of a combination of two metal mold halves; an upper metal mold half 5c and a lower metal mold half 5d. The upper metal mold half 5c and the lower metal mold half 5d correspond to the feeder electrode block (electrode block 12) and the grounding block (electrode block 13), respectively. Additionally, in the upper metal mold half 5c, the plate-type power receiving section 4 is provided in correspondence with each of the metal molds 7.

Thus, the united metal mold 5 (or metal mold 7) serving as the electrode blocks 12 and 13 used in the present invention, which is a combination of many metal molds 7, can transfer many metal molds 7 to the heating zone at one time. In result, production efficiency of the molded articles can be improved.

Also, the above united metal mold 5 may consist of more than three metal mold halves depending on a shape of the molded articles or a method for picking up the molded articles after molding. Also in this case, the united metal mold 5 can be always divided into the feeder electrode block (electrode block 12) and the grounding electrode block (electrode block 13). Thus, it is possible to properly apply high frequency to the raw materials 14 for molding (hereinafter referred to as raw materials).

The united metal mold 5 serves as the electrode blocks 12 and 13 in the mold 7, where high frequency is applied. Therefore, the feeder electrode block (electrode block 12) and the grounding electrode block (electrode block 13) constituting the united metal mold 5, do not come in contact on directly with the raw materials in between. More particularly, an insulator 50 is provided between each of the blocks. The insulator 50 is not particularly limited as long as it is used to prevent the feeder electrode block from contacting on the grounding electrode block. In general, various kinds of insulators may be used, or a space may be formed instead of the insulators.

The united metal mold 5 in this embodiment may have a steam exhaust (not shown) to adjust internal pressure. In baked and molded articles attained by heating and molding a starchy and watery mixture described below, since a dough as the raw materials 14 contains starch and water, steam must be exhausted out of the metal mold 7 with the progress of heating and molding. However, steam cannot be sometimes exhausted due to some shapes of the metal mold 7. Then, by providing the steam exhaust in the metal molds 7, it is possible to escape steam from the metal mold 7 and to adjust internal pressure properly. The structure of the above steam exhaust is not particularly limited as long as it is constructed in the shape, size, number and position that steam can be uniformly and efficiently escaped from the metal mold 7.

In addition, depending on a property of the raw materials 14 and molded articles, the entire heating section 1 including the united metal molds 5 may form a chamber and may be constructed so that a vacuum pump can reduce internal pressure.

In this embodiment, the molded articles manufactured in accordance with the present invention, are the baked and molded articles such as baked and molded confectioneries including edible containers, for example, cone cups, and biodegradable molded articles, as described above. The shape of the baked and molded articles is not particularly limited, and various shapes of baked and molded articles may be made depending on usage. Of course, the baked and molded articles are not limited to the baked articles, and other molded articles may be made.

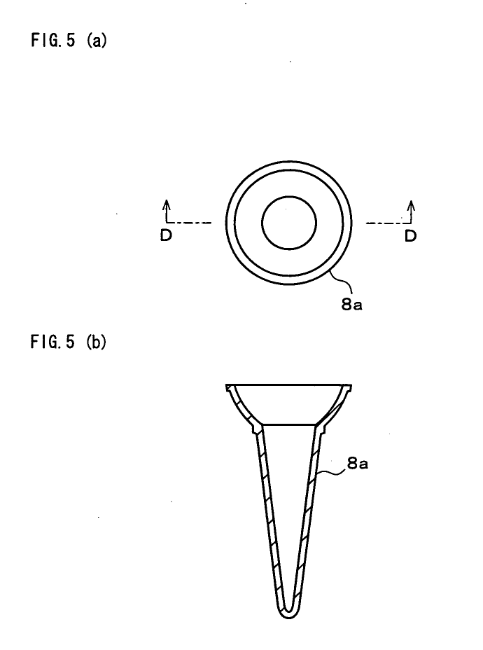

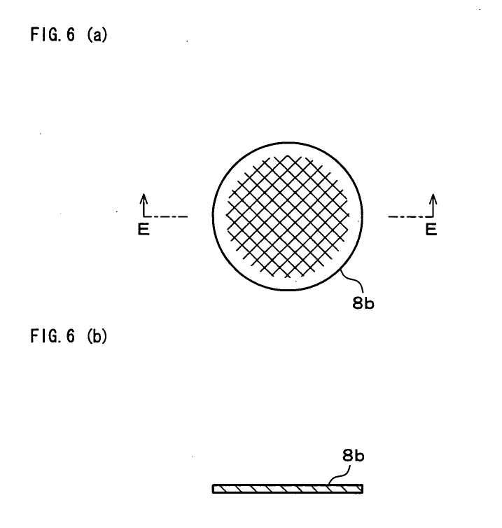

For example, the cone cups may be a conical cone cup 8a shown in FIGS. 5(a) and (b), or a disc-shaped waffle cone 8b shown in FIGS. 6(a) and (b). The size of these cones is not particularly limited.

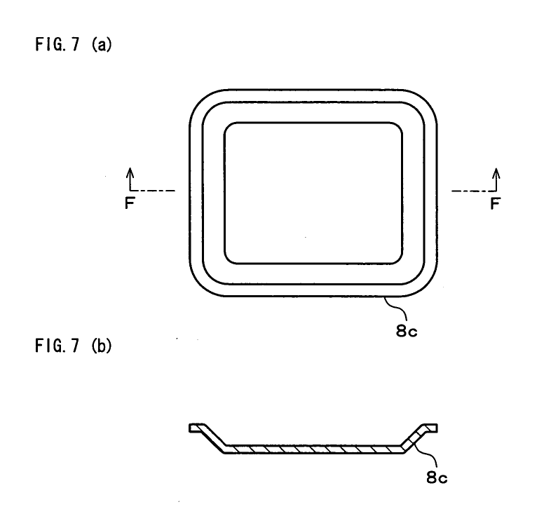

The biodegradable molded articles may be a plate-shaped tray 8c in a square shape with a flange formed in surroundings and shown in FIGS. 7(a) and (b), but not limited to this embodiment. In particular, the biodegradable molded articles have a wide range of usage and still more varieties of shapes, unlike edible containers such as the cone cups.

The raw materials 14 of the baked and molded articles are not particularly limited. In this embodiment, starch is a main ingredient, and by adding various sub ingredients to starch depending on the usage, adding water and mixing, a starchy and watery mixture in a dough having plasticity or in a slurry having fluidity can be preferably used.

For example, in the case of baked and molded confectioneries including edible containers such as the cone cups, flour is generally used as starch of the main ingredient. Other starch such as cornstarch may be used. In addition, various additives, for example, seasonings such as salt and sugar, anti-sticking agents such as oil and fat, flavorings, colorings, stabilizers, inflating agents, thickening agents, flavor enhancers, can be used as sub ingredients. These sub ingredients may be selected depending on the kind of baked and molded confectioneries, and are not particularly limited to those above.

Similarly, in case of the biodegradable molded articles, starch is a main ingredient, and filling agents such as diatomite and cellulose, binding agents such as gums, anti-sticking agents such as oil and fat, and colorings can be added as sub ingredients. However, these sub ingredients are not specifically limited to those above. Furthermore, as starch of the main ingredient, not only starch deriving from general plants (refined starch) and agricultural products containing starch such as flour (coarse-ground starch), but also chemical modified starch attained by chemically treating starch such as cross-linked starch, can be used.

In the present invention, for example, in order to mold the molded articles, heating is continuously performed by transferring the metal molds 7 (united metal molds 5) wherein the raw materials 14 are portioned. Thus, the united metal molds 5 can be continuously transferred by moving means. The moving means is not particularly limited, but in consideration with productivity of the molded articles, a conveyer (conveyer means) represented by a belt conveyer is preferably used.

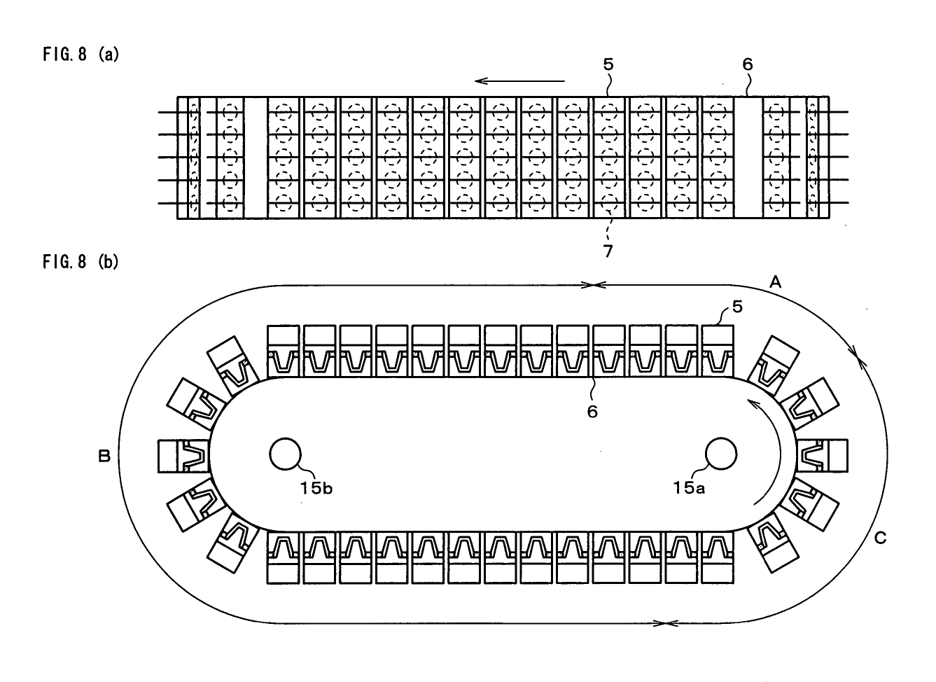

For instance, in this embodiment, a belt-type conveyer 6 is used which is stretched in rough plate shape by at least two supporting axes 15a and 15b, and which is rotatable as an endless track, as shown in FIG. 8. The direction in which the conveyer 6 is stretched, is not particularly limited. In this embodiment, the conveyer 6 is horizontally stretched. By using this conveyer 6, the united metal molds 5 can be transferred to the heating zone efficiently with improved production efficiency of the baked and molded articles. In addition, it is possible to reduce an installation space for the manufacturing apparatus since the conveyer 6 can move continuously and rotatably as an endless track.

In the descriptions below, the conveyer 6 that is stretched as shown in FIG. 8 has a layout of no-end plate shape. The conveyer 6 may be stretched rotatably by the supporting axes, and it is not limited to the above no-end plate shape.

In the manufacturing apparatus used in this embodiment, the united metal molds 5 (thirty-six in FIG. 8) are mounted on the entire periphery of the conveyer 6. Since the metal molds 7 (five in FIG. 8) are disposed in line as the united metal molds 5, and are mounted on the periphery of the conveyer 6 so that the longitudinally extending sides may be paralleled one another. The structure of the conveyer 6 is not particularly limited as long as it can resist a rise in temperature of the united metal molds 5 due to heating and can smoothly transfer the united metal molds 5 mounted on the entire periphery of the conveyer 6.

The method for manufacturing the molded articles in accordance with the present invention includes at least three processes; a raw material feeding process for pouring the raw materials 14 into the metal molds 7 (united metal molds 5), a heating process for heating and molding by applying high frequency to the metal molds 7 (united metal molds 5) wherein the raw materials 14 are fed in order to generate dielectric heating, and a pickup process for picking up the molded articles from the metal molds 7 (united metal molds 5) after heating and molding. Therefore, an area where these processes are performed, that is, a process zone is preset also in the manufacturing apparatus shown in FIG. 8.

In the no-end plate-type conveyer 6 shown in FIG. 8, a raw material feeding zone A is provided on the upper side of the end at the side of a supporting axis 15a (right end in FIG. 8). A heating zone B is set in the subsequent area to the raw material feeding zone A in the rotating direction of the conveyer 6 (direction of the arrow in the figure) and in an area occupying most of the periphery of the conveyer 6 which includes the end at the side of a supporting axis 15b, and in the subsequent area to the heating zone B, a pickup zone C is provided in an area adjacent to the raw material feeding zone A on the lower side of the end at the side of the supporting axis 15a.

The heating zone B may have a structure as shown in FIG. 2 and it may be equipped with high-frequency heating means to generate dielectric heating on the united metal molds 5 by applying high frequency. It is preferable that external heating means is provided depending on the kinds of raw materials 14.

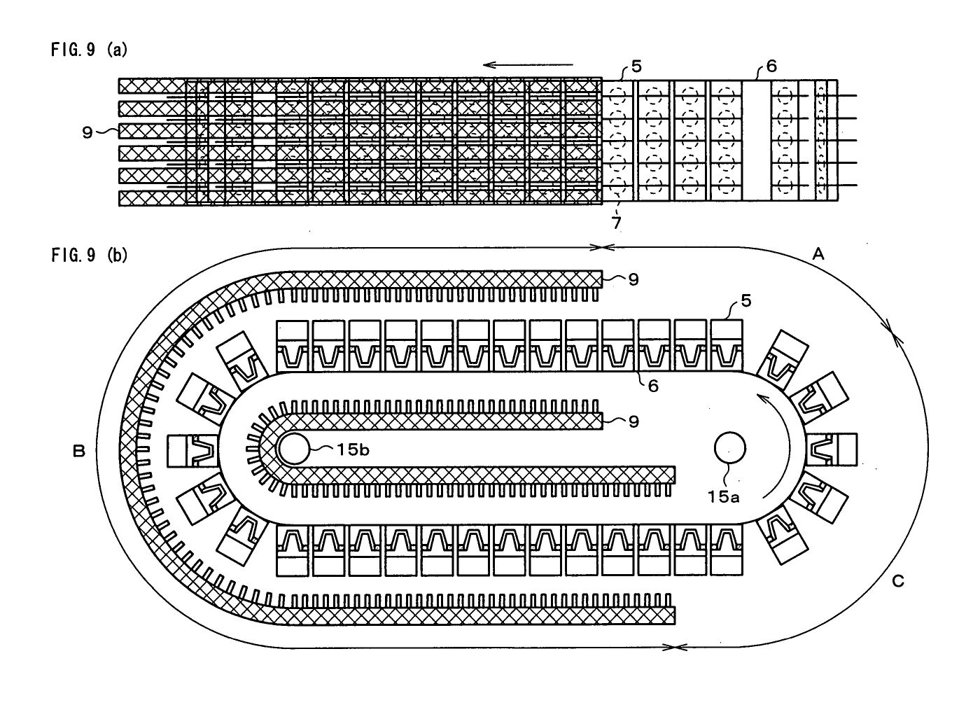

The external heating means may be used as long as the raw materials 14 in the united metal molds 5 can be heated through thermal conduction by heating the united metal molds 5 from the outside. In general, as shown in FIGS. 9(a) and (b), the gas heating section 9 may be provided along the shape in which the conveyer 6 is stretched across the heating zone B.

In external heating, the raw materials 14 are heated through thermal conduction by heating the united metal molds 5 from the outside to maintain the united metal molds 5 at a definite temperature (temperature of the metal molds). In result, it is very preferable, not only that the gas heating section 9 is disposed on the outer periphery of the conveyer 6 as shown in FIGS. 9(a) and (b), but also that the gas heating section 9 is disposed on the inner periphery of the conveyer 6, as shown in FIG. 9 (b). Thus, more uniform heating is possible, since external heating is performed from the upper and lower sides of the united metal molds 5.

For the above gas heating section 9, a publicly known structure used for manufacturing baked and molded articles can be preferably used, and the structure is not particularly limited. For convenience of clarifying the disposition of the gas heating section 9, the power feeding section 3 is not shown in FIGS. 9(a) and (b), as FIG. 8.

In the present invention, especially in case that the molded articles are baked and molded confectioneries including edible containers, it is preferable that not only dielectric heating but also external heating is used in the heating zone B.

When both dielectric heating and external heating are used in the heating zone, rapid heating of the raw materials 14 deriving from dielectric heating and moderate heating through thermal conductivity deriving from external heating are simultaneously performed in the starchy and watery mixture as the raw materials 14. In result, not only the starchy and watery mixture can be more steadily and fully heated, but also various properties can be preferably given to the baked and molded confectioneries by baking (baking and molding) the starchy and watery mixture due to both uses of dielectric heating and external heating.

More specifically, the properties may be structure of the molded articles, emergent effects from additives, and baked condition, but are not limited to those above. The level at which these properties are given to the molded articles depends on a balance between dielectric heating and external heating. The balance of these heating methods should be controlled depending on the varieties of raw materials 14, and it is not particularly limited.

The structure of the molded articles may be thickness of a surface texture, density of an inner texture, a condition of an inner cellular wall, and traces of deposit. In general, if a ratio of external heating to dielectric heating is lower, that is, a ratio of dielectric heating is higher; the surface texture becomes thinner; the inner texture becomes denser; the inner cellular wall becomes thinner; and the traces of deposit become thinner. On the other hand, if a ratio of external heating to dielectric heating is higher; the surface texture becomes thicker; the inner texture becomes coarser; the inner cellular wall becomes thicker; and the traces of deposit become thicker.

Emergent effects of the additives may be, for example, emergent effects of colorings or flavorings. In most cases, edible containers are colored after baking and molding by adding a red coloring to the starchy and watery mixture. When a ratio of dielectric heating is higher, a little brownish red color appears with good coloration. On the other hand, if a ratio of external heating is higher, the colorings are likely to fade, resulting in poor coloration. In case of the red colorings, a red color does not appear properly, resulting in a brownish color. In case of flavorings, if the ratio of dielectric heating is higher, good flavor is left over. If a ratio of external heating is higher, flavor is not properly left over due to spoilage or vaporization of aroma ingredients included in the flavoring.

In general, the baked condition may be a baked color or roasted smell, that is, whether a good baked color or roasted smell is attained or not. If a ratio of dielectric heating is higher, the baked color or roasted smell is light or weak. If a ratio of external heating is higher, the baked color or roasted smell becomes darker or stronger.

The external heating temperature in the gas heating section 9 is not particularly limited since it depends on the kinds of raw materials 14. For example, in case of the heated and molded confectioneries, heating temperature is controlled based on the temperature of the above metal molds. In general, it is preferable that external heating is performed at from 110° C. to 230° C. Depending on a target property of the molded articles, the temperature of the metal molds may be set within the above range accordingly.

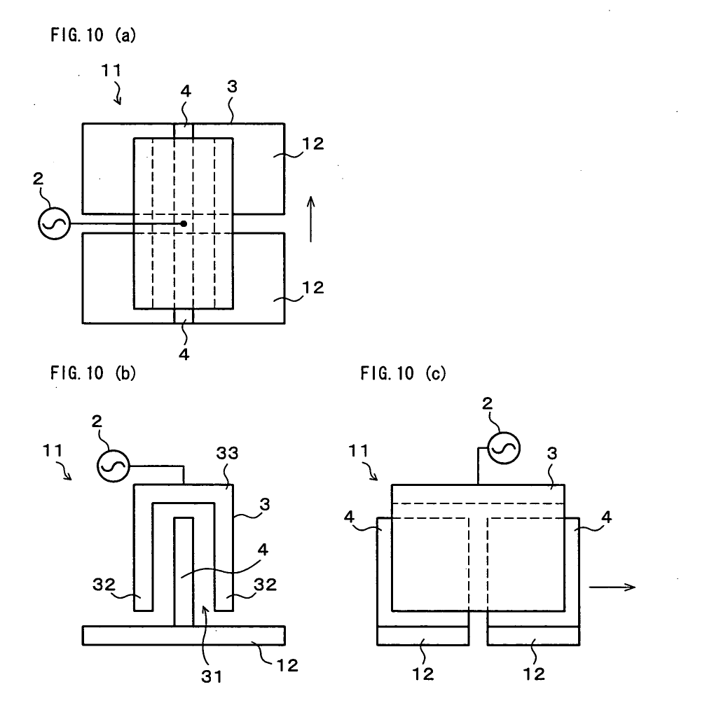

In the present invention, the high-frequency heating means is provided to generate dielectric heating by applying high frequency in the heating zone B. The high-frequency heating means includes the power source section 2 and the power feeding section (power feeding means) 3. In addition, as described above, the united metal mold 5 has the power receiving section (power receiving means) 4 to continuously receive high frequency from the power feeding section 3 during transference. The power feeding section 3 and the power receiving section 4 constitute the power feeding and receiving section 11. (Refer to FIG. 2.) The structure of the power feeding section 3 is not particularly limited. For example, the power feeding section 3 consists of electrically conductive materials such as metals and as shown in FIG. 10(b), it has a rough U-shape in the section and a concave 31 at the center. In other words, the shape has a rough U-shaped section formed by bending a rectangular plate-type member on the two lines in parallel with the longitudinally extending sides to form opposite sides 32 and 32 and a top surface 33 connected thereto.

On the other hand, the structure of the power receiving section 4 in correspondence with the power feeding section 3 is not particularly limited as long as it can receive high frequency with no contact with the power feeding section 3. For example, as shown in FIGS. 10(a), (b), and (c), the plate-type power receiving section 4 which is inserted with no direct contact on between the above opposite sides 32 and 32 may be used. This power receiving section 4 may consist of electrically conductive materials such as metals, as the power feeding section 3.

Since the power feeding section 3 is provided along the configuration in which the conveyer 6 is stretched across the entire heating zone B, it can be represented that the power feeding section 3 is disposed in a rail-shaped structure having a rough U-shaped section. Additionally, the power receiving section 4 is connected to the electrode block 12 in the configuration in correspondence to this rail-shaped power feeding section 3.

For example, as shown in FIGS. 10(a), (b), and (c), in the united metal mold 5, the power receiving section 4 is provided in the metal mold half (inside metal mold half 5a or upper metal mold half 5c) serving as the power feeder electrode block (electrode block 12). More specifically, in the united metal mold 5 as shown in FIGS. 3(a) and (b), or in the united metal molds 5 shown in FIGS. 4(a) and (b), the power receiving section 4 is individually provided for the five or three metal molds 7 constituting the united metal mold 5. In this case, the power feeding sections 3 are also disposed in parallel in correspondence to each of the metal molds 7.

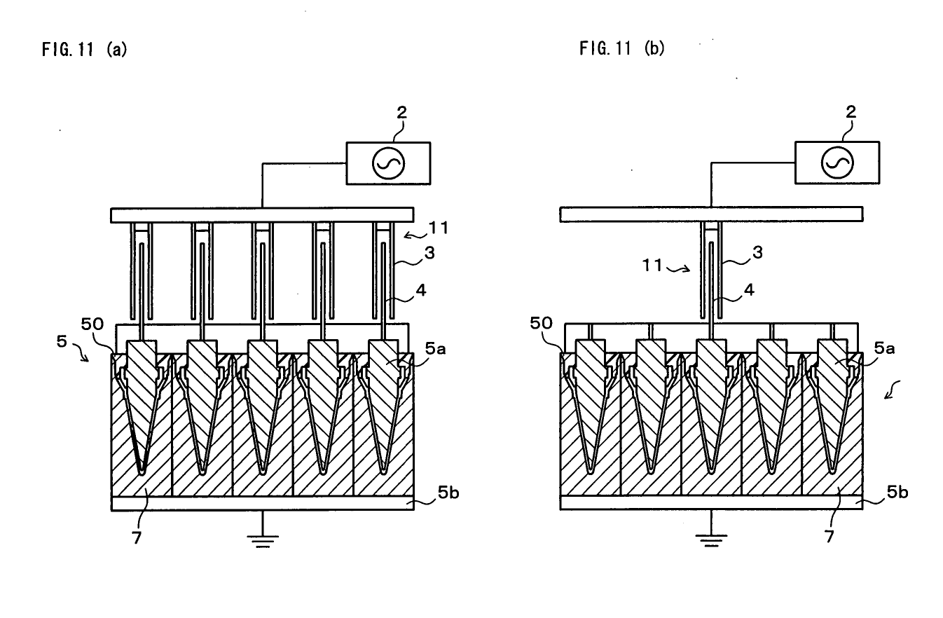

Furthermore, as shown in FIGS. 3(a) and (b), in the structure of the united metal mold 5 consisting of the five metal molds 7, the rail-shaped power feeding section 3 is also disposed in five lines in parallel as shown in FIG. 11(a).

Or, since the united metal mold 5 is a unit consisting of the five metal molds 7, it can be constructed so that as shown in FIG. 11(b), for example, the power receiving section 4 is provided only in the central metal mold 7 to apply high frequency to the other four metal molds 7. In this case, it is possible to simplify the structure of the manufacturing apparatus since the rail-shaped power feeding section 3 can be disposed in one line only.

Thus, in this embodiment, the power feeding and receiving section 11 is constituted by a combination of the rail-shaped power feeding section 3 forming a rough U-shaped section, and the plate-type power receiving section 4. When the united metal molds 5 enter in the heating zone B by transference of the conveyer 6, the plate-type power receiving section 4 is inserted in the concave 31 of the rail-shaped power feeding section 3 (between the opposite sides 32 and 32) with no contact. Then, with the transference of the conveyer 6, the power receiving section 4 moves along the rail-shaped power feeding section 3 (in the direction of the arrow in FIGS. 10(a) and (c)).

In the above condition, the power receiving section 4, the sides 32 and 32 surrounding it, and a space therein, form a condenser in the concave 31 of the power feeding section 3. In result, power starts to be supplied to the united metal molds 5 from the power source section 2, and a heating and drying process starts through dielectric heating. The heating and drying process smoothly and steadily continues until the united metal molds 5 pass through the heating zone B, that is, until the power receiving section 4-leaves the concave 31 in the power feeding section 3.

In other words, in the present invention, it is preferable that with the plate-type power receiving section 4, and the power feeding section 3 having a surface opposite to the power receiving section 4, high-frequency alternating current is applied with no contact by placing the above plate-type power receiving section 4 opposite to the above surface of the power feeding section 3. In addition, it is preferable that the sides 32 and 32 which oppose each other are provided as the above opposite surface. Therefore, the power feeding section 3 may not have a rough U-shaped section, and may be a plate type having the side 32 only.

The structure of the power feeding section 3 and the power receiving section 4 is not limited to those above. Namely, depending on a formula of the raw materials 14 or a finished shape of the molded articles, the configuration of the power feeding section 3 and the power receiving section 4 may be changed or by adding other members, dielectric heating may be generated differently. For example, an insulator may be placed between the power receiving section 4 and the sides 32 and 32 to improve a capacity of the condenser.

Therefore, in the present invention, power supply with no contact means that the power feeding section 3 and the power receiving section 4 (electrode block 12) do not come in contact directly. If the power feeding and receiving section 11 supplies power with no contact, the electrodes do not directly contact on each other, and generation of a spark can be prevented in the heating zone.

In the manufacturing apparatus used in this embodiment, as shown in FIG. 1, the united metal molds 5 (for example, the united metal mold 5 for the cone cup 8a shown in FIGS. 3(a) and (b)) are mounted entirely on the outer periphery of the conveyer 6 (refer to FIG. 8) disposed in a no-end plate-shaped layout. In addition, the rail-shaped power feeding section 3 (refer to FIGS. 10 and 11) constituting part of the heating section 1 is disposed on the position corresponding to the heating zone B in the conveyer 6. By a rotative movement of the conveyer 6, the united metal molds 5 move to the direction of the arrow in the figure (counterclockwise in FIG. 1) and heating starts when the united metal molds reach the heating zone B.

In this embodiment, as shown in FIG. 1, it is possible to apply high frequency to the twenty-five united metal molds 5 in the entire heating zone B. It is preferable that in the gas heating section 9 shown in FIG. 9, external heating can be performed. The whole length of the power feeding section 3 and the gas heating section 9 provided in the heating zone B is equivalent to that of the twenty-five united metal molds 5.

The united metal molds 5 are intended for making the above cone cups 8a shown in FIGS. 3(a) and (b), and one hundred twenty-five metal molds 7 can be heated in the entire heating zone B. If a high-frequency output from the power source section 2 is preset to apply 100 kW in the entire heating zone B, a high-frequency output applied to each of the metal molds 7 is 0.8 kW.

In the present invention, the high-frequency heating means provided in the heating zone B is divided into a plurality of means. Namely, a plurality of high-frequency heating means including the power source section 2 and the power feeding section 3 is provided in the heating zone B, and the high-frequency heating means constitute one heating zone B in combination.

In the structure shown in FIG. 1, the heating zone (heating area) B is divided into two sub-zones (sub-areas) b1 and b2. The sub-zones b1 and b2 have the power source sections 2a and 2b and the power feeding sections 3a and 3b, respectively. More specifically, the previous area in the direction of the rotative movement of the conveyer 6 corresponds to the sub-zone b1 and the subsequent area corresponds to the sub-zone b2.

As mentioned above, in the large-scale manufacturing apparatus to heat one hundred twenty-five metal molds 7, an output of the high-frequency generating section 21 will be very high, for example, 100 kW. In addition, due to the no-end plate-type conveyer 6, the heating zone B is disposed to cover the end at the side of the supporting axis 15b of the conveyer 6, thereby making the heating zone B longer. Then, when high frequency is applied in the heating zone B, it is likely to be localized on a certain position, whereon large high-frequency energy is likely to be concentrated.

Moreover, as mentioned above, if the raw materials 14 are a watery mixture containing water, an electrical property of the raw materials 14 significantly varies with a change of moisture content by heating. Accordingly, high frequency is more likely to be localized with the change of an electrical property of the raw materials 14, and high-frequency energy is more likely to be concentrated.

If high-frequency energy concentrates on a certain position as described above, some of the united metal molds 5 are likely to be excessively heated (overheating), which gives problems of poorer moldability of the raw materials 14 or poorer properties of the molded articles attained. In addition, since an output of the high-frequency generating section 21 is originally high, concentration of high-frequency energy may cause not only overheating but also a spark and even dielectric breakdown.

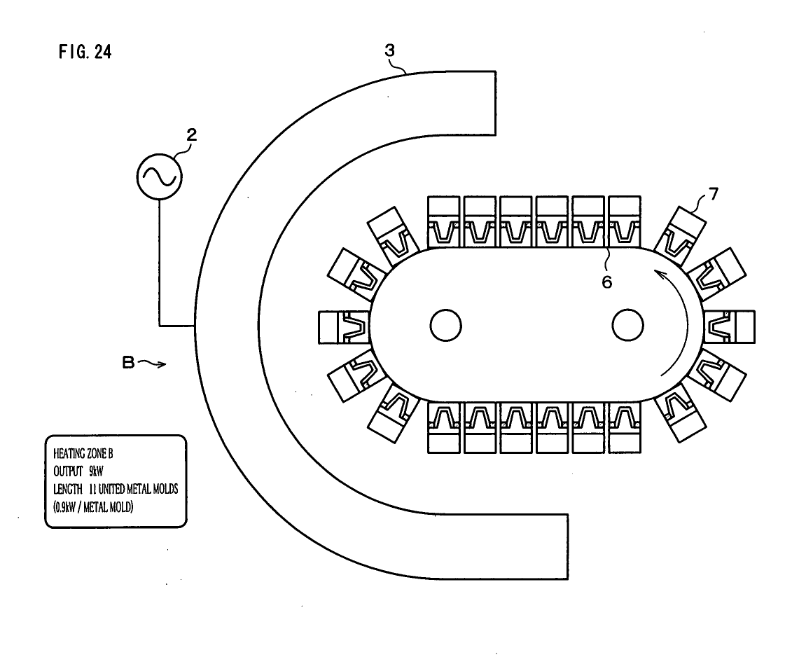

In the conventional art, since the manufacturing apparatus is small (refer to FIG. 24), concentration of high-frequency energy gives no problem. If the manufacturing apparatus becomes larger to increase production efficiency, the above problems are found.

On the other hand, in the prevent invention, the heating zone B is divided, for example, into two sub-zones b1 and b2. A high-frequency output in each of the sub-zones b1 and b2 is also divided from the total output. Accordingly, it is possible to effectively restrain or prevent concentration of high-frequency energy and to prevent overheating or dielectric breakdown.

In the example shown in FIG. 1, the heating zone B is divided into two sub-zones b1 and b2 having an equal length and an equal output. More specifically, the whole length of the heating zone B is equivalent to that of the twenty-five united metal molds 5, which means each of the sub-zones b1 and b2 have a length equivalent to the twelve point five united metal molds 5. Namely, the power feeding section 3a provided in the sub-zone b1, and the power feeding section 3b installed in the sub-zone b2, have the same length, each of which can apply high frequency to twelve point five united metal molds 5 (sixty-two point five metal molds 7 in total).

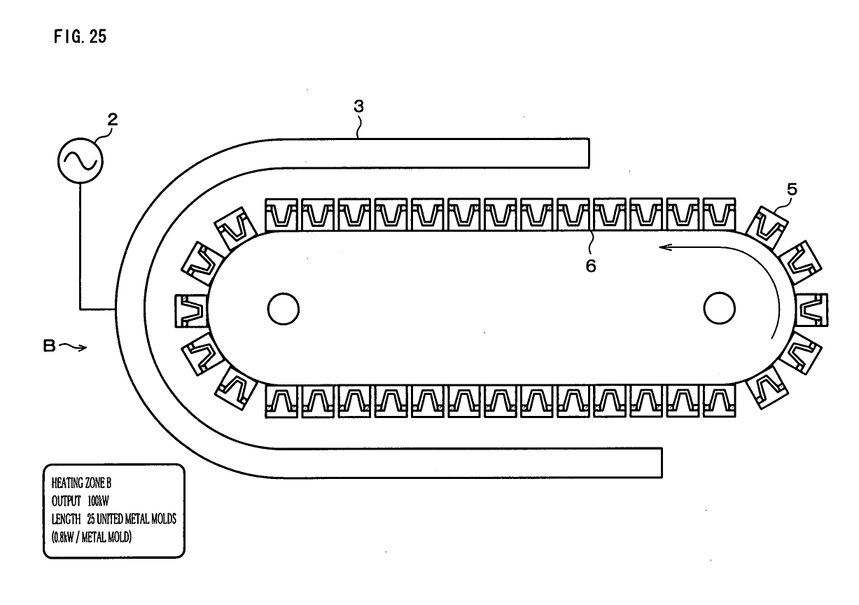

Also, since a high-frequency output in the entire heating zone B is 100 kW, a high-frequency output from the power source sections 2a and 2b provided in the sub-zones b1 and b2, respectively, is preset at 50 kW. Therefore, the output of the entire heating zone B is still 100 kW, and the high-frequency output applied to each of the metal molds 7 is still 0.8 kW. (Refer to FIG. 25.) In this embodiment, a way of to divide the heating zone B is not particularly limited as long as it is divided into two. In other words, a division of the heating zone B can be varied depending on a method of applying high frequency to the metal molds 7 (united metal molds 5), a layout of the conveyer 6, and properties and characteristics of the raw materials 14 and the finished molded articles.

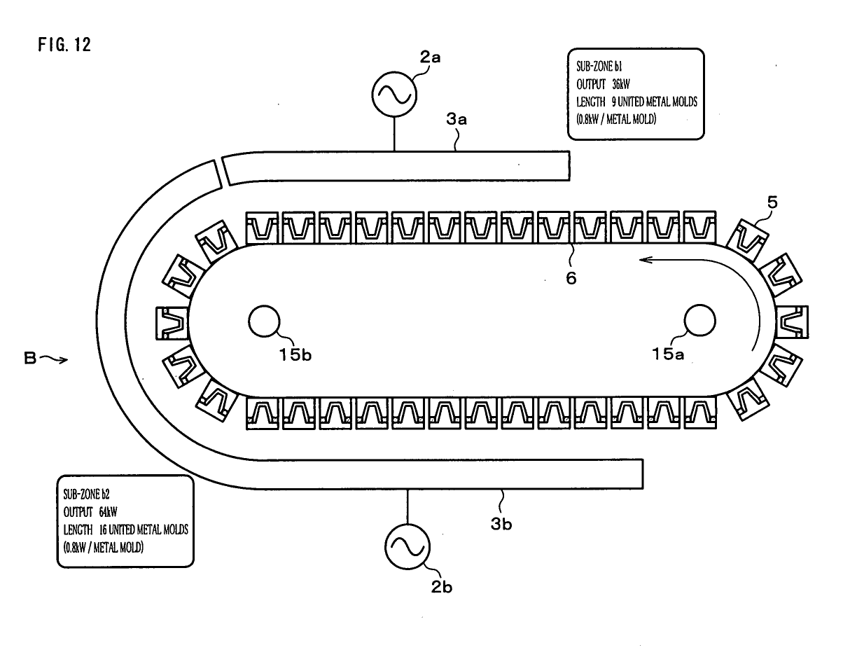

For example, as shown in FIG. 12, the heating zone B is divided into two sub-zones b1 and b2 as the example of FIG. 1. A length of the sub-zone b1 (length of the power feeding section 3a) may be equivalent to that of nine united metal molds 5, and an output from the power source section 2a may be 36 kW. In addition, a length of the sub-zone b2 (length of the power feeding section 3b) may be equivalent to that of sixteen united metal molds 5 and an output from the power source section 2b may be 64 kW.

In this case, in the sub-zones b1 and b2, high frequency can be applied to the forty-five metal molds 7 in total and the eighty metal molds 7 in total, respectively. However, total output in the entire heating zone B is still 100 kW and the output to each of the metal molds 7 is still 0.8 kW.

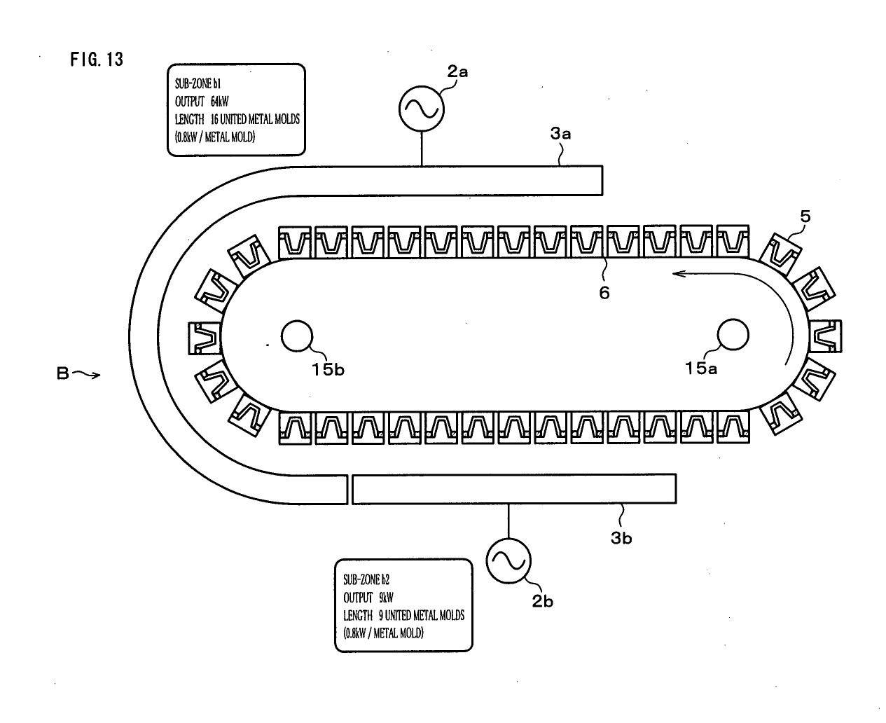

By contraries, as shown in FIG. 13, a length of the sub-zone b1 may be equivalent to that of sixteen united metal molds 5, and an output from the power source section 2a may be 64 kW. Also, a length of the sub-zone b2 may be equivalent to the nine united metal molds 5, and an output from the power source section 2b may be 36 kW. In this case, in the sub-zones b1 and b2, high frequency can be applied to the eighty metal molds 7 in total and the forty-five metal molds 7 in total, respectively. The output in the entire heating zone B is still 100 kW, and the output to each of the metal molds 7 is still 0.8 kW.

An example of a process for manufacturing molded articles in accordance with the present invention is explained below, giving an example of production of the cone cups 8a. The watery mixture is used as the raw materials 14 and the united metal molds 5 are used as the metal molds 7 shown in FIGS. 3(a) and (b). Of course, the present invention is not limited to the example of this manufacturing process.

First of all, after closing the two outside metal mold halves 5b and 5b constituting the grounding electrode block (electrode block 13), out of the metal mold halves constituting the united metal mold 5, the raw materials 14 are poured into the metal molds 7. Then, the inside metal mold half 5a constituting the feeder electrode block (electrode block 12) and outside metal mold halves 5b and 5b are locked (a raw material feeding process). This raw material feeding process is performed in the raw material feeding zone A in FIG. 8.

The united metal molds 5 wherein the raw materials 14 are fed, are ready for heating and molding the raw materials 14. The united metal molds 5 are transferred from the raw material feeding zone A to the heating zone B by the rotative movement of the conveyer 6. In the heating zone B, high frequency is applied with no contact from the power source sections 2a and 2b through the power feeding and receiving section 11 to start dielectric heating as well as external heating in the gas heating section 9 (a heating process). Since the heating zone B, as shown in FIG. 1, is divided into the sub-zones b1 and b2, concentration of high-frequency energy is not generated as mentioned above, whereby the raw materials 14 can be efficiently and steadily heated, dried and molded.

After the united metal molds 5 pass through the heating zone B, heating, drying and molding processes are completed. Then, the inside metal mold half 5a and the outside metal mold halves 5b and 5b constituting the united metal mold 5 are separated and the molded articles inside (cone cups 8a) are picked up (a pickup process). A series of manufacturing processes are now completed.

The above manufacturing processes are not particularly limited to those above, and other processes such as a stabilizing process (or a high-frequency heat delaying process) may be added.

For instance, it is preferable that in manufacturing the baked and molded articles including edible containers such as the cone cups 8a, a stabilizing process to hold the raw materials 14 in the metal molds 7 (united metal molds 5) for a definite period of time for stabilization, may be added before a heating process.

As mentioned above, it is preferable that not only dielectric heating but also external heating is performed in manufacturing baked and molded confectioneries. Even though the external heating means including the gas heating section 9 is provided only in the heating zone B, the metal molds 7 (united metal molds 5) are continuously transferred by the rotative movement of the conveyer 6. Therefore, the metal molds 7 are not almost cooled either in the raw material feeding zone A or in the pickup zone C for the whole manufacturing apparatus.

For example, in the heating zone B, when external heating is performed to raise the temperature of the metal molds to 180° C., it is still maintained at almost 180° C. even after the united metal molds 5 (metal molds 7) are transferred by the conveyer 6 and reach the pickup zone C and the raw material feeding zone A. It can be represented that the heating zone B covers even the raw material feeding zone A and the pickup zone C if external heating is also used together with dielectric heating.

If the raw materials 14 poured into the metal molds 7 are left alone therein for a definite period of time before applying high frequency in the heating zone B, external heating is moderately performed on the raw materials 14 through thermal conduction from the metal molds 7 of high temperature. This moderate heating completes an initial change of the raw materials 14. Afterwards, when high frequency is applied to the metal molds 7, dielectric heating is properly performed on the raw materials 14 inside the metal molds 7. In result, moldability of the raw materials 14 and properties of the molded articles attained can be improved.

By stabilizing the raw materials 14, high frequency is not applied to the raw materials 14 in the period of time when the electrical property changes most significantly. Thus, it is possible to further prevent concentration of high-frequency energy with less change in the electrical property of the raw materials 14 even if a larger high-frequency output is applied in the heating zone B.

In this embodiment, the stabilizing process is included in the raw material feeding process. The latter part in the raw material feeding zone A following the heating zone B is a stabilizing zone, which is not shown in the zoning of FIG. 8. Accordingly, in the raw material feeding zone A, the raw materials 14 are actually poured in the former part, and they are left alone for stabilization in the latter part.

Thus, in the present invention, the heating zone to apply high frequency is divided into sub-zones, each of which has a power source section and a power feeding section, which can restrain or prevent concentration of high-frequency energy in the heating zone. In result, overheating or dielectric breakdown is effectively prevented, with improved moldability of the raw materials and improved properties of the molded articles attained.

### EMBODIMENT 2

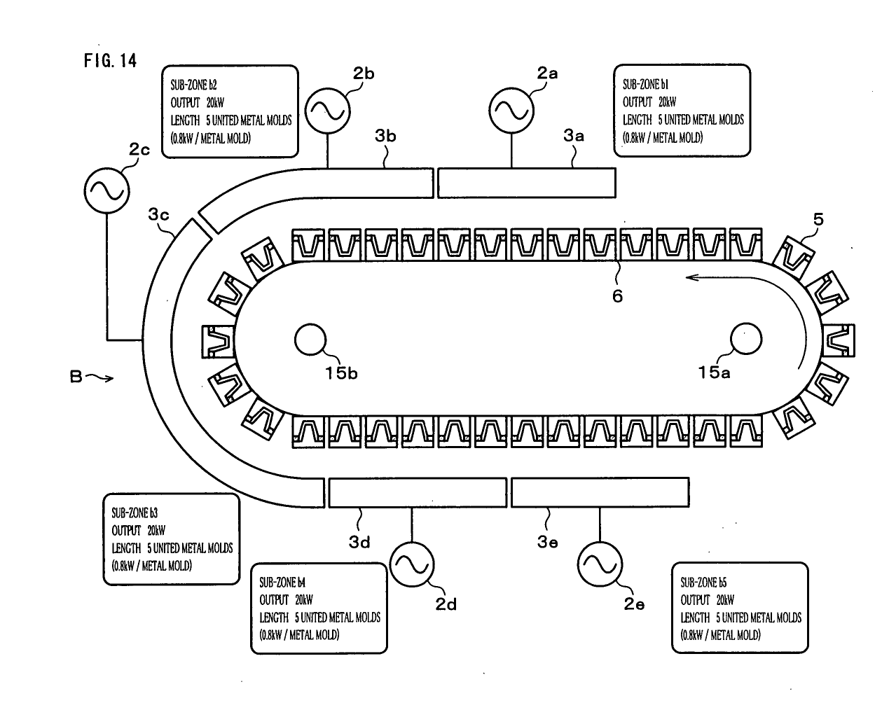

The following description explains another embodiment of the present invention referring to FIG. 14 to FIG. 16, but the present invention is not limited to this embodiment. For convenience, the same numbers are shown for the members having the same function as the members used in the above embodiment 1, with the explanation left out.

In the above embodiment 1, the heating zone B is divided into two. In this embodiment, the heating zone B is divided into more than three.

More specifically, for example, as shown in FIG. 14, the heating zone B is divided into five sub-zones, b1, b2, b3, b4 and b5 from the previous part based on the moving direction of the conveyer 6. Each of the sub-zones has power source sections 2a, 2b, 2c, 2d, and 2e as well as a power feeding sections 3a, 3b, 3c, 3d, and 3e, respectively.

A way to divide the heating zone B, that is, a length of each of the sub-zones (length from the power feeding sections 3a to 3e) or a high-frequency output from the power source sections 2a to 2e is not particularly limited as long as concentration of high-frequency energy can be retrained or prevented. As the above embodiment 1, the heating zone B may be simply divided into three sub-zones with an equal output and an equal length, or may be divided to apply the same high-frequency output to each of the metal molds 7 even with a different output and a different length.

However, it is more preferable that a different output of high frequency is applied in each of the sub-zones depending on the raw materials 14 and properties of the finished molded articles. In this case, a heating and drying process is performed in each sub-zone at a different level, whereby not only concentration of high-frequency energy can be restrained or prevented, but also moldability of the raw materials 14 and properties of the molded articles attained can be further improved.

For example, it is not preferable that a very large output of high frequency is applied to the starchy and watery mixture, since an electrical property (property for high frequency) significantly changes at an initial stage of heating and molding. At a last stage of heating and molding whereat heating and drying is almost completed, adding an excessive heat causes overheating, resulting in poorer property of the molded articles (e.g. cone cups 8a).

As the above embodiment 1, when the heating zone B is equally divided, as shown in FIG. 14, a length from the sub-zones b1 to b5 is equivalent to that of the five united metal molds 5, respectively. An output from the power source sections 2a to 2e is 20 kW, respectively. In this way of division, high frequency is applied to twenty-five metal molds 7 in each of the sub-zones, while the output in the entire heating zone B is still 100 kW, and the output to each of the metal molds is still 0.8 kW.

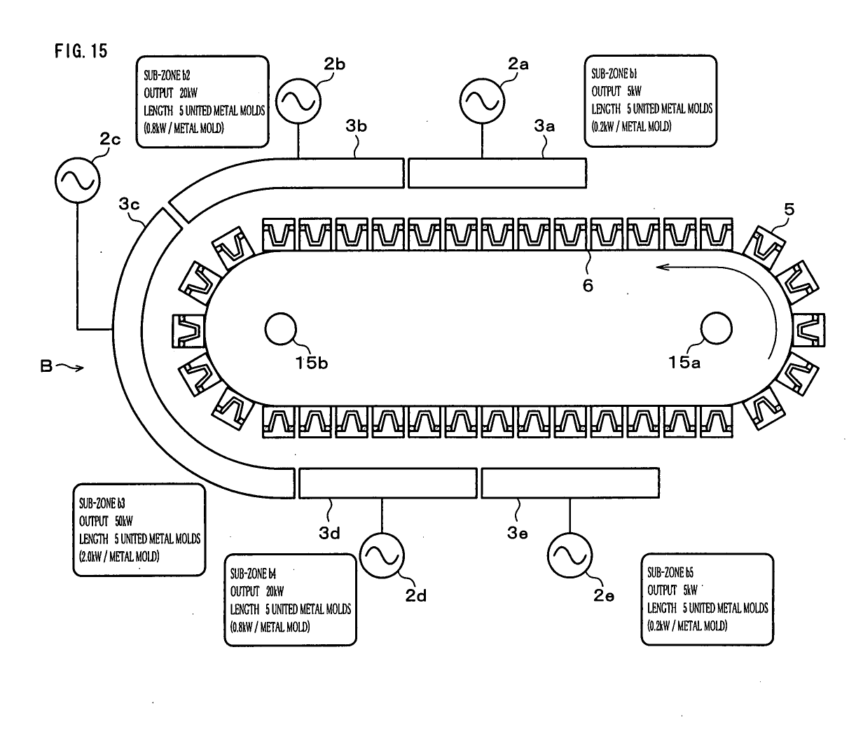

On the other hand, as shown in FIG. 15, an output from the power source sections 2a to 2e in each of the sub-zones may be individually changed depending on properties of the raw materials 14 and the cone cups 8a. More specifically, a length of the sub-zones b1 to b5 is still equivalent to that of the five united metal molds 5, respectively, that is, high frequency is still applied to the twenty-five metal molds 7. However, in the way of division shown in FIG. 15, an output in the sub-zones b1 and b5 is all 5 kW, and an output in the sub-zones b2 and b4 is all 20 kW, and an output in the sub-zone b3 is 50 kW.

In other words, in the above way of division, a high-frequency output is gradually raised from the sub zones b1 and b2 at an initial stage of heating process through the sub zone b3 at an intermediate stage. On the other hand, high frequency is gradually reduced from the sub-zone b3 through the sub zone b5 at a final stage.

Also in the above way of division, the output in the entire heating zone B is still 100 kW, but in the sub-zones b1 and b5, the output to each of the metal molds 7 is reduced to 0.2 kW. In the sub-zones b2 and b4, the output to each of the metal molds 7 is 0.8 kW, as the way of division in FIG. 14. In the sub-zone b3, the output to each of the metal molds 7 is increased to 2.0 kW. In result, when the raw materials are heated and molded, it is possible to reduce heat generation at an initial stage and a last stage, and to increase heat generation at an intermediate stage. Therefore, it is possible to restrain and prevent concentration of high-frequency energy with further improved moldability of the raw materials 14 and properties of the molded articles.

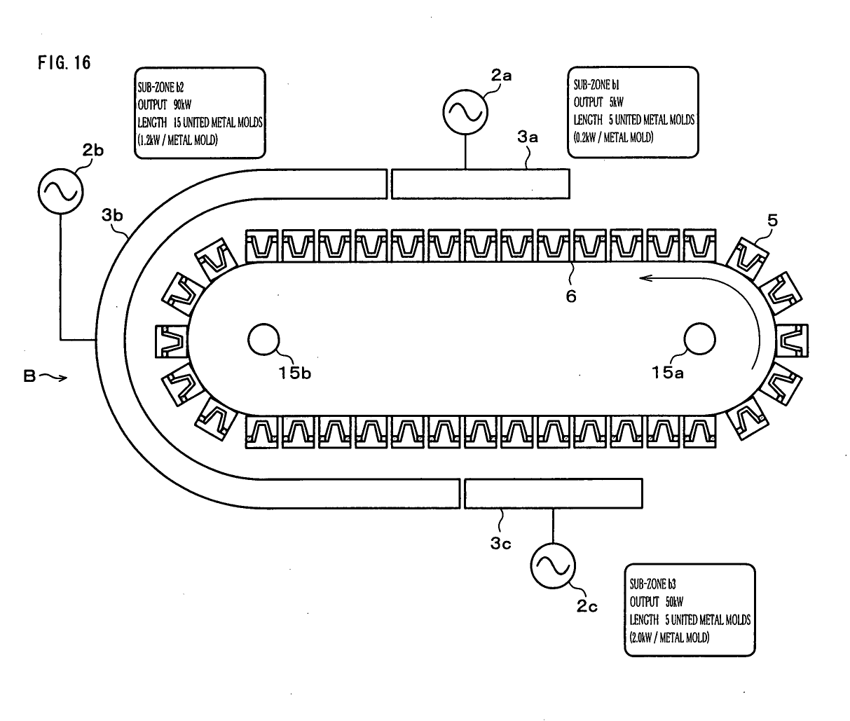

In the example shown in FIG. 15, though a high-frequency output from the power source sections 2a to 2e is changed, a length of each of the sub-zones may be changed. For example, as shown in FIG. 16, in dividing the heating zone B into three to make the sub-zones b1, b2, and b3 from the previous part based on the moving direction of the conveyer 6, a length of the sub-zones b1 and b3 (length of the power feeding sections 3a and 3c) may be made equivalent to that of five united metal molds 5, and an output from the power source sections 2a and 2c may be set at 5 kW. Also, a length of the sub-zone b2 (length of the power feeding section 3b) may be made equivalent to that of the fifteen united metal molds 5 and an output from the power source section 2b may be set at 90 kW. In the sub-zones b1 and b3, high frequency is applied to the twenty-five metal molds 7 and in the sub-zone b2, high frequency is applied to the seventy-five metal molds 7.

In this way of division, the whole length of the heating zone B is still equivalent to that of the twenty-five united metal molds 5, while the length of the sub-zone b2 is substantially three times as that of the sub-zones b1 and b3. Also, though the output in the entire heating zone B is still 100 kW, the output to each of the metal molds 7 in the sub-zones b1 and b3 decreases to 0.2 kW, and the output to each of the metal molds 7 in the sub-zone b2 increases to 1.2 kW.

In the above way of division, not only a high-frequency output but also a length of the sub-zone is changed. Therefore, it is possible not only to lessen a heat capacity at an initial stage and a last stage of heating and molding the raw materials 14, but also to set a shorter period of time to lessen the heat capacity by shortening a length of the sub-zones b1 and b3. In addition, it is possible to set a longer period of time for an intermediate stage requiring the heat capacity enough for heating and drying by lengthening the sub-zone b2.

In result, it is possible to add a heat capacity to the raw materials more properly, whereby not only concentration of high frequency can be restrained or prevented, but also moldability of the raw materials 14 and properties of the molded articles can be further improved.

As mentioned above, in this embodiment, in addition to dividing the heating zone into more than three sub-zones, conditions for applying high frequency are differently made by the sub-zone. Accordingly, it is possible to apply a different level of heat capacity for a different period of time depending on properties of the raw materials and the molded articles. In result, more effective heating and molding can be realized with more efficient production of high quality molded articles.

It is preferable that the above conditions for applying high frequency include at least one of the conditions; a high-frequency output in the entire sub-zone, a high-frequency output applied to each of the metal molds, and a length of each of the sub-zones. By changing one of these conditions in each of the sub-zones, a heating condition can be changed by the sub-zone. In result, concentration of high frequency can be restrained or prevented, and moldability of the raw materials and properties of the molded articles can be further improved.

### EMBODIMENT 3

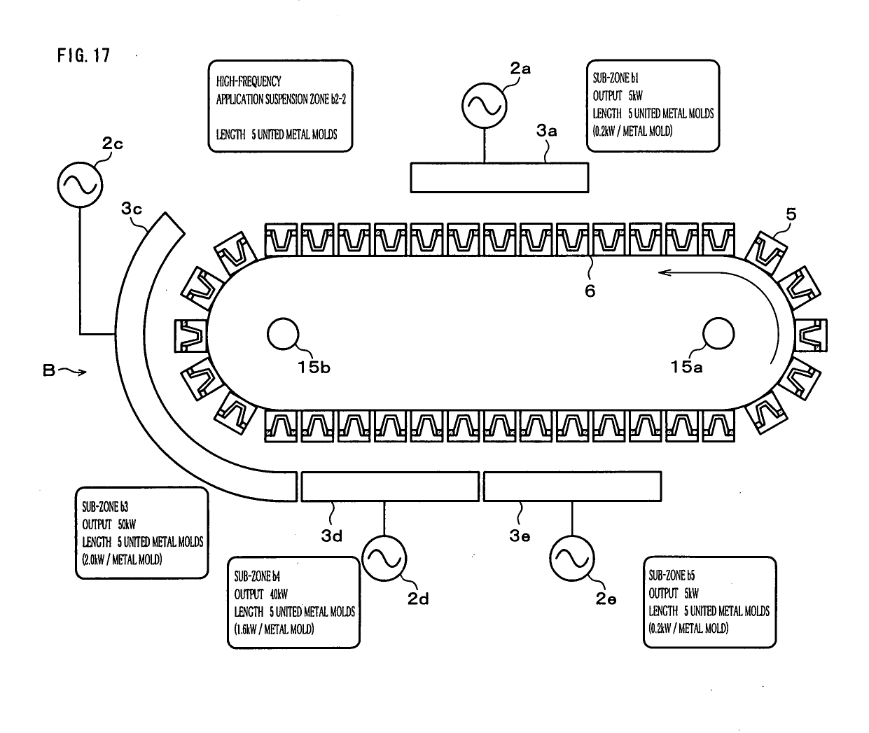

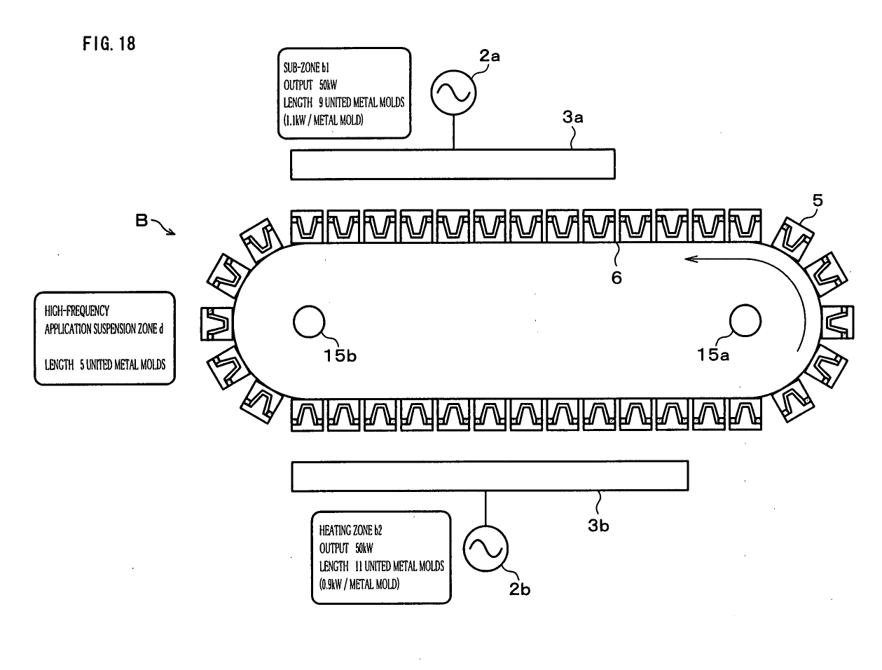

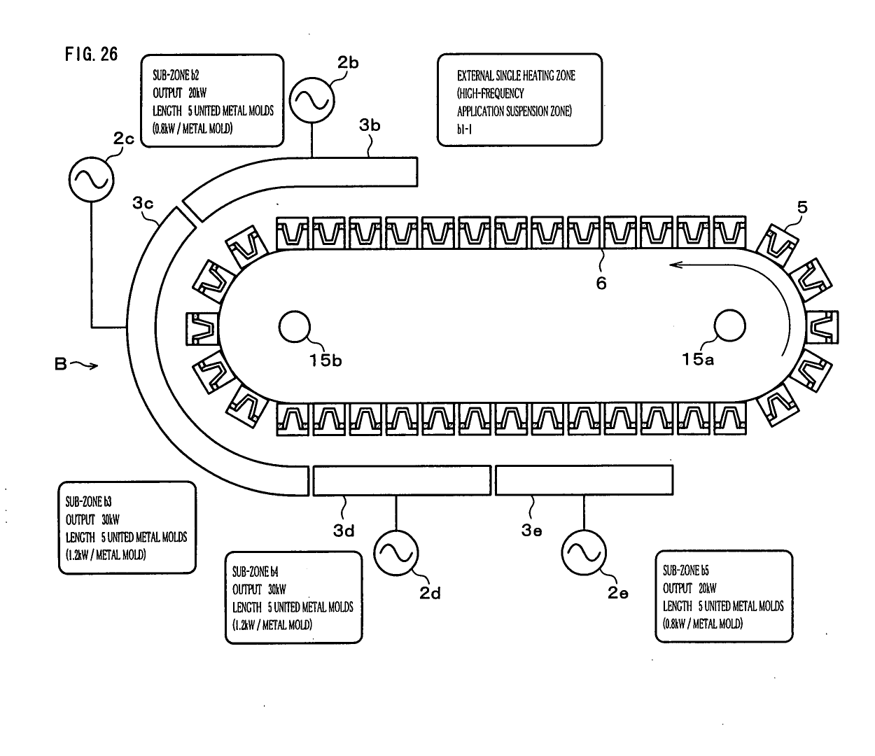

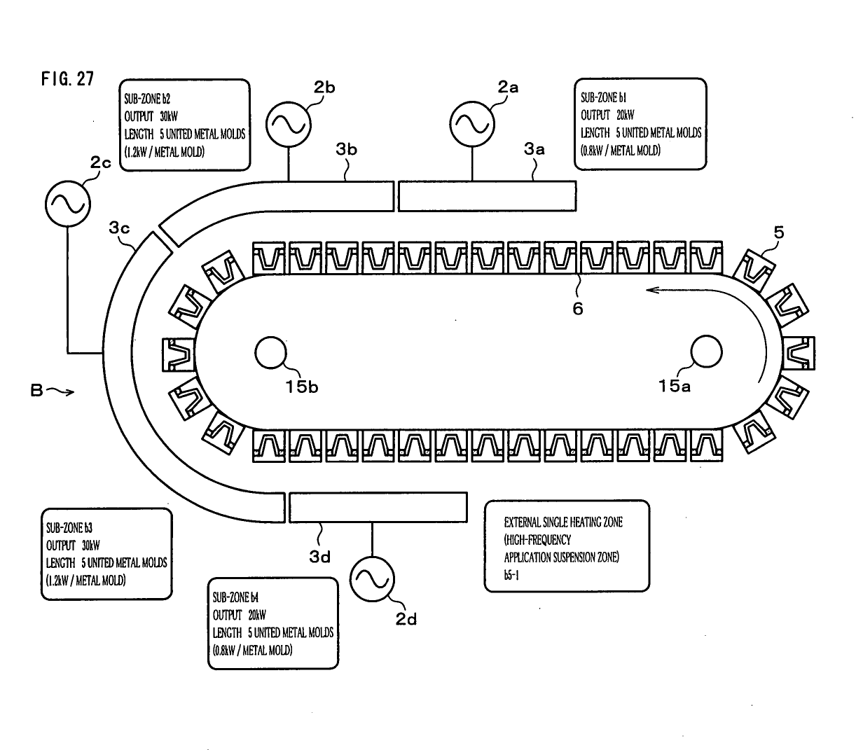

Still another embodiment of the present invention is described below referring to FIG. 17 and FIG. 18 as well as FIG. 26 and FIG. 27. The present invention is not limited to this embodiment. For convenience of explanation, the same numbers are shown for the members having the same function as the members used in the above embodiments 1 and 2 with the explanation left out.

In the above embodiments 1 and 2, even if the heating zone B is divided into sub-zones, both dielectric heating through the high-frequency heating means and external heating through the external heating means are used in the entire heating zone B. This embodiment includes an area where external heating is only performed, by providing a high-frequency application suspension zone where no high-frequency alternating current is applied, in part of the heating zone B.

More specifically, in this embodiment, as shown in FIG. 17, the heating zone B is basically divided into five sub-zones explained in the above embodiment 2, where the gas heating section 9 explained in the above embodiment 1 (refer to FIG. 9) is provided across the entire heating zone B. In an area corresponding to the sub-zone b2, the power source section 2b and power feeding section 3b are not provided but the high-frequency application suspension zone b2-2 is provided.

The gas heating section 9 described in the above embodiment 1 is only provided in the above high-frequency application suspension zone b2-2. Consequently, moderate heating can be performed through external heating only in the previous part to the sub-zone b3 requiring the highest heat capacity, thereby heating the raw materials 14 more properly. This high-frequency application suspension zone b2-2 can be also referred to as an external heating zone where external heating is only performed.

The above high-frequency application suspension zone b2-2 also corresponds to an area where an electrical property of the starchy and watery mixture as the raw materials 14 changes most significantly. It is possible to prevent concentration of high-frequency energy by not applying high frequency in the above high-frequency application suspension zone.

In the way of division shown in FIG. 17, since high frequency is not applied in the above high-frequency application suspension zone b2-2, the heating zone B is substantially divided into four sub-zones from a viewpoint of dividing a high-frequency output.

In other words, as the way of division shown in FIG. 15, a length of the above sub-zones b1, b2-2, b3, b4 and b5 is all equivalent to that of the five united metal molds 5. A high-frequency output from the power source sections 2a, 2c, 2d, 2e are all 5 kW in the sub-zones b1 and b5 (an output to each of the metal molds 7 is 0.2 kW), and 50 kW in the sub-zone b3 (an output to each of the metal molds 7 is 2.0 kW). However, a high-frequency output in the entire heating zone B is 100 kW. Thus, in this embodiment, the heating zone B is substantially divided into four sub-zones excepting the high-frequency application suspension zone b2-2.

Out of the above sub-zones bland b3 to b5, the sub-zone b4 is an area where a higher heat capacity is preferable. An output in the sub-zone b4 may be set at 50 kW (an output to each of the metal molds 7 is 1.6 kW). Since the sub-zone b4 is located in an area subsequent to the sub-zone b3 requiring the highest heat capacity and in an area previous to the sub-zone b5 performing a final heating and drying process, a higher output of high frequency may be applied in the sub-zone b4.

On the other hand, in the sub-zones b1 and b5, it is not preferable to increase a high-frequency output, since much heat capacity is not required, as mentioned in the above embodiment 2. In the sub-zone b3, since a high-frequency output is preset enough high, it is not preferable to increase the high-frequency output, which may cause overheating.

An example of a process for manufacturing molded articles in accordance with a manufacturing method in this embodiment is explained below. Basically, there are only three processes explained in the above embodiment 1; a raw material feeding process, a heating process, and a pickup process. In addition to these processes, external heating is performed during the heating process.

The united metal molds 5 wherein the raw materials 14 are fed by the raw material feeding process, are transferred to the heating zone B by the rotative movement of the conveyer 6. First, high frequency is applied together with external heating in the sub-zone b1 to perform “slight” heating at an initial stage. Next, in the external heating zone b2-2, external heating is only performed, since high frequency is not applied to perform dielectric heating. Accordingly, the raw materials 14 are moderately heated through thermal conduction.

At the time when the united metal molds 5 move from the external heating zone b2-2 to the sub-zone b3, the raw materials 14 are stabilized by moderate heating and matured (cured), as the stabilizing process in the embodiment 1. Thus, even if the largest output of high frequency is applied in the sub-zone b3, an electrical property of the raw materials 14 changes less and the raw materials are stabilized, since an initial change of the raw materials 14 are already completed in the united metal molds 5. In result, it is possible to reduce a spark in the sub-zone b3 and to improve moldability of the raw materials 14.

Afterwards, the largest output of high frequency next to the output in the sub-zone b3 is applied in the sub-zone b4 and a heating and drying process goes on efficiently. Finally, a “slight” heating and drying process is performed as a finish in the sub-zone b5, and molding of the molded articles is completed.

Thus, in the present invention, a zone where no high frequency is applied, may be provided in the heating zone B. Furthermore, in case that both dielectric heating and external heating are used, it is possible to include the external heating zone in the heating zone B. Especially, it is possible to attain improved moldability and desirable properties of the finished products (molded articles) by providing the high-frequency application suspension zone depending on the raw materials 14.

Or, in this embodiment, as shown in FIG. 18, the heating zone B may be divided into the sub-zones b1 and b2. The high-frequency application suspension zone d may be provided between the sub-zones b1 and b2, and the gas heating section 9 may not be provided in the high-frequency application suspension zone d.

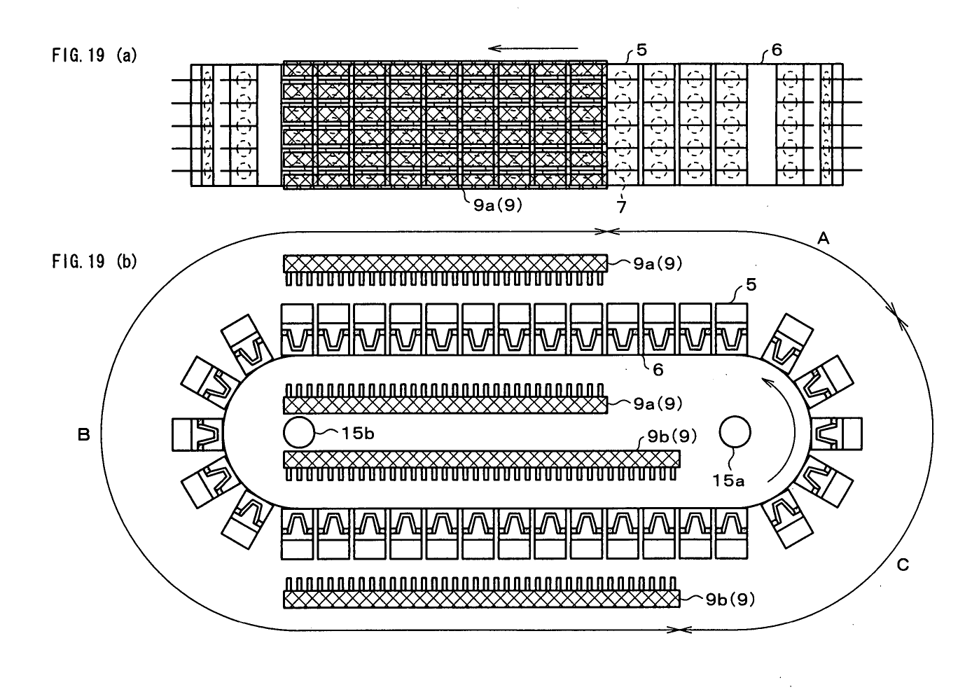

Namely, the sub-zones b1 and b2 have the power source sections 2a and 2b as well as the power feeding sections 3a and 3b, respectively, and also have the gas heating sections 9a and 9b, respectively, as shown in FIG. 19. However, in the high-frequency application suspension zone d, not only the power source section 2 and the power feeding section 3 but also the gas heating section 9 is not provided.

More specifically, the above sub-zone b1 is provided in an area subsequent to the raw material feeding zone A, having a length equivalent to that of the nine united metal molds 5, which can apply high frequency to the forty-five metal molds 7 in total. Also, a high-frequency output from the power source section 2a in the sub-zone b1 is 50 kW and an output to each of the metal molds 7 is 1.1 kW. In addition, as described above, the gas heating section 9a equivalent to the length of the sub-zone b1 is provided.

On the other hand, the sub-zone b2 is provided in an area previous to the pickup zone C having a length equivalent to that of the eleven united metal molds 5, which can apply high frequency to the fifty-five metal molds 7 in total. Also, a high-frequency output from the power source section 2b in the sub-zone b2 is 50 kW, and the output to each of the metal molds 7 is 0.9 kW. In addition, as described above, the gas heating section 9b equivalent to the length of the sub-zone b1 is provided.

Furthermore, the high-frequency application suspension zone d is provided between the sub-zones b1 and b2 and near the end of the supporting axis 15b of the conveyer 6, having a length equivalent to that of the five united metal molds 5. In this high-frequency application suspension zone d, either high frequency or external heating is not applied to twenty-five metal molds 7 in total. In other words, the high-frequency application suspension zone d is a zone to suspend heating.

If case that the conveyer 6 is no-end plate type, the conveyer 6 is curved as an arc near the supporting axes 15a and 15b stretching the conveyer 6, whereby the power feeding section 3 and the gas heating section 9 are disposed curvedly. In the curved area (referred to as R-area), high frequency is more likely to be localized, and the structure of the manufacturing apparatus becomes relatively complicated by making or disposing the power feeding section 3 and the gas heating section 9 in the configuration corresponding to the R-area.

On the other hand, in this embodiment, the R-area corresponds to an area to suspend heating where no high frequency is applied. Since high frequency is not applied to the area where it is likely to be localized, it is possible to prevent concentration of high-frequency energy more steadily.

In addition, as described in the above embodiment 1, in case that external heating is also used, the temperature of the united metal molds does not almost decrease. Even if all heating is suspended in the R-area, the raw materials 14 inside the united metal molds 5 are continuously heated through external heating.

Therefore, the high-frequency application suspension zone d becomes the external heating zone as the above high-frequency application suspension zone b2-2 shown in FIG. 17. In result, the raw materials 14 are stabilized through moderate heating and matured (cured). If high frequency is applied to the raw materials 14 after maturation in the sub-zone b2, it is possible to improve moldability of the raw materials 14 and properties of the molded articles Moreover, it is possible to design a manufacturing apparatus that does not have the power feeding section 3 or the gas heating section 9 in the R-area since the above high-frequency application suspension zone d is not equipped with any heating means. In result, it is possible to simplify the structure of the manufacturing apparatus.

In this embodiment, it is also possible to further improve quality of the molded articles by providing the high-frequency application suspension zone at either an initial stage or a last stage of the heating process.

For instance, as described in the embodiment 2, in case of baking the starchy and watery mixture and making molded articles, it is not preferable to apply a very large output of high frequency, since an electrical property of the raw materials (property of high frequency) changes significantly at an initial stage of heating and molding. In other words, at an initial stage of the heating process, water included in the starchy and watery mixture is so much (moisture content is high). If strong heating is applied through dielectric heating at an initial heating stage, the starchy and watery mixture rapidly changes the property. It results in poorer moldability of baked and molded articles (heated and molded articles) or weaker and fragile baked and molded articles, which gives problems of excessively light texture, for example, in case of the baked and molded articles such as edible containers or baked and molded confectioneries.

In FIG. 26, an area corresponding to the sub-zone b1 is provided as the high-frequency application suspension zone b1-1 without the power source section 2a and the power feeding section 3a. In other words, an external single heating zone b1-1 is provided at an initial heating stage.

It is possible to heat the raw materials 14 moderately by providing the external single heating zone at an initial stage of the heating process, whereby the raw materials 14 are stabilized in the united metal molds 5 (metal molds 7). Even if the raw materials 14 are the above starchy and watery mixture containing much water, it is possible to prevent a reduction of moldability or strength of the molded articles. In result, it is possible not only to further improve quality of the molded articles, but also to adjust properties (strength or texture etc.) of the molded articles to obtain target properties.

Similarly, for example, in case that molded articles are manufactured by baking the above starchy and watery mixture, a heating and drying process is almost completed at a last stage of heating and molding. Therefore, applying much heat causes overheating resulting in poorer properties of the molded articles. In other words, a last stage of the heating process corresponds to a last stage of drying the molded articles. If strong heating such as dielectric heating is performed, the molded articles get a scorch due to overheating for some kinds of raw materials and shapes of molded articles. The generation of a scorch deteriorates quality of the molded articles, and in some cases, generates a spark between an upper half and a lower half of the united metal mold 5 (refer to the inside metal mold half 5a and the outside metal mold halves 5b and 5b as shown in FIGS. 3(a) and (b), or the upper metal mold half 5c and the lower metal mold half 5d as shown in FIGS. 4(a) and (b)), which may make it difficult to make the molded articles steadily.

In FIG. 27, an area corresponding to the sub-zone b5 is provided as the high-frequency application suspension zone b1-1 without the power source section 2e or the power feeding section 3e. In other words, the external single heating zone b5-1 is provided at a last heating stage.

By providing the external single heating zone at a last stage of heating and molding, it is possible to moderately heat the molded articles at a finish of drying for the molded articles, and thereby to prevent overheating of the molded articles. In result, it is possible to prevent a scorch on the molded articles or a spark deriving from a scorch, thereby enabling steady production of high quality molded articles.

An output in the other sub-zones than the external single heating zone b1-1 at an initial stage or the external single heating zone b5-1 at a last stage is not specifically limited. In both examples in FIG. 26 and FIG. 27, the heating zone is practically divided into four sub-zones from a viewpoint of dividing a high-frequency output, as described above. Of course, a length in each of the sub-zones, the external single heating zones b1-1 and b5-1 are all equivalent to that of the five united metal molds 5.

As the example shown in FIG. 17, a higher output may be set in an area where more heat capacity is preferable, out of each of the sub-zones.

In the example shown in FIG. 26, the sub-zone b1 replaces the external single heating zone b1-1. In the sub-zone b2 just subsequent to the sub-zone b1, an output is set at 20 kW (an output to each of the metal molds 7 is 0.8 kW), where after external heating, dielectric heating is moderately performed. In the sub-zones b3 and b4 subsequent to the sub-zone b2, an output is set at 30 kW (an output to each of the metal molds 7 is 1.2 kW), where stronger heating is performed. Then, an output in the sub-zone b5 is set at 20 kW (the output to each of the metal molds 7 is 0.8 kW), where dielectric heating is moderately performed as a finish.

Also, in the example shown in FIG. 27, the sub-zone b5 replaces the external single heating zone b5-1. In the first sub-zone b1, an output is set at 20 kW (an output to each of the metal molds 7 is 0.8 kW), and moderate heating at an initial stage is performed. Then, in the sub-zones b2 and b3 subsequent to the sub-zone b1, an output is set at 30 kW (an output to each of the metal molds 7 is 1.2 kW), where stronger heating is performed. Then, in the sub-zone b4, the output is set at 20 kW (an output to each of the metal molds 7 is 0.8 kW) to switch strong heating to moderate heating. In the external heating zone b5-1, moderate heating is performed as a finish.

In the examples shown in FIG. 26 and FIG. 27, an output in each of the sub-zones may be all the same (not shown). For instance, in the example of FIG. 26, an output in the sub-zones b2, b3, b4 and b5 may be all preset at 25 kW (an output to each of the metal molds 7 is 1.0 kW). Similarly, in the example of FIG. 27, an output in the sub-zones b1, b2, b3, and b4, may be all set at 25 kW (an output to each of the metal molds 7 is 1.0 kW).

The method of setting up the high-frequency application suspension zone in this embodiment is not limited to those above. In other words, the sub-zone b3 or b4 may be the high-frequency application suspension zone, or high frequency may be applied only in the sub-zones b2, b3 and b4 by combining the external single heating zone b1-1 at an initial stage with the external single heating zone b5-1 at a last stage. Namely, the heating zone B in the present invention may be constructed so that desirable heating can be performed depending on the kinds of molded articles or raw materials 14, and it is not limited to the above examples. Of course, in some cases, an output may be just changed by the sub-zone in the above embodiment 2.

As described above, in this embodiment, the high-frequency application suspension zone is included in the heating zone, where moderate heating is performed through external heating in case of using both dielectric heating and external heating. It is thus possible to improve moldability and attain a desirable property of the finished products by setting up the high-frequency application suspension zone depending on the raw materials. Also, by setting up the high-frequency application suspension zone in an area where an electrical property of the raw materials changes most significantly, concentration of high-frequency energy can be prevented. In addition, since moderate heating can be performed through external heating before the sub-zone to apply the largest output of high frequency in the heating zone, it is possible to properly heat and mold the raw materials.

In this embodiment, in order to include the high-frequency application suspension zone, it is possible to design a manufacturing apparatus so that high frequency may not be applied to an area where high frequency is likely to be localized. It is thus possible to prevent concentration of high frequency energy more steadily.

Moreover, from the characteristics of external heating, it is possible to make the high-frequency application suspension zone of the external heating zone where external heating is only performed, whether the external heating means is provided in the high-frequency application suspension zone or not. Especially, if an area where it is difficult to provide the power feeding section or the external heating means is set up as the high-frequency application suspension zone, it is unnecessary to provide various heating means, thereby simplifying the structure of the manufacturing apparatus.

In addition, it is possible to perform heating depending on the raw materials, by providing the high-frequency application suspension zone at either an initial stage or at a last stage of the heating process, and thereby to improve quality of the molded articles attained or productivity. Especially, the method to install the high-frequency application suspension zone at an initial stage and at a last stage is preferably used in case of using the starchy and watery mixture with a high moisture content or in case of producing the molded articles which are likely to get a scorch such as the above baked and molded articles.

### EMBODIMENT 4

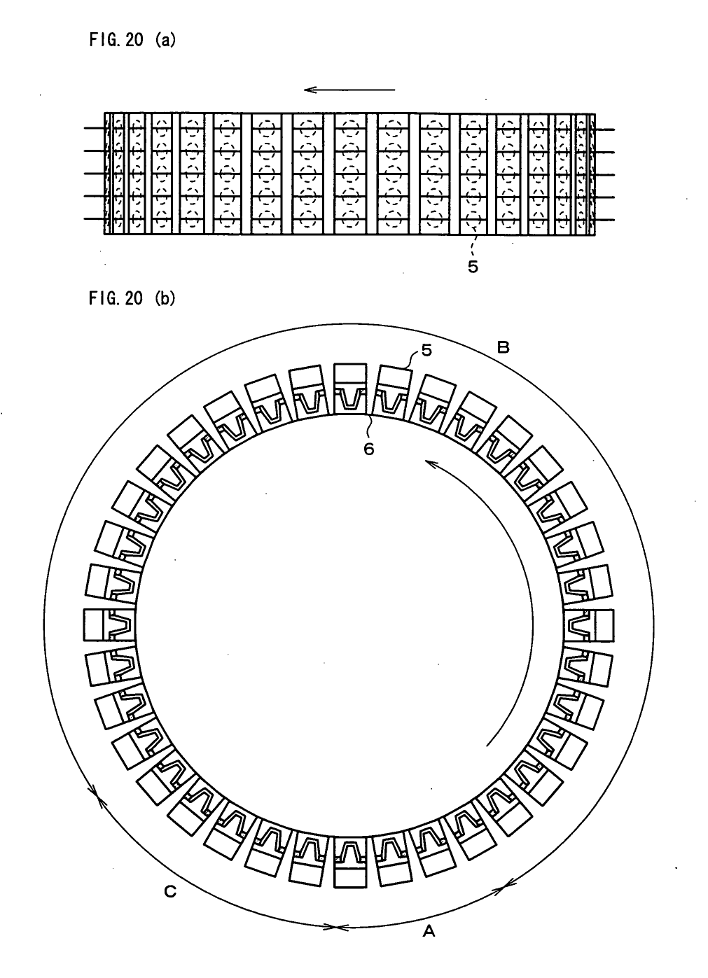

Still another embodiment of the present invention is described below referring to FIG. 20 to FIG. 23. The present invention is not limited to this embodiment. For convenience of explanation, the same numbers are shown for the members having the same function as the members used in the above embodiments 1 to 3 with the explanation left out.

In the above embodiments 1 to 3, the conveyer 6 has a layout of no-end plate type, while in this embodiment, another layout of the conveyer 6 is explained.

For example, as shown in FIGS. 20(a) and (b), the conveyer 6 has a layout of a Ferris wheel type disposed circularly and installed rotatively and vertically. Viewing from the top, as shown in FIG. 20(a), the united metal molds 5 are rotatively transferred from an upper part to a lower part in the direction of the arrow. Viewing from the side, as shown in FIG. 20(b), the united metal molds 5 are mounted entirely on an outer periphery of the cylindrical conveyer 6 and are rotatively transferred in the direction of the arrow.

As shown in FIG. 20(a), this Ferris wheel type layout also has the raw material feeding zone A, the heating zone B, and the pickup zone C, as no-end plate-type layout. It is preferable that the raw material feeding zone A and the pickup zone C are provided in a lower area to smoothly feed the raw materials or pick up the molded articles, due to the layout.

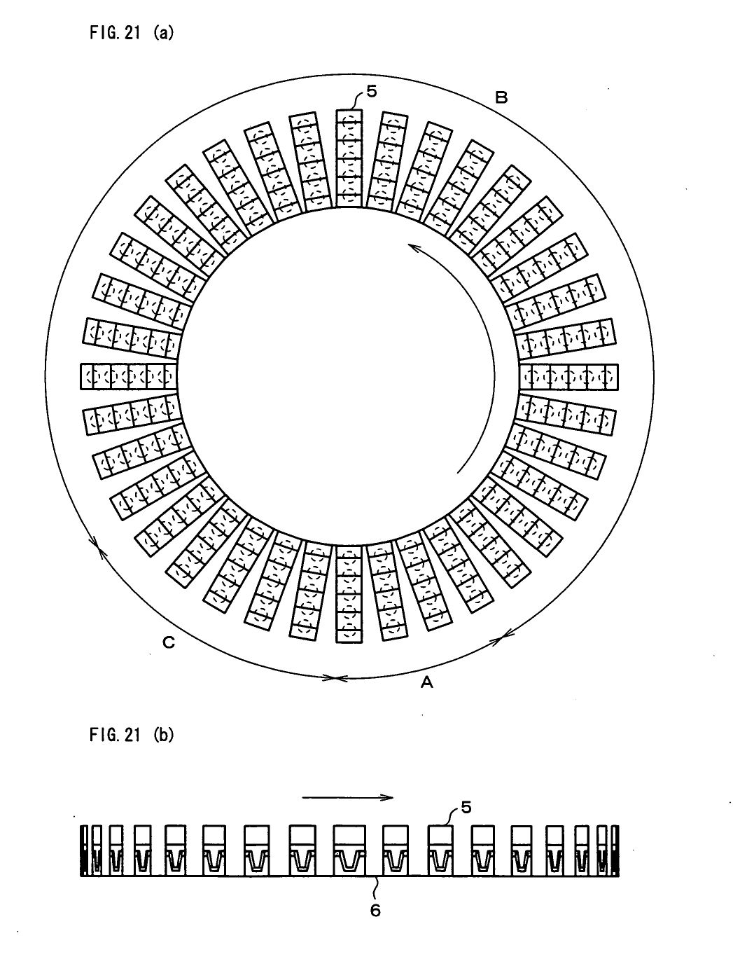

Or, as shown in FIGS. 21(a) and (b), there may be a horizontal disc-type layout, disposed circularly and rotatively on a horizontal surface. Viewing from the top, as shown in FIG. 21(a), the united metal molds 5 are radially disposed and rotatively transferred in the direction of the arrow. Viewing from the side, as shown in FIG. 21(b), the above united metal molds 5 are radially mounted on the top surface of the circular conveyer 6 and rotatively transferred in the direction of the arrow.

As shown in FIG. 21(b), in this horizontal disc-type layout, each of the process zones may be set up anywhere, since it is the same thing no matter where the raw material feeding zone A, the heating zone B, and the pickup zone C is provided on the conveyer 6.

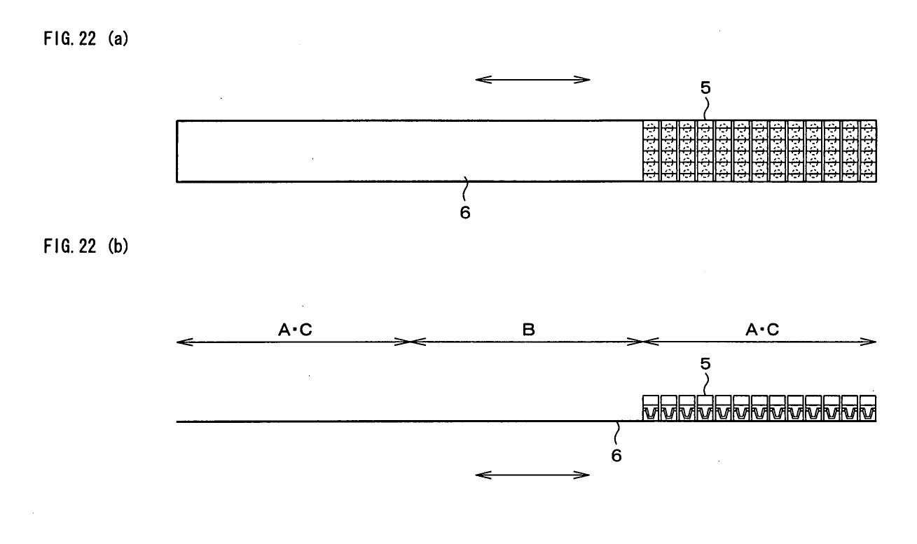

In addition, as shown in FIGS. 22(a) and (b), there may be a straight type layout which makes a round-trip movement on a horizontal surface. Viewing from the top, as shown in FIG. 22(a), for example, the thirteen united metal molds 5 are disposed in a row along the longitudinally extending sides of the conveyer, which can make a round trip movement in the direction of the arrow. Viewing from the side, as shown in FIG. 22(b), the above united metal molds 5 are mounted on the top surface of the conveyer 6 disposed on the horizontal surface and rotatively transferred in the direction of the arrow.

As shown in FIG. 22(b), it is preferable that in this straight type layout, the heating zone B is provided in the center, and both the raw material feeding zone A and the pickup zone C are provided on the ends of the conveyer 6 for both uses.

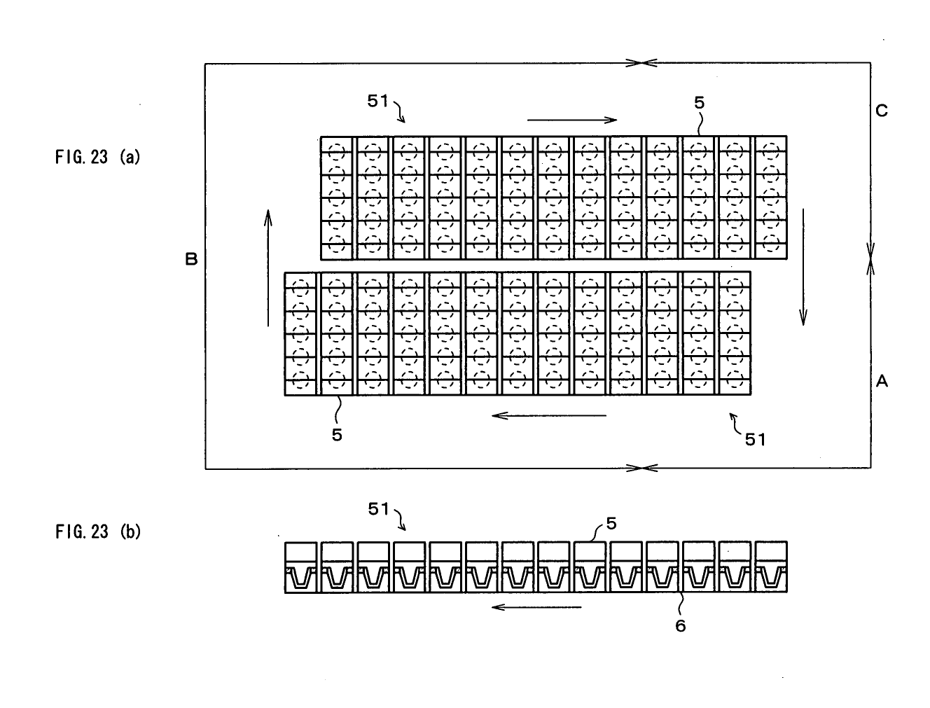

Or, as shown in FIGS. 23(a) and (b), there may be a partial tact type layout wherein the metal molds 5 disposed in rows along the longitudinally extending sides are arranged in two rows on parallel, and on both of the ends the united metal molds 5 are continuously moved to an adjacent straight disposition 51.

Viewing from the top, as shown in FIG. 23(a), the straight disposition consists of the thirteen united metal molds 5, and each of the straight dispositions is adjacent each other by the metal mold 5 spaced apart. For example, in the left end of the figure showing the straight dispositions 51 and 51, the united metal molds 5 move upward from the lower straight disposition 51, and in the right end of the figure, the united metal molds 5 move downward from the upper straight disposition 51. Viewing from the side, as shown in FIG. 23(b), the above united metal molds 5 are mounted on the top surface of the conveyer 6 and transferred in the direction of the arrow, and in both ends, the united metal molds 5 are moved adjacently to the straight disposition 51.

As shown in FIG. 23(a), in the partial tact type layout, each of the process zones may be set up anywhere, since it is the same thing no matter where the raw material feeding zone A, the heating zone B, and the pickup zone C is provided on the conveyer 6.

The above layouts including the no-end plate-type layout are roughly divided into; a structure that the united metal molds 5 are mounted on an outer periphery of the conveyer 6 having no ends; and a structure that the united metal molds 5 are mounted on the top surface of the horizontally extended conveyer 6. However, a desirable layout or structure is not particularly limited since it depends on properties of the raw materials 14 and molded articles, or conditions of a place where the manufacturing apparatus is installed. The above layouts or structures are just examples and other layouts or structures can be used in the present invention.

As described above, in the manufacturing process in accordance with the present invention, the layout of the conveyer 6 is not limited, and it is possible to make a preferable layout depending on properties of the raw materials and molded articles, or conditions of a place where the manufacturing apparatus is installed.

### EMBODIMENT 5

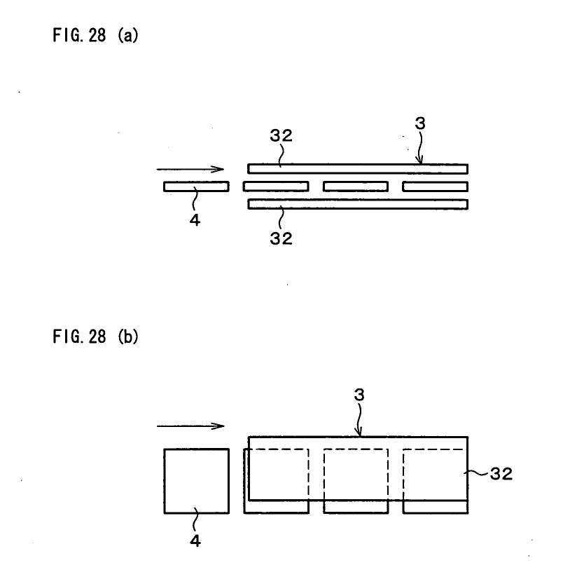

Still another embodiment of the present invention is described below referring to FIG. 28 to FIG. 33. The present invention is not limited to this embodiment. For convenience of explanation, the same numbers are shown for members having the same function as the members used in the above embodiments 1 to 4 with the explanation left out.

In the above embodiments 1 to 4, the structures of the heating zone B are explained in detail. In this embodiment, a preferable structure of the power feeding and receiving section is described in detail.

More specifically, as described in the embodiment 1, in the manufacturing apparatus used in the present invention, the heating section 1 includes the power feeding section 3 and the metal molds 7 (or united metal molds 5). (Refer to FIG. 2 etc.) The above power feeding section 3 has a rail shape, in correspondence with the plate-type power receiving sections 4 equipped with the metal molds 7 (refer to FIG. 10(a) to (c)). In this structure, as shown in FIGS. 28(a) and (b), the plate-type power receiving sections 4 move in the direction of the arrow in the figure and they are inserted into the rail-shaped power feeding section 3 with no contact.

Usually, the rail-shaped power feeding section 3 has the same shape, for example, a rough U-shaped section, near an inlet to the power feeding section 3 and also at the other parts, shown in FIGS. 28(a) and (b). However, if a part near the inlet and the other parts have the same shape, power starts to be supplied rapidly from the power feeding section 3 to the power receiving sections 4, which may not be preferable for some kinds of raw materials 14 or molded articles.

As described in the above embodiments 2 and 3, for instance, an electrical property (property of high frequency) of the above starchy and watery mixture significantly changes at an initial stage of heating and molding. Accordingly, applying a very large output of high frequency is not preferable.

It is thus possible to gradually heat the raw materials 14 by changing a shape of the power feeding section 3 and gradually raising a power feeding level near the inlet to each of the sub-zones in the heating zone B. This stabilizes the raw materials 14 inside the united metal molds 5 (metal molds 7) and can prevent a reduction of moldability and strength of molded articles, even if the raw materials 14 contain much water as the above starchy and watery mixture. In result, it is possible not only to further improve quality of molded articles, but also to adjust properties of molded articles (strength or texture) to target properties.

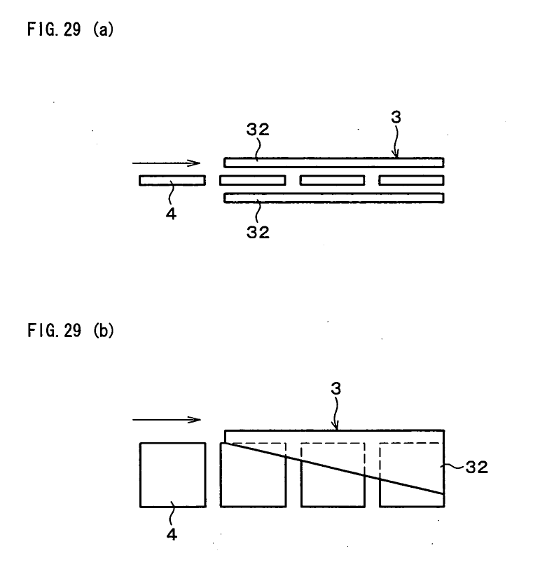

More specifically, as shown in FIGS. 29(a) and (b), the power feeding section 3 is constructed so that a pair of plate-type sides 32 and 32 wherein the plate-type power receiving sections 4 are inserted with no contact, may reduce an area toward the inlet, that is, that a rough triangle shape is formed having oblique sides upwardly inclined toward the moving direction of the united metal molds 5. Thus, an overlapped area formed by the power receiving sections 4 and the sides 32 and 32 inserting the power receiving sections 4 in between, gradually enlarges with the movement of the united metal molds 5. Then, a capacity of a condenser formed by the power receiving sections 4, the sides 32 and 32 and a space therein increases. In result, it is possible to gradually increase a power feeding level and to gradually heat the raw materials 14.

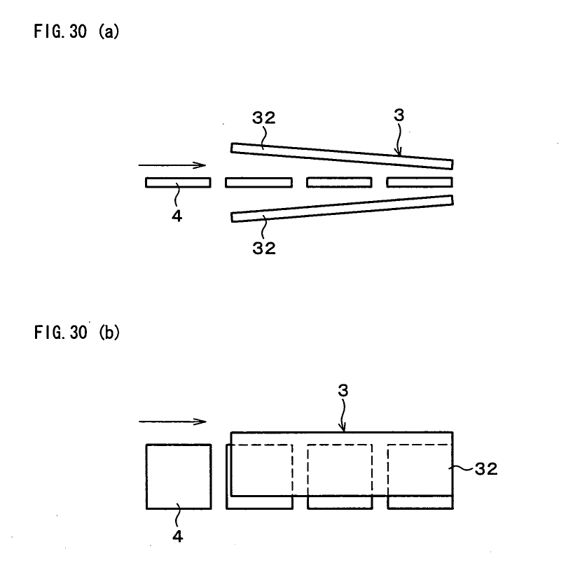

Or, as shown in FIGS. 30(a) and (b), the rail-shaped power feeding section 3 is constructed so that a distance between a pair of sides 32 and 32 (opposite distance) is extended toward the inlet, that is, a distance between the sides 32 and 32 is reduced toward the moving direction of the united metal molds 5. Since a space between the power receiving sections 4 and the sides 32 and 32 with the power receiving sections 4 in between is gradually reduced with the movement of the united metal molds 5, a capacity of a condenser formed by the power receiving sections 4, the sides 32 and 32, and a space therein increases. In result, it is possible to gradually heat the raw materials 14, by gradually increasing a power feeding level.

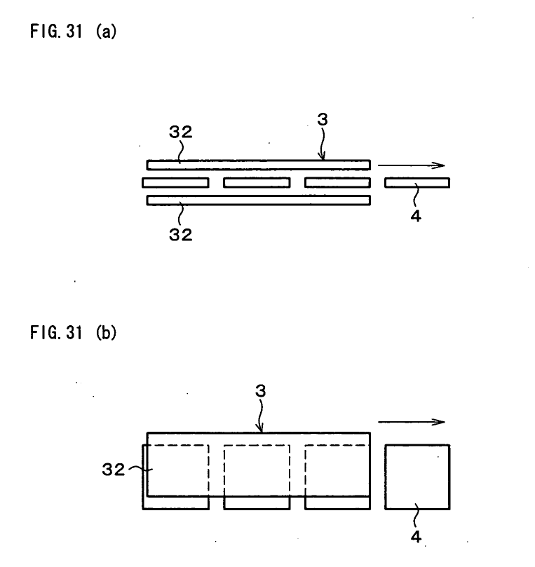

Similarly, the rail-shaped power feeding section 3 may have the same shape at a part near an outlet of the power feeding section 3 and also at the other parts shown in FIGS. 31(a) and (b). However, when a part near the outlet and the other parts have the same shape, power supply from the power feeding section 3 to the power receiving sections 4 suddenly finishes, which may not be preferable for some kinds of raw materials 14 or molded articles.

For example, as described in the above embodiments 2 and 3, for baked and molded articles made from the above starchy and watery mixture, in case that much heat is applied at a last stage of heating and molding, the molded articles get a scorch due to overheating, with a poorer property. In addition, a scorch may cause a spark.

If a power feeding level is gradually reduced by changing a shape of the power feeding section 3 near an outlet in each of the sub-zones in the heating zone B, it is possible to gradually reduce a level of heating the raw materials 14. Then, it is possible to moderately heat molded articles for a finish of drying the molded articles, and to prevent overheating of the molded articles. In result, it is possible to prevent a scorch on molded articles and a spark deriving therefrom, and to steadily produce high quality molded articles.

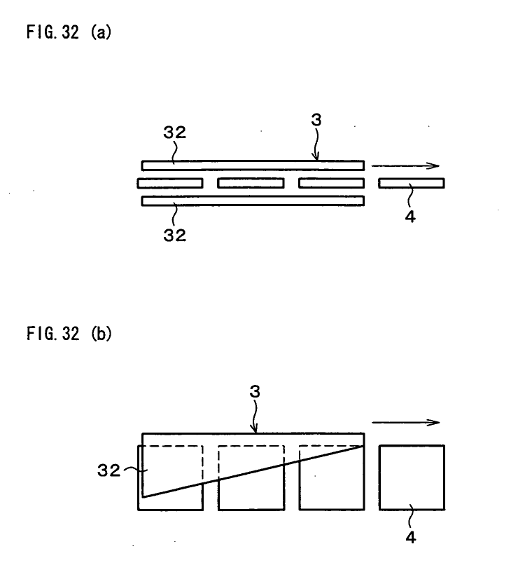

More specifically, as shown in FIGS. 32(a) and (b), the power feeding section 3 is constructed so that a pair of sides 32 and 32 gradually reduces an area toward the outlet, that is, a rough triangle shape is formed with oblique sides downwardly inclined toward the moving direction of the united metal molds 5. Thus, an overlapped area of the power receiving sections 4 with the sides 32 and 32 inserting the power receiving sections 4 in between is gradually reduced toward the moving direction of the united metal molds 5. A capacity of a condenser formed by the power receiving sections 4, the sides 32 and 32, and a space therein, is reduced. In result, it is possible to gradually decrease a power feeding level and to gradually decrease heating applied to molded articles.

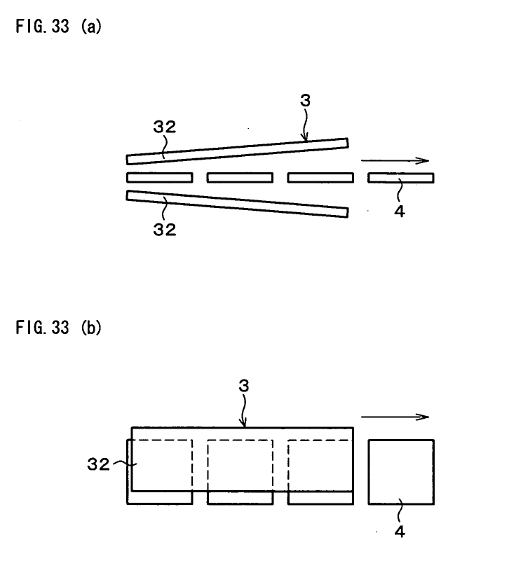

Or, as shown in FIGS. 33(a) and (b), the rail-shaped power feeding section 3 is constructed so that a distance between a pair of sides 32 and 32 (opposite distance) is extended toward the outlet, that is, a distance between the sides 32 and 32 is extended toward the moving direction of the united metal molds 5. Since a space between the power receiving sections 4 and the sides 32 and 32 with the power receiving sections 4 in between is gradually extended toward the moving direction of the united metal molds 5, a capacity of a condenser formed by the power receiving sections 4, the sides 32 and 32, and a space therein is decreased. In result, it is possible to gradually reduce a power feeding level and to gradually reduce heating applied to molded articles.

Thus, in this embodiment, the power feeding section 3 is constructed so that the overlapped area (opposite area) of the power receiving sections 4 with the side 32 (opposite side) of the power feeding section 3 may be changed along the moving direction of the united metal molds 5 (moving passage), or so that a distance (opposite distance) between the power receiving sections 4 and the sides 32 (the opposite side) of the power feeding section 3, may be changed along the moving direction (the moving passage) of the united metal molds 5, in order to gradually change a level of high frequency applied to the united metal molds 5. This can improve moldability of molded articles and can attain desirable properties of molded articles.

As a way of changing the opposite area, as mentioned above, it is preferable to change an area of the side (opposite side) 32 along the moving direction of the united metal molds 5. As a way of changing the opposite distance, as mentioned above, it is preferable to change a distance between a pair of sides (opposite sides) 32 and 32 along the moving direction of the united metal molds 5. However, the way is not limited to those above. Also, in the above example, the way of continuously changing the opposite area and the opposite distance is explained, but not limited to those. Namely, if an application level of high frequency can be changed, the distance between the side 32, that is, the opposite side, and the power receiving sections 4 can be changed in any way, for example, step by step.

In addition, this embodiment is constructed so that a shape of the power feeding section 3 is changed in order to change a level of applying high frequency, but the present invention is not limited to this. Especially, in case that the opposite area between the power feeding section 3 and the power receiving section 4 is changed, the shape of the power receiving section 4 may be changed instead of the power feeding section 3.

As mentioned above, in this embodiment, a power feeding level can be changed by making the rail-shaped power feeding section wherein the plate-type power receiving section is inserted or the power receiving section, which changes the shape along the moving passage of the power receiving section (i.e. moving passage of the metal molds) in the neighborhood of either an inlet or an outlet to the heating zone.

It is thus possible to adjust a heating level as the above embodiments 2 and 3, and to improve moldability of molded articles or attain desirable properties of finished articles. Especially, since step-by-step heating can be performed at an initial stage or a last stage of the heating process, it is possible to heat and mold the raw materials properly.

Also, it is possible to adjust a strength of heating at an optional position by combining the way to change the shape of the rail-shaped power feeding section in this embodiment, with the way to divide the heating zone, the way to change an output by the sub-zone and the way to set up the high-frequency application suspension zone shown in the above embodiments 1 to 3. For example, it is possible to perform proper heating based on a condition of raw materials and molded articles by changing a shape of the power feeding section near an inlet or an outlet to each of the sub-zones.

### EMBODIMENT 6

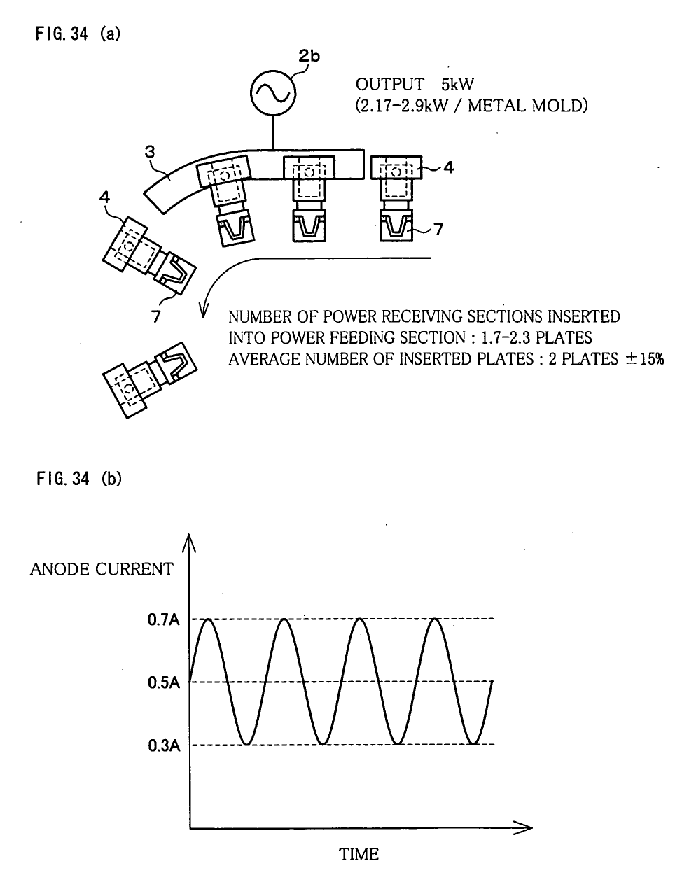

Still another embodiment of the present invention is described below referring to FIG. 34 to FIG. 36. The present invention is not limited to this embodiment. For convenience of explanation, the same numbers are shown for the members having the same function as the members used in the above embodiments 1 to 5 with the explanation left out.

In the above embodiments 1 to 5, the structure of the heating zone B and the power feeding and receiving section is explained. In this embodiment, a preferable method to transfer the power receiving sections, that is, the metal molds, to the heating zone is explained in detail.

More specifically, as illustrated in the embodiments 1 to 3, a layout of the conveyer 6 is no-end plate type, curved in an arc near the supporting axes 15a and 15b stretching the conveyer 6 (refer to FIG. 1 or FIG. 14.). The power feeding section 3 is curvedly disposed to fit the curved area (R-area) of the conveyer 6. When the metal molds 7 are transferred, there is a difference in the distance where the metal molds 7 are transferred within a definite period of time in a straight area and in the R-area of the conveyer 6.

For example, as shown in FIG. 34(a), if the power feeding section 3 is a high-frequency application zone (e.g. sub-zone b2 shown in FIG. 14) including both the straight area and the R-area, the number of the power receiving sections inserted into the power feeding section 3 (placed between the sides 32 and 32) always varies. In other words, the number of the metal molds 7 to be dielectrically heated in the above high-frequency application zone always varies. In the example shown in FIG. 34(a), the number of the power receiving sections 4 (i.e. metal molds 7) inserted into the power feeding section 3 varies from 1.7 plates to 2.3 plates, 2 plates on average, and a rate of variation is ±15%, that is, ¼ plates. In this case, if an output from the power source section 2 is 5 kW, an output to each of the metal molds 7 varies from 2.17 kW to 2.94 kW.

As mentioned above, if the number of the plate-type power receiving sections 4, that is, the united metal molds 5, inserted into the power feeding section 3 is not fixed, matching of high frequency becomes unsteady. Then, as shown in FIG. 34(b), timing of high anode current and timing of low anode current periodically appears. In other words, a change deriving from proper matching and a change deriving from improper matching are alternately repeated, which results in a condition of high anode current and a condition of low anode current alternately. In the example of FIG. 34(a), anode current varies from 0.3A at minimum to 0.7A at maximum, as shown in FIG. 34(b), which largely varies compared with the average of 0.5A.

Especially, at an initial stage of heating process (initial stage), a condition of the raw materials 14 changes most significantly, and at a last stage of heating process, a moisture content of the raw materials 14 is the lowest, whereby matching of high frequency is more likely to become unsteady and the anode current is likely to vary most extremely. Therefore, if the number of the plate-type power receiving sections 4, that is, if the number of the metal molds 7, inserted into the power feeding section 3 at an initial stage and a last stage of heating process, is not fixed, heating efficiency is likely to be reduced and a spark may be generated when the matching is improper.

In addition, it is necessary to adjust an output from the power source section 2 to a maximum (peak) value of anode current. In the examples shown in FIGS. 34(a) and (b), an output from the power source section 2 is 5 kW, that is, 0.5 A of anode current on average can be only applied. Accordingly, it is necessary to use the power source section 2 having an additional output, resulting in increased production cost of molded articles. In addition, to control the matching of high frequency at a consistent level gives a problem that a very high-speed adjustment of electrostatic capacity or inductance is necessary.

Of course, the above problem that matching of high frequency becomes unsteady may not much affect for some kinds of the raw materials 14 and molded articles. However, it is preferable to stabilize the matching of high frequency in case that baked and molded articles are manufactured using the starchy and watery mixture.

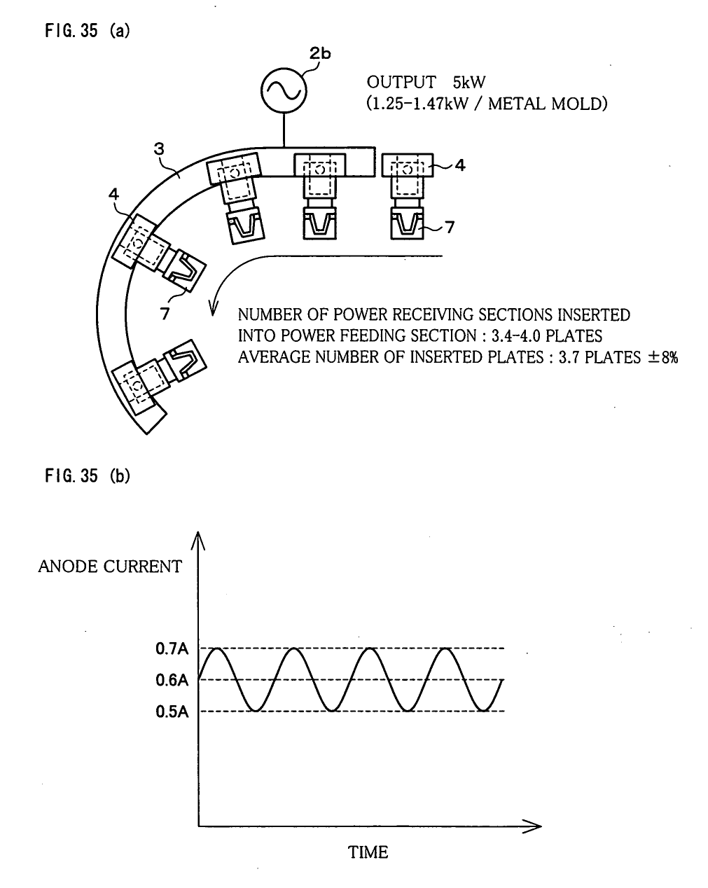

As shown in FIG. 35(a), if the high-frequency application zone includes the straight area and the R-area as the example of FIG. 34(a), a length of the high-frequency application zone is extended.

More specifically, as shown in FIG. 35(a), viewing from the moving direction of the metal molds 7, the rail-shaped power feeding section 3 is extended from a position around which R-area starts to curve, to a position before which the curve finishes. Therefore, the number of the power receiving sections 4 inserted into the power feeding section 3 changes 3.4 plates to 4.0 plates. The variation in the number of the metal molds 7 to be heated is ±0.25 plates. Though the variation in the number of metal molds 7 remains the same and the average is 3.7 plates, a rate of variation changes to ±8%, which is obviously lower than the example in FIG. 34(a).

In addition, the output to each of the metal molds 7 varies from 1.25 kW to 1.47 kW, which is lower than the example shown in FIG. 34(a). Moreover, as shown in FIG. 35(b), though the anode current varies, the variation is held down at from 0.5 A at minimum to 0.7 A at maximum, that is, approaches toward 0.6 A. In this example, though the output from the power source 2 is 5 kW as the example shown in FIG. 34(a), 0.6 A of anode current on average can be applied with improved energy efficiency.

Thus, in the present invention, it is preferable to extend a length of the high frequency application zone if it includes the straight area and the R-area. In result, it is possible to reduce a rate of variation in the number of metal molds to be heated in one of the sub-zones, thereby reducing a variation in matching of high frequency and relatively stabilizing anode current. It is thus possible to improve energy efficiency of dielectric heating by applying high frequency and to reduce a risk of a spark.

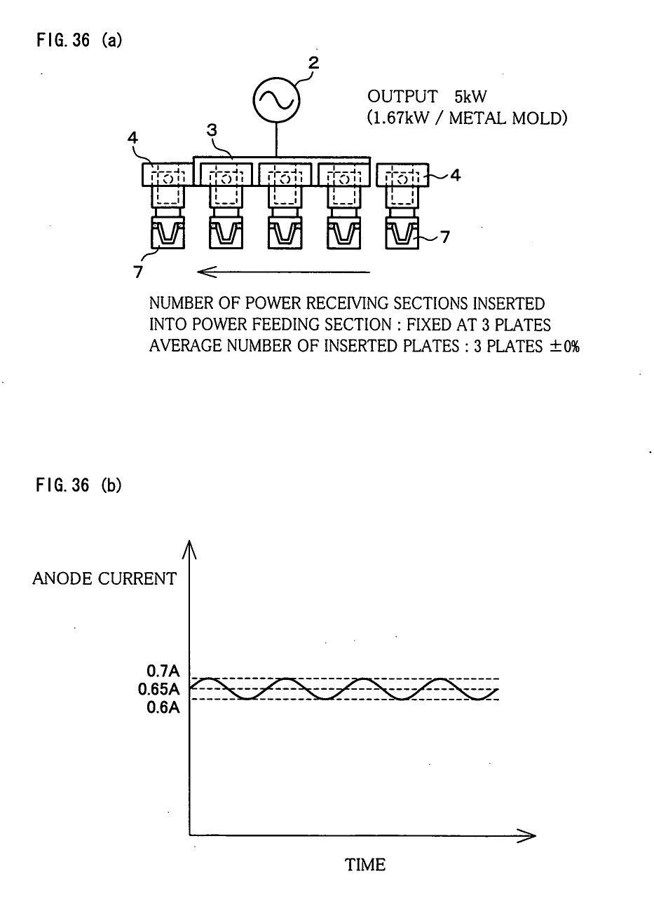

In addition, as shown in FIG. 36(a), the high-frequency application zone may be composed of the straight area only. In this case, since the R-area is not included, the number of power receiving sections 4 inserted into the power feeding section 3 is almost fixed at 3 plates, averaging 3 plates, and the variation in the number of metal molds 7 to be heated is almost ±0. In addition, the output to each of the metal molds is almost fixed at 1.65 kW. As shown in FIG. 36(b), a variation in anode current is held down at from 0.6 A at minimum to 0.7 A at maximum, approaching toward 0.65 A. Namely, in this example, though an output from the power source section 2 is 5 kW as the examples shown in FIG. 34(a) and FIG. 35(a), 0.65 A of anode current on average can be applied. Therefore, the matching of high frequency becomes much stabilized and energy efficiency is further improved.

In case that the heating zone B is designed depending on the kinds of raw materials 14 and molded articles, if the R-area is set up as the high-frequency application suspension zone and high frequency is applied in the straight area only (refer to FIG. 18), it is possible to stabilize matching of high frequency, increase energy efficiency, and prevent a spark.

The heating zone B must be constructed so that preferable heating can be performed depending on a change in condition of the raw materials 14 or the kind of molded articles attained. Especially, as explained in the above embodiments 3 and 5, if high frequency is applied at an initial stage and a last stage when the raw materials 14 significantly changes a state, it is preferable to design the high-frequency application zone to minimize a variation in anode current.

However, in designing the heating zone B, considering a change in condition of the raw materials 14 or the kind of molded articles attained, the high-frequency application zone cannot be always composed of the above-mentioned straight area only. Even if the high-frequency application zone is composed of the above straight area only, the number of power receiving sections 4 inserted into the power feeding section 3 may not be fixed in some cases.

Moreover, as shown in FIG. 36(b), even if the number of power receiving sections 4 inserted into the power feeding section 3 is fixed, the anode current practically varies within from 0.6 A to 0.7 A, because the condition of the raw materials 14 in the metal molds 7 newly entering into the high-frequency application zone (the power feeding section 3 in the sub-zone) is different from the condition of the raw materials 14 in the metal molds 7 leaving the high-frequency application zone.

In this embodiment, whether the high-frequency application zone includes the R-area or the straight area only, a rate of variation in the number of metal molds 7 to be heated in one of the high-frequency application zones (the sub-zones) is set within a given range, based on which a length of high-frequency application zone is determined.

More specifically, in this embodiment, if the rate of variation in the number of the metal molds 7 to be heated is indicated as C, the rate of variation C can be determined by the following formula. Nₘₐₓ is the maximum number of the power receiving sections 4 inserted into the power feeding section 3, Nₘᵢₙ is the minimum number of the power receiving sections 4 inserted into the power feeding section 3, and Nₐᵥₑ is the average number of the power receiving sections 4 inserted into the power feeding section 3.
C={(Nₘₐₓ−Nₘᵢₙ)/2}/Nₐᵥₑ

In other words, the rate of variation C in the number of metal molds 7 is calculated by dividing the difference between the maximum number and the minimum number of the power receiving sections 4 inserted into the power feeding section 3 by 2 and then dividing the result by the average number of the power receiving sections 4.

In this embodiment, it is preferable to determine a length of the high-frequency application zone so that the above rate of variation C may be more than 0 to less than 0.5 (0≦C<0.5). Especially, it is preferable to determine a length of the high-frequency application zone so that the above rate of variation C may be 0 or more than 0 to less than 0.1 (0≦C<0.1).

As mentioned above, in the sub-zone applying high frequency included in the heating zone (high-frequency application zone), a length is determined so that the number of the power receiving sections inserted into the power feeding section may be fixed as much as possible. It is thus possible to reduce a variation in the number of metal molds to be dielectrically heated by applying high frequency in one of the sub-zones, thereby stabilizing matching of high frequency and reducing a variation in anode current. In result, it is possible not only to improve energy efficiency but also to prevent a spark.

Based on the embodiments, comparative examples, and conventional arts, the method for manufacturing heated and molded articles in accordance with the present invention is explained below in more detail, but the present invention is not limited to those above. In the following explanation, weight ratio is simply referred to as ratio, and weight % is simply referred to as %. Out of various properties, including a rate of sparking by applying high frequency in the heating zone, moldability of the raw materials and properties of the molded articles attained and other various properties given to the molded articles by performing both dielectric heating and external heating, emergent effects from additives and baked condition are evaluated based on the following methods.

Rate of Sparking

In the heating zone B, as mentioned above, high frequency energy is likely to be concentrated and to generate a spark due to localized high frequency. The generation of a spark is evaluated based on a rate of sparking. The double circle indicates that a spark is not generated at all. The single circle indicates that a spark is not almost generated. The triangle indicates that a spark is sometimes generated. The cross mark indicates that a spark is generated very often.

Moldability of Raw Materials

Moldability of the raw materials 14 is totally evaluated for separatability from the metal molds 7 (the united metal molds 5) and holding a shape of molded articles. The double circle indicates the molded articles can be completely separated from the metal molds and hold a good shape. The single circle indicates that the molded articles are almost completely molded though there are slight difficulties in separatability from the metal molds and holding a shape of molded articles. The triangle indicates that molding is possible though there are some difficulties in separatability from the metal molds and holding a shape of molded articles, and some improvements are necessary. The cross mark indicates that molding is impossible.

Properties of Molded Articles

Properties of molded articles are totally evaluated based on appearance, hue and texture to check strength and a structure of the molded articles attained. The double circle indicates “excellent”. The single circle indicates “good”. The triangle indicates “rather good” enough to use the molded articles. The cross mark indicates that the molded articles cannot be used due to some defects.

Emergent Effect from Additives

An emergent effect from additives is evaluated using a red coloring and a flavoring. The double circle indicates that molded articles have a slightly brownish red color with an excellent coloration. The single circle indicates a good coloration. The triangle indicates that a red color is colored a little poorly with a slightly poor coloration. The cross mark indicates that the molded articles have a brownish color due to a very poor red coloring and a poor coloration.

Similarly, for flavorings, the double circle indicates that an excellent flavor is left in the molded articles. The single circle indicates that a good flavor is left. The triangle indicates that a slightly poor flavor is left. The cross mark indicates that the flavor is not almost left.

Baked Condition

A baked condition is evaluated for a baked color and a roast smell of molded articles. For a baked color, the double circle indicates “enough dark”. The single circle indicates “dark”. The triangle indicates “light”. The cross mark indicates “very light”. For a roast smell, the double circle indicates “very strong”, single circle indicates “strong”, the triangle indicates “hardly smells” (“slightly smells”), and the cross marks indicates “no smell”.

Preparation of Raw Materials

To make the composition shown in Table 1, flour and/or starch as main ingredients, and sub ingredients “a” or “b” are added to water, and then by fully agitating and mixing, starchy and watery mixtures A to F (hereinafter referred to as raw materials A to F) are prepared. The solids and viscosity of each of the raw materials are shown in Table 1. The raw materials A to C as well as E and F containing the sub ingredients “a” are the raw materials 14 for edible containers. The raw materials D containing the sub ingredient “b” are the raw materials 14 for biodegradable molded articles.

TABLE 1

| | | Raw materials (weight ratio) | | | | | |
|---|---|---|---|---|---|---|---|
| | | A | B | C | D | E | F |
| Main | Flour | 100 | 100 | 100 | 0 | 100 | 100 |
| ingredients | Corn starch | 15 | 20 | 20 | 0 | 15 | 20 |
| | Sweet potato starch | 5 | 0 | 0 | 0 | 5 | 0 |
| | Potato starch | 0 | 0 | 0 | 100 | 0 | 0 |
| Sub | Salt | 0 | 1 | 0.5 | — | 0.5 | 1.5 |
| ingredients | Sugar | 5 | 5 | 60 | — | 5 | 5 |
| “a” | Flavor enhancer | 0 | 0 | 5 | — | 0 | 0 |
| | Inflating agent | 0.5 | 0.5 | 0.5 | — | 1 | 0.5 |
| | Colorings | 1 | 1 | 1 | — | 1 | 1 |
| | Flavorings | 1 | 1 | 1 | — | 1 | 1 |
| | Oil and fat, Emulsifier | 2 | 2 | 2 | — | 2 | 2 |
| Sub | Diatomaceous earth | — | — | — | 1 | — | — |
| ingredients | Locust bean gum | — | — | — | 2 | — | — |
| “b” | Stearin | — | — | — | 1 | — | — |

| | | | | | | |
|---|---|---|---|---|---|---|
| Total solids | 129.5 | 130.5 | 190 | 104.0 | 130.5 | 131 |
| Water | 130 | 130 | 190 | 100 | 160 | 130 |
| Content of solids (%) | 49.9 | 50.1 | 50.0 | 50.9 | 44.9 | 50.2 |
| Viscosity (cP) | 2700 | 2700 | 3300 | 3500 | 1200 | 2700 |

The corn starch in Table 1 includes not only general corn starch, but also waxy corn starch, high-amylose corn starch, industrially-modified a corn starch, cross-linked corn starch. The composition of starch is optional and determined accordingly.

Shape of Molded Articles

For a shape of molded articles, in case of edible containers, a conical cone cup 8a shown in FIGS. 5(a) and (b) or a flat waffle cone 8b shown in FIGS. 6(a) and (b), may be used. The size of the cone cup 8a is 54 mm in maximum diameter and 120 mm in height, and 2.0 mm in thickness. The size of the waffle cone 8b is 150 mm in diameter, and 2.0 mm in thickness.

On the other hand, for biodegradable containers, a tray 8c of a square shape with flanges on the periphery shown in FIGS. 7(a) and (b) is used. The size of the tray 8c is 220 mm in length, 220 mm in width, 21.5 mm in height and 3.5 mm in thickness.

Structure of Manufacturing Apparatus

In the examples and comparative examples shown below, a manufacturing apparatus of the following specifications is basically used:

As shown in FIG. 8, the conveyer 6 has a no-end plate-type layout stretched horizontally. In the conveyer 6, tongues (united metal molds 5) are mounted on the entire periphery of the conveyer 6. The tongue consists of the five metal molds 7 continuously disposed in one line. It is possible to continuously move the metal molds 7 by transferring the tongues. In the conveyer 6, the raw material feeding zone A, the heating zone B, and the pickup zone C are provided in the order from the neighborhood of one end (end at the side of the supporting axis 15a) along the direction of the rotative movement of the tongues.

In the heating zone B, the high-frequency heating part including the power source section 2 and the power feeding section 3 as well as the gas heating section 9 (external heating section) are provided. A high-frequency output in the entire high-frequency heating part is 100 kW. The temperature of the metal molds by external heating in the gas heating section 9 is 180° C. unless specified.

Also, the number of tongues (number of the united metal molds 5) that can be dielectrically heated in the entire heating zone B is also twenty-five. Accordingly, the number of the metal molds 7 that can be dielectrically heated is one hundred and twenty-five in the entire heating zone B.

In addition, the number of tongues on which external heating can be directly performed is also twenty-five (one hundred and twenty-five metal molds 7). However, in practice, both in the raw material feeding zone A and in the pickup zone C, the temperature of the metal molds through external heating does not almost lower, that is, it can be considered that external heating is performed on the entire manufacturing apparatus.

Way to Divide Heating Zone

In the following example, the heating zone B is divided into sub-zones, each of which has a high-frequency application part (the power source section 2 and the power feeding section 3) to apply high frequency. A condition to divide the heating zone B, that is, a way to divide the heating zone B are explained by Division numbers shown below.

Divisions 1 to 3 are the ways to divide the heating zone B into two sub-zones b1 and b2 explained in the above embodiment 1. Divisions 1, 2 and 3 correspond to structures shown in FIG. 1, FIG. 12, and FIG. 13, respectively.

Divisions 4 to 6 are the ways to divide the heating zone B into more than two sub-zones. Divisions 4, 5 and 6 correspond to a structure divided into five sub-zones shown in FIG. 14, a structure divided into five sub-zones shown in FIG. 15, and a structure divided into three sub-zones shown in FIG. 16, respectively.

Divisions 7 and 8 are the ways to provide the high-frequency application suspension zone where no high frequency is applied, in the heating zone B. Divisions 7 and 8 correspond to structures shown in FIG. 17 and 18, respectively.

Divisions 9 and 10 are the ways to provide the external single heating zone b1-1 at an initial heating stage or the external single heating zone b5-1 at a last heating stage in the heating zone B, explained in the above embodiment 3. Divisions 9 and 10 correspond to the structures shown in FIG. 26 and FIG. 27, respectively. In this example, an output in the sub-zones b2, b3, b4, and b5 based on Division 9 and 10 is all set at 25 kW (an output to each of the metal molds 7 is 1.0 kW), which is different from the structures shown in FIGS. 26 and 27.

Divisions 11 to 14 are the ways that are equipped with a structure to change a shape of the rail-shaped power feeding section receiving the plate-type power receiving section in the neighborhood of either an inlet or an outlet to the heating zone, explained in the embodiment 5. The way to divide into the sub-zones is the same as that of Division 4 divided into five sub-zones shown in FIG. 14.

Division 11 is a combination of shapes of the power feeding section shown in FIGS. 29(a) and (b) for the neighborhood of the inlet to the sub-zone b1 in Division 4. Division 12 is a combination of shapes of the power feeding section shown in FIGS. 30(a) and (b) for the neighborhood of the inlet to the sub-zone b1 in Division 4. Division 13 is a combination of shapes of the power feeding section shown in FIGS. 29(a) and (b) for the neighborhood of the inlet to the sub-zone b5 in Division 4. Division 14 is a combination of shapes of the power feeding section shown in FIGS. 30(a) and (b) for the neighborhood of the inlet to the sub-zone b5 in Division 4.

In comparative examples, a way that does not divide the heating zone B into sub-zones, is referred to as “No Division”, which corresponds to the structure shown in FIG. 25.

Moreover, in all of the Divisions except for Division 8, the gas heating section 9 is disposed in the entire heating zone B shown in FIG. 9, constituting an external heating model 1. In Division 8, the gas heating section 9 is disposed in the sub-zones b1 and b2 only shown in FIG. 19, constituting an external heating model 2. Thus, the external heating models 1 and 2 are not referred in the following examples, since they are considered combined into each of the Divisions.

### EXAMPLE 1

In the manufacturing apparatus of the above specifications, the heating zone B is divided into two to make the above Division 1 (refer to FIG. 1.). Using this manufacturing apparatus, the above raw materials A are heated and molded to make the cone cups 8a and to evaluate a rate of sparking, moldability of the raw materials 14 and properties of the molded articles. The results are shown in Table 2.

### EXAMPLE 2

In the manufacturing apparatus of the above specifications, the heating zone B is divided into five to make the above Division 4 (refer to FIG. 14). Using this manufacturing apparatus, the above raw materials A are heated and molded to make the cone cups 8a and to evaluate a rate of sparking, moldability of the raw materials 14 and properties of the molded articles. The results are shown in Table 2.

### EXAMPLE 3

In the manufacturing apparatus of the above specifications, the heating zone B is divided into five to make the above Division 5 (refer to FIG. 15). Using this manufacturing apparatus, the above raw materials A are heated and molded to make the cone cups 8a and evaluate a rate of sparking, moldability of the raw materials 14 and properties of the molded articles. The results are shown in Table 2.

### EXAMPLE OF CONVENTIONAL ART

In accordance with the art disclosed in Patent No. Hei 10-230527 of the Japanese unexamined patent application publication, the above raw materials A are heated and molded to make the cone cups 8a. More specifically, as shown in FIG. 24, a basic structure of the conveyer 6 is the same as that of the examples 1 or 2. However, each of the tongues has just one metal mold 7 only. In the heating zone B, a high-frequency output is 9 kW, the number of tongues that can be dielectrically heated is nine, and the number of the metal molds 7 is also nine. In other words, the manufacturing apparatus is smaller as a whole.

By manufacturing molded articles in accordance with the conventional manufacturing apparatus and method, a rate of sparking, moldability of the raw materials 14, and properties of the molded articles are evaluated, as the example 1. The results are shown in Table 2.

### COMPARATIVE EXAMPLE 1

Using the manufacturing apparatus of the above specifications with “No Division” structure that the heating zone B is not divided (refer to FIG. 25), the above raw materials A are heated and molded to make the cone cups 8a and evaluate a rate of sparking, moldability of the raw materials 14 and properties of the molded articles. The results are shown in Table 2.

TABLE 2

| | Examples, comparative examples and conventional art | | | | |
|---|---|---|---|---|---|
| | | | | | Comparative |
| | Example 1 | Example 2 | Example 3 | Conventional art | example |
| Division of heating zone | Division 1 | Division 2 | Division 5 | No division | No division |
| Raw materials | Raw Materials A | Raw Materials A | Raw Materials A | Raw Materials A | Raw Materials A |
| Molded articles | Cone cup | Cone cup | Cone cup | Cone cup | Cone cup |
| Rate of sparking | Δ | ◯ | ⊚ | ◯ | X |
| Moldability of raw | Δ | ◯ | ⊚ | ◯ | X |
| materials | | | | | |
| Properties of molded | Δ | ◯ | ⊚ | ◯ | — |
| articles | | | | | |

As clarified from the results in Table 2, in the manufacturing method and apparatus in accordance with the present invention, even if the manufacturing apparatus is larger, it is possible to restrain or prevent localization of high frequency by dividing the heating zone B, thereby effectively preventing a spark, overheating and dielectric breakdown. Also, it is possible to attain excellent moldability of the raw materials 14 and properties of the molded articles.

Especially, as clarified from comparison of the examples 2 and 3, in case that the cone cups 8a are molded using the raw materials A, it is possible not only to improve moldability of the raw materials 14 and properties of the molded articles, but also to almost prevent a spark, by reducing an output in the sub-zone b1 where an electrical property of the raw materials 14 changes most significantly.

In addition, if an output is gradually raised from the sub-zone b1 to the sub-zone b3 as an electrical property of the raw materials A changes less, it is possible to perform efficient high-frequency heating, preventing generation of a spark. Moreover, if the output is gradually lowered from the sub-zone b3 to the sub-zone b5, it is possible to prevent overheating of molded articles, which improves moldability, reduces a spark, and can control a finish of the heating process more easily.

On one hand, if the heating equipment is small as the conventional art, high-frequency energy necessary for each of the metal molds 7 is smaller, and an output from the power source section 2 is also smaller. Therefore, even if the heating zone B is not divided, high frequency is not almost localized, and overheating or dielectric breakdown is not almost generated.

On the other hand, as the comparative example, if the heating zone B is not divided in a larger heating equipment, that is, if the conventional art disclosed in the above Japanese unexamined patent application publication is adopted to the large-scale heating equipment, an output from the power source section 2 increases. Thus, high frequency is more-likely to be localized due to the extended heating zone B. Or, high frequency is more likely to be localized and concentrate on a certain part due to a change in a property of high frequency in the raw materials used as the raw materials 14. Accordingly, it is impossible to prevent overheating or dielectric breakdown.

### EXAMPLE 4

In the manufacturing apparatus of the above specifications, the heating zone B is divided into three to make the above Division 6 (refer to FIG. 16). Using this manufacturing apparatus, the above raw materials D are heated and molded to make the trays 8c and to evaluate a rate of sparking, moldability of the raw materials 14 and properties of the molded articles. The results are shown in Table 3.

### COMPARATIVE EXAMPLE 2

Using the manufacturing apparatus of the above specifications, having the above “No Division” structure that the heating zone B is not divided (refer to FIG. 25), the above raw materials D are heated and molded to make the trays 8c and to evaluate a rate of sparking, moldability of the raw materials 14 and properties of the molded articles. The results are shown in Table 3.

TABLE 3

Example, comparative
example

| | | Comparative |
|---|---|---|
| | Example 4 | example 2 |
| Division of heating | Division 6 | No Division |
| zone | | |
| Raw materials | Raw Materials D | Raw Materials D |
| Molded articles | Tray | Tray |
| Rate of sparking | ◯ | X |
| Moldability of raw | ◯ | X |
| materials | | |
| Properties of molded | ◯ | — |
| articles | | |

As clarified from the results in Table 3, in the manufacturing method and apparatus in accordance with the present invention, even if the raw materials 14 and the molded articles attained are the raw materials D and the biodegradable trays 8c, respectively, it is possible to restrain or prevent localization of high frequency by dividing the heating zone B, thereby reducing a spark and effectively preventing overheating or dielectric breakdown. Also, in the manufacturing method in accordance with the present invention, excellent moldability and properties of the raw materials 14 can be attained.

### EXAMPLES 5 TO 7

In the manufacturing apparatus of the above specifications, the heating zone B is divided into two to make Divisions 1, 2 or 3 (refer to FIG. 1, FIG. 12 or FIG. 13). Using this manufacturing apparatus, the above raw materials D are heated and molded to make the trays 8c and to evaluate a rate of sparking only. The results are shown in Table 4.

### EXAMPLES 8 TO 10

In the manufacturing apparatus of the above specifications, the heating zone B is divided into two to make the above Division 1, 2 or 3 (refer to FIG. 1, FIG. 12 or FIG. 13). Using this manufacturing apparatus, the above raw materials C are heated and molded to make the waffle cones 8b and to evaluate a rate of sparking only. The results are shown in Table 4.

TABLE 4

| Examples | Example 5 | Example 6 | Example 7 | Example 8 | Example 9 | Example 10 |
|---|---|---|---|---|---|---|
| Division of | Division 1 | Division 2 | Division 3 | Division 1 | Division 2 | Division 3 |
| heating | | | | | | |
| zone | | | | | | |
| Raw | Raw | Raw | Raw | Raw | Raw | Raw |
| materials | Materials D | Materials D | Materials D | Materials C | Materials C | Materials C |
| Molded | Tray | Tray | Tray | Waffle cone | Waffle cone | Waffle cone |
| articles | | | | | | |
| Rate of | ◯ | ⊚ | Δ | Δ | X | ◯ |
| sparking | | | | | | |

As clarified from Table 4, even if the heating zone B is divided into two in the same way, it is possible to significantly reduce a rate of sparking by changing a way of division depending on the kinds of raw materials 14 and molded articles.

Especially, if the trays 8c are molded from the raw materials D, it is possible to restrain generation of a spark in the entire heating zone B by reducing an output in the sub-zone b1, shortening a length of the sub-zone b1, and reducing the number of tongues (metal molds 7) that can be heated in the sub-zone b1. On one hand, if the waffle cones 8b are molded from the raw materials C, it is possible to restrain generation of a spark in the entire heating zone B by reducing an output in the sub-zone b2, shortening a length of the sub-zone b2, and reducing the number of tongues (metal molds 7) that can be heated in the sub-zone b2.

### EXAMPLES 11 AND 12

In the manufacturing apparatus of the above specifications, the heating zone B is divided to make the above Division 5 or 7 (refer to FIG. 15 or 17). Using this manufacturing apparatus, the raw materials B are heated and molded to make the above cone cups 8a and to evaluate a rate of sparking, moldability of the raw materials 14 and a property of the molded articles. The results are shown in Table 5.

TABLE 5

| Example | Example 11 | Example 12 |
|---|---|---|
| Division of heating zone | Division 5 | Division 7 |
| Raw materials | Raw Materials B | Raw Materials B |
| Molded articles | Cone cup | Cone cup |
| Rate of sparking | ◯ | ⊚ |
| Moldability of raw | ◯ | ⊚ |
| materials | | |
| Properties of molded | ◯ | ⊚ |
| articles | | |

As clarified from the results in Table 5, it is possible to mature (cure) the raw materials 14 (raw materials B) and to improve moldability of the raw materials 14 or properties of the finished articles, if the high-frequency application suspension zone b2-2 is provided in heating and molding process to moderately heat the raw materials 14 through external heating, etc., depending on the kinds of raw materials 14 and molded articles. Also, it is possible to effectively prevent localization of high frequency and to reduce a rate of sparking if external heating is performed in an area where an electrical property of the raw materials 14 (raw materials B) changes significantly.

### EXAMPLES 13 TO 16

In the manufacturing apparatus of the above specifications, the heating zone B is divided to make the above Division 1 or 8. (Refer to FIG. 1 or FIG. 18.) Using this manufacturing apparatus, the raw materials B and the raw materials C are heated and molded to make the above cone cups 8a and waffle cones 8b, respectively, and to evaluate a rate of sparking, moldability of the raw materials 14 and properties of the molded articles. The results are shown in Table 6.

TABLE 6

| | Examples | | | |
|---|---|---|---|---|
| | Example | Example | Example | Example |
| | 13 | 14 | 15 | 16 |
| Division of | Division 1 | Division 1 | Division 8 | Division 8 |
| heating | | | | |
| zone | | | | |
| Raw | Raw | Raw | Raw | Raw |
| Materials | Materials B | Materials C | Materials B | Materials C |
| Molded | Cone cup | Waffle | Cone cup | Waffle |
| articles | | cone | | cone |
| Rate of | X | Δ | Δ | ◯ |
| sparking | | | | |
| Moldability | Δ | Δ | ◯ | ◯ |
| of raw | | | | |
| materials | | | | |
| Properties | Δ | Δ | ◯ | ◯ |
| of molded | | | | |
| articles | | | | |

As clarified from the results in Table 6, it is possible to effectively prevent localization of high frequency and to reduce a rate of sparking, by providing the high-frequency application suspension zone d in the heating and molding process depending on the kinds of raw materials 14 and molded articles. In addition, by moderately heating the raw materials 14 through external heating in the high-frequency application suspension zone d, it is possible to mature (cure) the raw materials 14 (raw materials B or C), which can improve the moldability of the raw materials and properties of the finished articles.

Especially, if a curved area corresponding to the R-area is set up as the high-frequency application zone d, it is possible not only to attain excellent molded articles, but also to reduce a rate of sparking and simplify the structure of the apparatus whether the high-frequency heating part or the gas heating section 9 is provided or not.

### EXAMPLE 17

In the manufacturing apparatus of the above specifications, the heating zone B is divided to make the above Division 7 (refer to FIG. 17). In addition, external heating in the gas heating section 9 is adjusted so that the temperature of the metal molds may be 120° C. Using this manufacturing apparatus, the raw materials A are heated and molded to make the above cone cups 8a and to evaluate the moldability of the raw materials 14, structure of the molded articles, emergent effects from additives and baked condition. The results are shown in Table 7.

### EXAMPLES 18 AND 19 AND COMPARATIVE EXAMPLE 3

The raw materials A are heated and molded to make the cone cups 8a as the example 17, except that external heating in the gas heating section 9 is adjusted so that the temperature of the metal molds may be 160° C., 200° C., or 240° C. The moldability of the raw materials 14, structure of the molded articles, emergent effects from additives and baked condition are evaluated. The results are shown in Table 7.

TABLE 7

| | | Examples and Comparative examples | | | |
|---|---|---|---|---|---|
| | | | | | Comparative |
| | | Example 17 | Example 18 | Example 19 | example 3 |
| Division of heating zone | | Division 7 | Division 7 | Division 7 | Division 7 |
| Raw Materials | | Raw | Raw | Raw | Raw |
| | | Materials A | Materials A | Materials A | Materials A |
| Molded articles | | Cone cup | Cone cup | Cone cup | Cone cup |
| Temperature of metal molds | | 120° C. | 160° C. | 200° C. | 240° C. |
| Moldability of raw materials | | Δ | ⊚ | ⊚ | X |
| Structure | Inner | Very dense | Dense | Slightly | — |
| | structure | | | coarse | |
| | Outer | Thin | Slightly thin | Thick | — |
| | structure | | | | |
| Emergent | Colorings | ⊚ | ◯ | Δ | — |
| effects from | Flavorings | Δ | ◯ | ⊚ | — |
| additives | | | | | |
| Baked | Color | ⊚ | ◯ | Δ | — |
| condition | Roast smell | Δ | ◯ | ⊚ | — |

As clarified from the results in Table 7, from a viewpoint of moldability, if the temperature of the metal molds is 120° C. or 240° C., external heating is not preferable or appropriate. If the temperature of the metal molds is 160° C. or 200° C., external heating is appropriate.

More specifically, since the temperature of the metal molds is 120° C. in the example 17, the ratio of external heating to high-frequency heating is too low. Accordingly, the raw materials A are not fully stabilized in the stabilizing zone and high-frequency application suspension zone d with fair but slightly poorer moldability. On one hand, in the comparative example 3, since the-temperature of the metal molds is 240° C., the ratio of external heating is too high. Therefore, the molded articles get too scorched to be molded and to be evaluated for various properties given by external heating.

On the other hand, in the examples 18 and 19, external heating and high-frequency heating are well balanced since the temperature of the metal molds is appropriate. Therefore, it is possible to fully stabilize the raw materials A in the stabilizing zone and the high-frequency application suspension zone d and to attain very excellent moldability.

Also, as clarified from the results in Table 7, from a viewpoint of various properties given by external heating, it is possible to change a structure, emergent effects from additives, and baked condition of the molded articles accordingly, by changing a ratio of external heating to high-frequency heating accordingly as the examples 17 to 19. It is thus possible to optionally change properties of the molded articles by changing a condition of external heating depending on a usage of the molded articles.

### EXAMPLES 20 AND 21

In the manufacturing apparatus of the above specifications, the heating zone B is divided to make the above Division 4 or 9 (refer to FIG. 14 or FIG. 26). Using this manufacturing apparatus, the raw materials E are heated and molded to make the cone cups 8a and to evaluate a rate of sparking, moldability of the raw materials 14 and properties of the molded articles. The results are shown in Table 8.

TABLE 8

| Examples | Example 20 | Example 21 |
|---|---|---|
| Division of heating | Division 4 | Division 9 |
| zone | | |
| Raw materials | Raw Materials E | Raw Materials E |
| Molded articles | Cone cup | Cone cup |
| Rate of sparking | ◯ | ⊚ |
| Moldability of raw | Δ | ⊚ |
| materials | | |
| Properties of | Δ | ⊚ |
| molded articles | | |

### EXAMPLES 22 AND 23

In the manufacturing apparatus of the above specifications, the heating zone B is divided to make the above Division 4 or 10 (refer to FIG. 14 or FIG. 27). Using this manufacturing apparatus, the above raw materials F are heated and molded to make the cone cups 8a and to evaluate a rate of sparking only. The results are shown in Table 9.

TABLE 9

| Examples | Example 22 | Example 23 |
|---|---|---|
| Division of heating | Division 4 | Division 10 |
| zone | | |
| Raw materials | Raw Materials F | Raw Materials F |
| Molded articles | Cone cup | Cone cup |
| Rate of sparking | Δ | ⊚ |

As clarified from the results in Table 8 and Table 9, it is possible to perform more proper heating for the raw materials 14 and to improve quality of the molded articles, if the external single heating zone is provided at an initial stage or at a last stage of heating and molding, depending on the kinds of raw materials 14 and molded articles. Also, it is possible to reduce a rate of sparking, thereby further improving productivity of the molded articles.

### EXAMPLES 24 TO 26

In the manufacturing apparatus of the above specifications, the heating zone B is divided to make the above Division 4, 11 or 12 (refer to FIG. 14, FIGS. 29(a) and (b), or FIGS. 30(a) and (b)). Using this manufacturing apparatus, the raw materials E are heated and molded to make the cone cups 8a and to evaluate a rate of sparking, moldability of the raw materials 14 and properties of the molded articles. The results are shown in Table 10.

TABLE 10

| Examples | Example 24 | Example 25 | Example 26 |
|---|---|---|---|
| Division of | Division 4 | Division 11 | Division 12 |
| heating zone | | | |
| Raw materials | Raw | Raw | Raw |
| | Materials E | Materials E | Materials E |
| Molded articles | Cone cup | Cone cup | Cone cup |
| Rate of sparking | ◯ | ⊚ | ⊚ |
| Moldability of | Δ | ⊚ | ⊚ |
| raw materials | | | |
| Properties of | Δ | ⊚ | ⊚ |
| molded articles | | | |

As clarified from Table 10, it is possible to perform proper heating for the raw materials 14 and to improve quality of the molded articles by changing a shape of the rail-shaped power feeding section 3 where the plate-type power receiving sections 4 are inserted and gradually increasing a power feeding level.

### EXAMPLES 27 TO 29

In the manufacturing apparatus of the above specifications, the heating zone B is divided to make the above Division 4, 13 or 14. (Refer to FIG. 14, FIGS. 32(a) and (b) or FIGS. 33(a) and (b).) Using this manufacturing apparatus, the raw materials F are heated and molded to make the cone cups 8a and to evaluate a rate of sparking only. The results are shown in Table 11.

TABLE 11

| Examples | Example 24 | Example 25 | Example 26 |
|---|---|---|---|
| Division of | Division 4 | Division 13 | Division 14 |
| heating zone | | | |
| Raw materials | Raw | Raw | Raw |
| | Materials F | Materials F | Materials F |
| Molded articles | Cone cup | Cone cup | Cone cup |
| Rate of sparking | Δ | ⊚ | ⊚ |

As clarified from the results in Table 11, it is possible to perform more proper heating for the raw materials 14 and to improve quality of the molded articles by changing a shape of the rail-shaped power feeding section 3 where the plate-type power receiving sections 4 are inserted and gradually increasing a power feeding level in the sub-zone corresponding to a last heating stage. This can prevent overheating at a last heating stage and can further reduce a rate of sparking, thereby still more improving productivity of the molded articles.

As mentioned above, in the method for manufacturing heated and molded articles in accordance with the present invention, wherein raw materials are fed into electrically conductive molds which are continuously transferred along a moving passage and high-frequency alternating current is continuously applied to the moving molds with no contact from a heating area provided along the moving passage in order to mold the raw materials through dielectric heating, the heating area is divided into sub-areas, each of which has power source means and power feeding means.

In the above method, when high-frequency alternating current (high frequency) is continuously applied to the continuously moving molds with no contact, the heating area wherein high frequency is applied, is divided into sub-areas, each of which has the power source means and the power feeding means, thereby restraining or preventing concentration of high-frequency energy in the heating area. In result, it is possible to effectively prevent overheating or dielectric breakdown, and to produce the heated and molded articles very efficiently and steadily.

In the above method for manufacturing heated and molded articles in accordance with the present invention, the high-frequency alternating current is applied to the molds in the sub-areas by the rail-shaped power feeding means continuously disposed along the moving passage, and the molds have the power-receiving means to receive the high-frequency alternating current from the rail-shaped power feeding means with no contact.

In the above method, the rail-shaped power feeding means is provided in the heating area and the power receiving means is provided in correspondence with the power feeding means. After the molds enter into the heating area by the moving means, the molds equipped with the power receiving means are transferred along the rail-shaped power feeding means with movement of the moving means. Accordingly, it is possible to continue a heating and drying process smoothly and steadily until the molds pass through the heating area, that is, until the power receiving means takes off the power feeding means.

In the above method for manufacturing heated and molded articles in accordance with the present invention, with the power receiving means shaped like a plate, the rail-shaped power feeding means has a surface opposite to the power receiving means, and high-frequency alternating current is applied with no contact by placing the plate-type power receiving means opposite to the surface.

In the above method, the power receiving means moves along the rail-shaped power feeding means with the surface of the power feeding means opposite to the plate-type power receiving means with no contact, forming a condenser by the power receiving means, the surface opposite thereto, and a space in between. In result, it is possible to supply power to continuously moving molds with no contact and to continue a heating and drying process smoothly and steadily.

In the above method for manufacturing heated and molded articles in accordance with the present invention, the rail-shaped power feeding means or power receiving means is constructed so that the opposite area may be varied along the moving passage of the molds to change a level of high-frequency alternating current applied to the molds through the power receiving means.

In the above method, it is possible to adjust a level of heating the molds by changing a power feeding level. In result, it is possible to prevent a scorch on molded articles or a spark by restraining overheating, and to improve moldability of the molded articles and attain desirable properties of the finished articles. Especially, by performing step-by-step heating at an initial stage or a last stage of heating and molding, it is possible to properly heat and mold the raw materials.

In the above method for manufacturing heated and molded articles in accordance with the present invention, the rail-shaped power feeding means is constructed so that an area of the opposite surface is changed along the moving passage.

In the above method, by changing an area of the opposite surface equipped with the power feeding means with the movement of the molds, the opposite area between the surface and the power receiving means changes. Accordingly, a capacity of a condenser formed between the power receiving means, the surface opposite thereto and a space in between changes. In result, it is possible to change heating applied to the heated and molded articles by changing a power feeding level, thereby improving moldability of the heated and molded articles and attaining desirable properties of the finished products.

In the above method for manufacturing heated and molded articles in accordance with the present invention, the rail-shaped power feeding means is constructed so that the opposite distance is changed along the moving passage of the molds to change a level of high-frequency alternating current applied to the molds through the power receiving means.

Also in the above method, it is possible to adjust a heating level applied to the molds by changing a power feeding level. In result, it is possible to prevent a scorch on molded articles and a spark by restraining overheating, and to improve moldability of the molded articles and attain desirable properties of the finished articles. Especially, since step-by-step heating can be performed at an initial heating stage or a last heating stage, it is possible to properly heat and mold the raw materials.

In the above method for manufacturing heated and molded articles in accordance with the present invention, a length of the sub-area is determined so that a rate of variation for the continuously moving molds to be heated in the entire sub-area may be less than 0.5.

In the above method, it is possible to reduce a variation in the number of molds to be dielectrically heated by high-frequency alternating current in one of the sub-areas, so that matching of high frequency can be stabilized and a variation in anodic amperage can be lessened. In result, it is possible not only to improve energy efficiency but also to prevent a spark.

In the above method for manufacturing heated and molded articles in accordance with the present invention, in case that the sub-area corresponds to an area at an initial stage or a last stage of heating the raw materials, a length of the sub-area is determined so that a rate of variation of the continuously moving molds may be less than 0.1.

In the above method, especially, it is possible to decrease a variation in the number of molds to be dielectrically heated at an initial stage or a last stage of heating and molding when matching of high frequency is likely to be unsteady. Therefore, it is possible to further stabilize matching of high frequency, and in result, it is possible to further improve energy efficiency or to steadily prevent generation of a spark.

In the above method for manufacturing heated and molded articles in accordance with the present invention, the mold consists of a plurality of mold halves, which can be divided into the feeder electrode block where power is supplied from the power feeding section, and the grounding electrode block grounded to the earth. These blocks are insulated from each other.

In the above method, the mold consists of a combination of the feeder electrode and the grounding electrode insulated from each other. It is thus possible to dielectrically heat the raw materials by applying high frequency from the feeder electrode, with the raw materials placed between the feeder electrode and the grounding electrode. In addition, the mold consists of a plurality of mold halves and can be always divided into the feeder electrode block and the grounding electrode block. Accordingly, by applying high frequency to the raw materials as the objects to be heated, it is possible to steadily perform dielectric heating on the raw materials.

In the above method for manufacturing heated and molded articles in accordance with the present invention, the mold is a united mold uniting a plurality of molds.

In the above method, since many molds are integrated into the united mold, it is possible to move many molds to the heating area once. In result, it is possible to improve production efficiency of molded articles.

In the above method for manufacturing heated and molded articles in accordance with the present invention, both dielectric heating by applying high-frequency alternating current and external heating by the external heating means are used in part of the heating area.

In the above method, since both dielectric heating and external heating are used in part of the heating area, rapid heating deriving from dielectric heating and moderate heating through thermal conduction deriving from the external heating are simultaneously performed on the raw materials. In result, it is possible to more steadily and fully heat the raw materials. Especially, in case that the present invention is used for baking the baked and molded confectioneries mentioned below, it is preferable to use both dielectric heating and external heating which can give a proper baked color and a roast smell to the baked and molded confectioneries.

In the above method for manufacturing heated and molded articles in accordance with the present invention, the heating area includes the high-frequency application suspension zone where no high-frequency alternating current is applied.

In the above method, since the heating area includes the high-frequency application suspension zone, it is not necessary to provide the power feeding means and other means to apply high frequency in the high-frequency application suspension zone. It is thus possible to design a heating equipment that does not apply high frequency to the part where high-frequency alternating current is likely to be localized, thereby restraining or preventing concentration of high-frequency energy still more steadily. Also, it is possible to further simplify a structure of the heating equipment by setting up the high-frequency application suspension zone at a part where it is relatively difficult to dispose the power feeding means and other means.

Moreover, in case that both dielectric heating and external heating are used, moderate heating through external heating is only performed in the high-frequency application suspension zone. Therefore, it is possible to improve moldability and attain desirable properties of the finished articles by setting up the high-frequency application suspension zone depending on properties of the raw materials.

Also, by setting up the high-frequency application suspension zone at a part where an electrical property of the raw materials changes most significantly, it is possible to prevent concentration of high-frequency energy. In addition, it is possible to perform moderate heating through external heating only at the part before the sub-area applying the largest output of high frequency in the heating area, thereby properly heating- and molding the raw materials.

In the above method for manufacturing heated and molded articles in accordance with the present invention, the high-frequency application suspension zone included in the heating area is provided in an area corresponding to either an initial stage or a last stage of heating the raw materials.

In the above method, since the high-frequency application suspension zone is provided at either an initial stage or a last stage of heating and molding, it is possible to perform proper heating for the raw materials. In result, it is possible to improve quality of the heated and molded articles attained and to improve productivity.

In the above method for manufacturing heated and molded articles in accordance with the present invention, conditions of high-frequency alternating current applied to the molds in the heating area is differently specified by the sub-area.

In the above method, since high frequency is applied at a different condition by the sub-area, it is possible to perform heating at a different condition. Accordingly, it is possible not only to make a condition to restrain or prevent concentration of high-frequency energy for the entire heating area, but also to heat the molds at a better condition, thereby more properly heating and molding the raw materials.

In the above method for manufacturing heated and molded articles in accordance with the present invention, the condition for applying high-frequency alternating current includes at least one of the conditions; an output of high-frequency alternating current in the entire sub-area; an output of high-frequency alternating current applied to each of the molds; and a length of the sub-area.

In the above method, if at least one of the above conditions is differently specified by the sub-area, it is possible to change a heating condition by the sub-area. In result, it is possible not only to restrain or prevent concentration of high-frequency energy but also to more properly heat and mold the raw materials.

In the above method for manufacturing heated and molded articles in accordance with the present invention, the condition for applying high-frequency alternating current is specified depending on a property of the raw materials that changes by applying high-frequency alternating current.

In the above method, it is possible to apply high-frequency alternating current at a different condition by the sub-area depending on a property of the raw materials or the molded articles attained by heating. Therefore, it is possible not only to restrain or prevent concentration of high-frequency energy but also to add a heat capacity to the raw materials more properly, thereby heating and molding the raw materials still more properly.

In the above method for manufacturing heated and molded articles in accordance with the present invention, the raw materials include at least starch and water, and a starchy and watery mixture having fluidity or plasticity is used. Also, baked and molded articles are manufactured as heated and molded articles.

In the above method, when the above watery mixture containing starch and water is heated and molded to make baked and molded articles, the method for manufacturing heated and molded articles in accordance with the present invention is used, which can makes high quality baked and molded articles with higher production efficiency.

In the above method for manufacturing heated and molded articles in accordance with the present invention, flour is used as starch in the starchy and watery mixture, and the baked and molded articles are molded and baked confectioneries mainly containing flour.

In the above method, when the starchy and watery mixture using flour as starch is baked and molded to make edible containers or molded and baked confectioneries such as cookies and biscuits, the method for manufacturing heated and molded articles in accordance with the present invention is used. Thus, it is possible to make high quality molded and baked confectioneries with higher production efficiency.

In the above method for manufacturing heated and molded articles in accordance with the present invention, the conveyer rotatably stretched by the supporting axes is used as the above moving means.

In the above method, since the molds can be efficiently transferred to the heating area, it is possible to improve production efficiency of molded articles. Also, since the molds can be continuously and rotatably transferred as an endless track, it is possible to reduce an installation space of the manufacturing equipment.

### EMBODIMENT 7

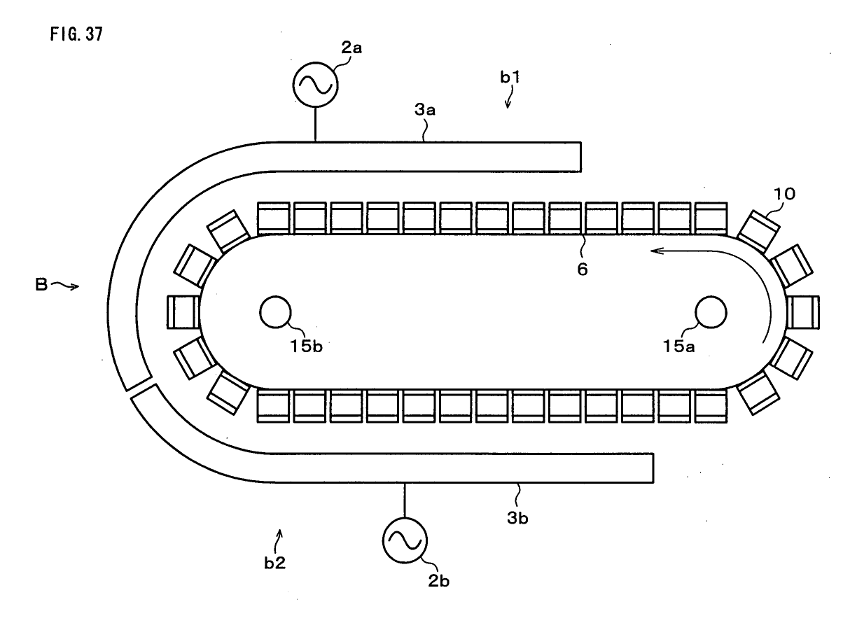

Still another embodiment of the present invention is described below referring to FIG. 37 to FIG. 40. The present invention is not limited to this embodiment. For convenience of explanation, the same numbers are shown for the members having the same function as the members used in the above embodiments 1 to 6 with the explanation left out.

In the above embodiments 1 to 6, a starchy and watery mixture is used as an object to be heated, and metal molds (united metal molds) are used as heating units. Of course, the present invention is not limited to those above.

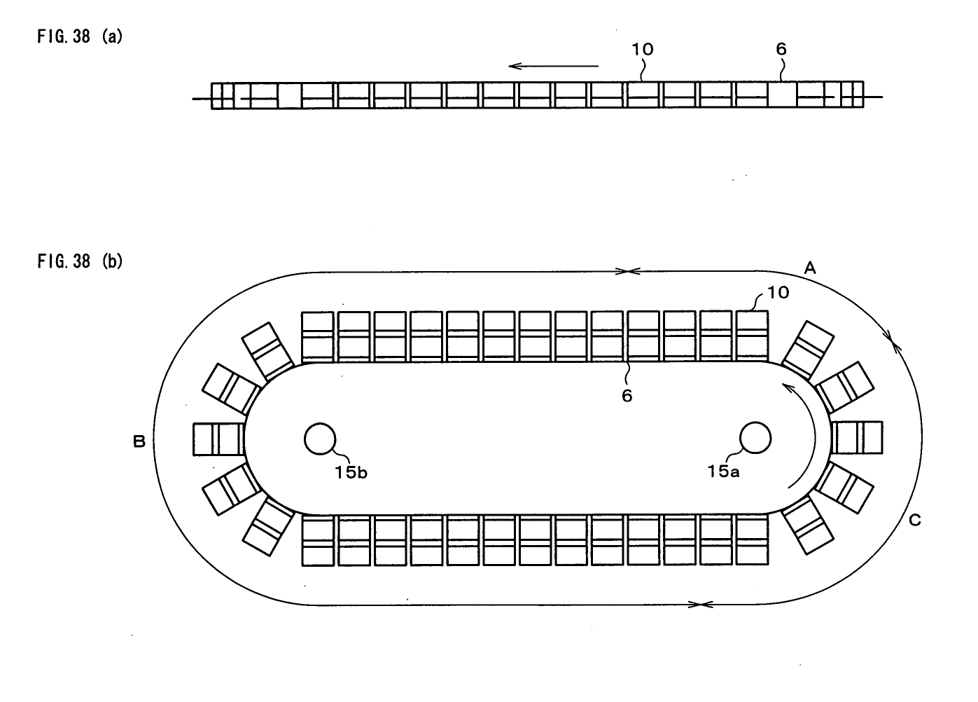

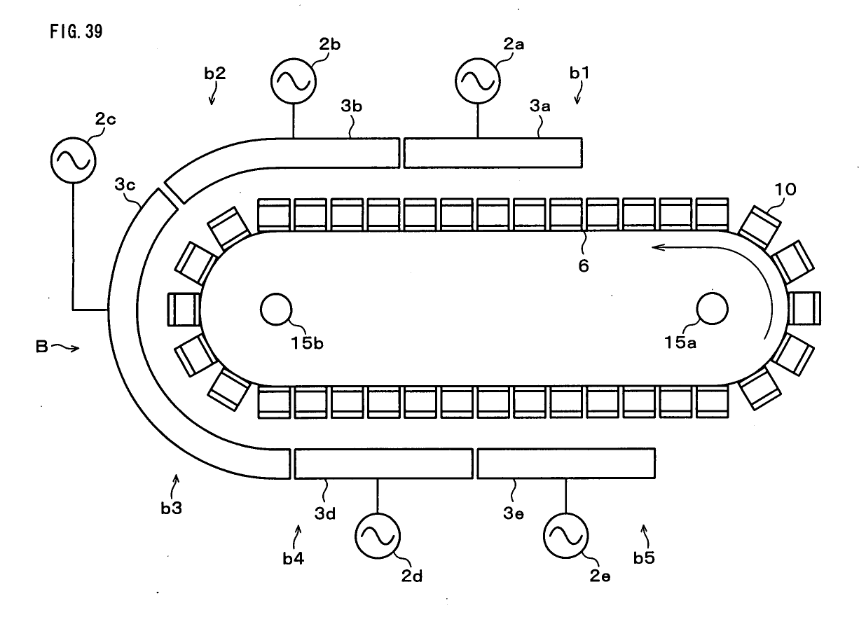

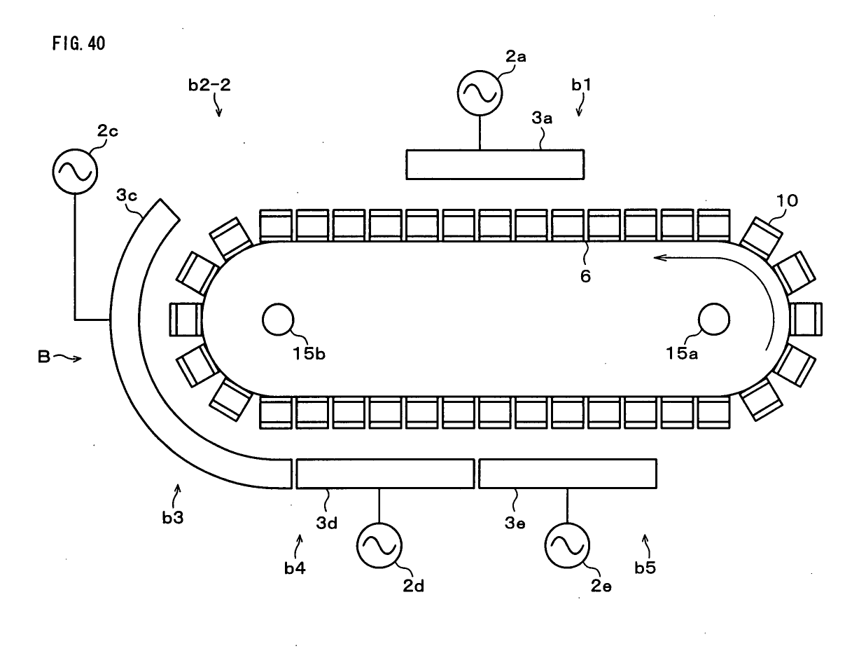

Namely, as shown in FIG. 37 or 38, instead of the united metal molds 5, the other type of heating units 10 may be used for the other purposes than for heating and molding baked and molded articles, in the examples shown in FIG. 1, FIG. 8 and FIG. 9 of the embodiment 1. Similarly, as shown in FIG. 39 and FIG. 40, the other type of heating units 10 may be used for the other purposes than for heating and molding baked articles, in the examples shown in FIG. 14 and FIG. 15 of the embodiment 2, and also in the examples shown in FIG. 17 of the embodiment 3. Of course, this is the same also for other examples in the embodiments 1 to 3 and in the embodiments 4 to 6.

For example, as described in the above embodiment 1, there are various usages including cooking, heat sterilization, defrosting, heat maturation and cure, drying, heat bonding and heat pressing, melting and bonding, and heat pressing and molding. The heating units 10 in the figure are schematically shown in correspondence with FIG. 2. It goes without saying that the shape or structure is determined based on the objects to be heated and it is not particular limited.

As mentioned above, in the continuous high-frequency heating apparatus in accordance with the present invention, having heating units wherein an object to be heated is placed between a pair of electrodes, moving means which continuously transfers the heating units along a moving passage, and power feeding means provided along the moving passage, and dielectrically heating the object to be heated by continuously applying high-frequency alternating current to the moving heating units from the power feeding means, the power feeding means are included, each of which has power source means, and a heating area is constituted by continuously disposing the power feeding means.

In the above structure, when high-frequency alternating current (high frequency) is continuously applied to the continuously moving heating units, the heating area where the high frequency is applied, is divided into sub-areas, each of which has the power source means and the power feeding means, thereby restraining or preventing concentration of high-frequency energy in the heating area. In result, it is possible to prevent overheating or dielectric breakdown effectively and to perform very high quality heat treatment.

In addition to the above structure, the continuous high-frequency heating apparatus in accordance with the present invention is constructed so that the above power feeding means apply high-frequency alternating current to the heating units with no contact.

In the above structure, since high frequency is applied with no contact, it is not necessary to directly contact on the electrodes between the heating units and the power feeding means forming the heating section. It is thus possible to prevent generation of a spark at the power feeding and receiving section in the heating area. In the present invention, the power supply with no contact means that the power feeding means and the electrodes do not contact directly, as mentioned below.

In addition to the above structure, the continuous high-frequency heating apparatus in accordance with the present invention is constructed so that the above power feeding means has a rail shape continuously disposed along the heating area in the moving passage and also the heating units have the power receiving section receiving alternating current with no contact from the rail-shaped power feeding means.

In the above structure, since the rail-shaped power feeding means is provided in the heating area and the power receiving means is provided in correspondence with the rail-shaped power feeding means, after the heating units enter into the heating area by the moving means, the heating units equipped with the power receiving means are transferred along the rail-shaped power feeding means with the movement of the moving means. Therefore, it is possible to continue a heating and drying process smoothly and steadily until the heating units pass through the heating area, that is, the power receiving means takes off the power feeding means.

In addition to the above structure, the continuous high-frequency heating apparatus in accordance with the present invention, is constructed so that the above power receiving section is formed like a plate, the rail-shaped power feeding means has a surface opposite to the power receiving means, and high-frequency alternating current is applied with no contact by placing the plate-type power receiving means opposite to the above surface.

In the above structure, with the surface on the power feeding means opposite to the plate-type power receiving means with no contact, the power receiving means moves along the rail-shaped power feeding means, forming a condenser by the power receiving means, the surface opposite thereto, and a space in between. In result, it is possible to supply power with no contact to the continuously moving heating units and to continue a heating and drying process smoothly and steadily.

In addition to the above structure, the continuous high-frequency heating apparatus in accordance with the present invention is constructed so that the rail-shaped power feeding means or power receiving means change the opposite area along the moving passage to change a level of high-frequency alternating current applied to the heating units through the power receiving means.

In the above structure, it is possible to adjust a level of heating the heating units by changing a power feeding level. In result, it is possible to prevent a scorch on the heating units and a spark by restraining overheating, and to improve quality of the objects to be heated and attain desirable properties of the finished articles. Especially, since step-by-step heating can be performed at an initial heating stage or a last heating stage, more proper heating is possible.

In addition to the above structure, in the continuous high-frequency heating apparatus in accordance with the present invention, the rail-shaped power feeding means is so constructed as to change an area of the opposite surface along the moving passage.

In the above structure, since the area of the opposite surface on the power feeding means is changed with the movement of the heating units, the opposite area between the above surface and the power receiving means changes. Then, a capacity of a condenser formed by the power receiving means, the surface opposite thereto, and a space in between changes. In result, it is possible to change a heating level by changing a power feeding level and to improve quality of objects to be heated and attain desirable properties of finished articles.

Further to the above structure, in the continuous high-frequency heating apparatus in accordance with the present invention, the rail-shaped power feeding means is constructed so that the opposite distance is changed along the moving passage of the heating units to change a level of the high-frequency alternating current applied to the heating units through the power receiving means.

Also in the above structure, it is possible to adjust a level of heating the heating units by changing a power feeding level. In result, it is possible to prevent a scorch on the heating units and a spark by restraining overheating, and to improve quality of objects to be heated and attain desirable properties of finished articles. Especially, since it is possible to perform step-by-step heating at an initial heating stage or a last heating stage, more proper heating can be performed.

Further to the above structure, in the continuous high-frequency heating apparatus in accordance with the present invention, a length of one of the power feeding means is determined so that a rate of variation of the continuously moving heating units to be heated by the entire power feeding means may be less than 0.5.

In the above structure, it is possible to reduce a variation in the number of heating units to be dielectrically heated with one of the power feeding sections by applying high-frequency alternating current. It is thus possible to stabilize matching of high frequency and to lessen an increase or a decrease in anodic amperage. In result, it is possible not only to improve energy efficiency but also to prevent generation of a spark.

Further to the above structure, in the continuous high-frequency heating apparatus in accordance with the present invention, when the power feeding means is provided in an area corresponding to either an initial heating stage or a last heating stage in the heating area, a length of the power feeding means is determined so that a rate of variation in the continuously moving heating units is less than 0.1.

In the above structure, it is possible to reduce a variation in the number of heating units to be dielectrically heated also at an initial stage or a last stage of heating and molding when matching of high frequency is likely to be unsteady for some objects to be heated. In result, it is possible to further improve energy efficiency and prevent generation of a spark more steadily.

Further to the above structure, in the continuous high-frequency heating apparatus in accordance with the present invention, a pair of electrodes equipped with the power receiving means, consist of a feeder electrode fed from the power feeding means and a grounding electrode grounded to the earth. The feeder electrode and the grounding electrode are insulated from each other.

In the above structure, a pair of electrodes constituting the heating unit consists of the feeder electrode and the grounding electrode insulated from each other. It is thus possible to dielectrically heat objects to be heated by applying high frequency from the feeder electrode with the objects placed between the feeder electrode and the grounding electrode.

Further to the above structure, in the continuous high-frequency heating apparatus in accordance with the present invention, the heating area includes the high-frequency application suspension zone where no high-frequency alternating current is applied.

In the above structure, the high-frequency application suspension zone is included in the heating area, where the power feeding means or other means to apply high frequency are not necessary. Therefore, it is possible to design a heating equipment that does not apply high frequency to the area where high-frequency alternating current is likely to be localized, thereby more steadily restraining or preventing concentration of high-frequency energy. Also, it is possible to simplify a structure of a heating apparatus by providing the high-frequency application suspension zone in an area where it is relatively difficult to dispose the power feeding means.

Further to the above structure, in the continuous high-frequency heating apparatus in accordance with the present invention, the high-frequency application suspension zone included in the heating area is provided in an area corresponding to either an initial heating stage or a last heating stage in the heating area.

In the above structure, since the high-frequency application suspension zone is provided at either an initial heating stage or a last heating stage, it is possible to perform proper heating depending on objects to be heated, thereby improving quality of the objects and productivity of heat treatment.

Further to the -above structure, in the continuous high-frequency heating apparatus in accordance with the present invention, a conveyer rotatably stretched with a plurality of axes is used.

In the above structure, it is possible to improve production efficiency of molded articles since the molds can be efficiently transferred to the heating area. Also, due to a continuous and rotative movement of the molds as an endless track, it is possible to reduce an installation space of the heating apparatus.

### EMBODIMENT 8

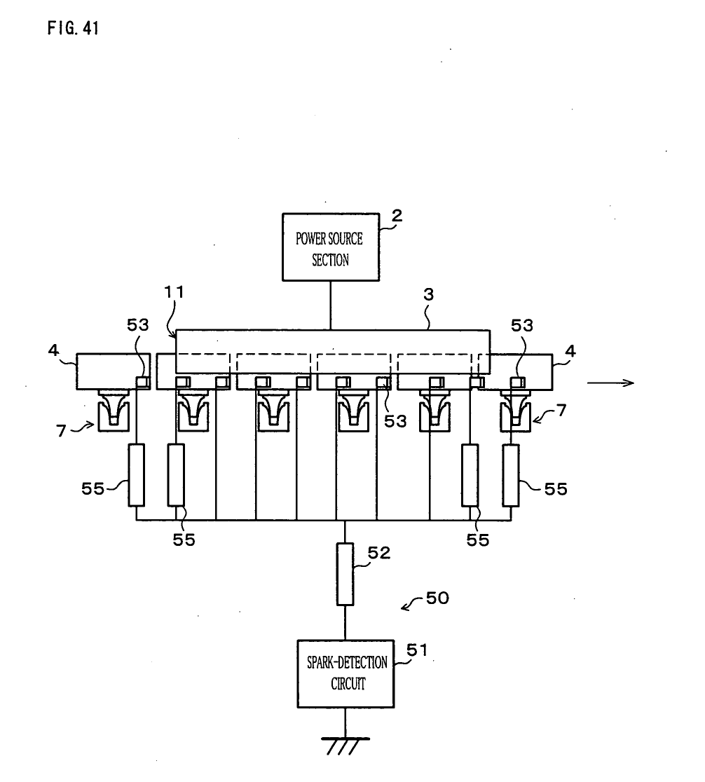

Still another embodiment of the present invention is described below referring to FIG. 41 to FIG. 46 and FIG. 55 and FIG. 56. The present invention is not limited to this embodiment. For convenience of explanation, the same numbers are shown for the members having the same function as the members used in the above embodiments 1 to 7 with the explanation left out.

In the embodiments 1 to 7, the continuous high-frequency heating apparatus that continuously heats objects to be heated, as well as the method for manufacturing heated and molded articles using the above apparatus, are explained. In this embodiment, the continuous high-frequency heating apparatus and method in accordance with the present invention is explained, wherein, in the same structure as that of the above-mentioned embodiments, by providing a spark-detecting circuit to confirm that a spark is not generated between the electrodes wherein the objects to be heated are placed, high-frequency filters are individually provided in part of the circuit where there may be a potential difference between the adjacent objects, in order to prevent an arc.

The usage of the present invention is described in the above embodiment 1, so the details are left out here. In the following description including this embodiment, the continuous high-frequency heating apparatus and method is referred to as the heating apparatus and the heating method, respectively.

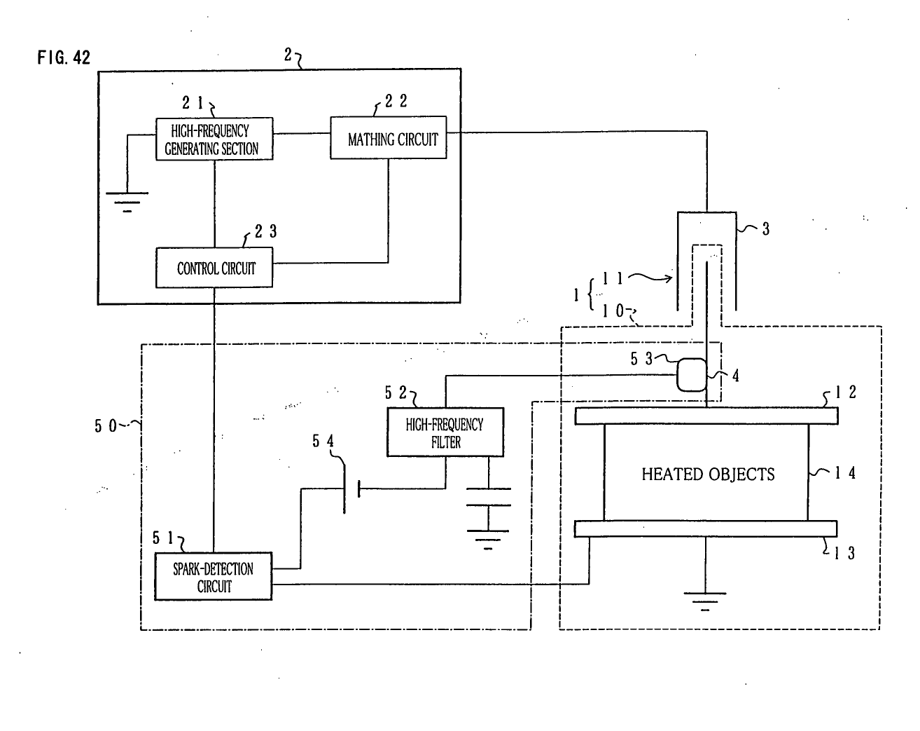

As shown in FIG. 42, the heating apparatus in accordance with the present invention, more specifically, as explained in the above embodiment 1 and shown in an outlined circuit diagram of FIG. 42, is equipped with the heating section 1, the power source section (power source means) 2, and spark-detecting part (spark-detecting means) 50. The heating section 1 includes the power feeding section 3 and a plurality of heating units 10 in correspondence therewith. These heating units 10 correspond to the metal molds 7 (or the united metal molds 5) in the above embodiments 1 to 6. For convenience of explanation, one of the heating units 10 is shown in FIG. 42. The above power source section 2 includes the high-frequency generating part 21, the matching circuit 22, and the control circuit 23.

The heating unit 10 is equipped with a pair of electrodes 12 and 13 as well as the power receiving section 4 provided in the electrode 12. The objects 14 to be heated are placed between the electrodes 12 and 13. The power receiving section 4 and the power feeding section 3 constitute the power feeding and receiving section 11. The electrodes 12 and 13 correspond to the electrode blocks 12 and 13, respectively, explained in the above embodiment 1. The electrode 12 is the feeder electrode connected to the power feeding and receiving section 11 and the electrode 13 is the grounding electrode grounded to the earth.

The electrodes 12 and 13 are insulated from each other with the objects 14 to be heated (raw materials) in between, and generate dielectric heating on the objects 14 by high frequency applied through the power feeding and receiving section 11. The structure of the electrodes 12 and 13 is not specifically limited. In this embodiment, as the embodiments 1 to 6, the electrodes 12 and 13 are the molds (metal molds 7), and the objects 14 to be heated are the raw materials for molding (referred to as the raw materials). Accordingly, the heating units 10 in this embodiment indicate the metal molds wherein the raw materials are fed.

The spark-detecting part 50 is connected between the control circuit 23 and the heating section 1 to anticipate a spark between the electrodes 12 and 13. More specifically, the spark-detecting part 50 includes the spark-detecting circuit 51, the high-frequency filter 52, the spark-sensing part 53 and the direct current power source section 54. The spark-detecting circuit 51 is connected to the electrode 12 at the side of the feeder electrode (described below) through the spark-sensing part 53 and the power receiving section 4. Also, the high-frequency filter 52 and the direct current power source section 54 are provided between the spark-sensing part 53 and the spark-detecting circuit 51. In addition, the spark-detecting circuit 51 is directly connected to the electrode 13 at the side of the grounding electrode (described below), not connected on a circuit.

The spark-detecting circuit 51 is not specifically limited as long as it can discover whether a spark is anticipated between the electrodes 12 and 13, and it can send out a control signal to instruct the control circuit 23 to suspend application of high frequency if a spark is anticipated. In general, the spark-detecting circuit is constructed so that it checks for electrification by measuring a resistance value from direct current applied between the electrodes 12 and 13 in order to anticipate a spark.

The spark-detecting circuit 51 of the above structure judges that there is no electrification if the resistance value measured is higher than a given value. If there is no electrification, a spark is not anticipated and the spark-detecting circuit 51 does not send out a control signal to the control circuit 23. On the other hand, the spark-detecting circuit 51 judges that there is electrification if the resistance value measured is lower than a given value. Since a spark is more likely to be generated due to electrification, the spark-detecting circuit 51 sends out a control signal to instruct the control circuit 23 to suspend application of high frequency.

The control circuit 23 cuts off high frequency supplied from the high-frequency generating part 21 based on the control signal to suspend application of high frequency. In result, it is possible to effectively prevent damages on the electrode 12 or a scorch on the objects 14 to be heated.

The high-frequency filter 52 is not particularly limited as long as it is an electric circuit that supplies direct current but does not supply high frequency. The high-frequency filter 52 is grounded to the earth through a condenser. The function of the high-frequency filter 52 is described below in detail.

The spark-sensing part 53 is not particularly limited as long as it can apply direct current to the electrodes 12 and 13 through the power receiving section in contact with an optional position corresponding to the feeder electrode (electrode 12) of the heating units 10. In this embodiment, as mentioned below, since the power receiving section 4 is shaped like a plate, for example, a plate-spring contact terminal is used.

The spark-sensing part 53 does not directly contact on the body of the heating units 10, but it contacts on an optional position in the feeder electrode (electrode 11) in the heating units 10, for example, the power receiving section 4. For convenience of explanation, the optional position of the feeder electrode in the heating units 10 with which the spark-sensing part 53 contacts, is referred to as a contact position of the spark-sensing part. Of course, this contact position of the spark-sensing part includes the power receiving section 4. As mentioned below, a spark is generated between the spark-sensing part 53 and the heating units 10 due to a potential difference. The part where a spark is actually generated is the above contact position of the spark-sensing part.

Also, as described below, the spark-sensing parts 53 are disposed at equal intervals in the heating area. This disposition is not particularly limited as long as the spark-sensing parts 53 are disposed at the intervals so that at least more than one of the spark-sensing parts 53 can contact on each of the heating units 10 in the heating area. Namely, when the heating units 10 are continuously transferred in the heating area, at least more than one of the spark-sensing parts 53 always contact on each of the heating units 10.

The direct current power source section 54 is not particularly limited as long as it can supply direct current at such a level that a resistance value between the electrodes 12 and 13 can be measured.

The spark-detecting part 50 is not limited to the above structure that a spark is anticipated by checking for electrification using a resistance value as a parameter, and it may have other various structures. However, it is more preferable that the above resistance value is used as a parameter.

More specifically, it is possible not only to detect a spark by checking for electrification between the electrodes 12 and 13 using a resistance value, but also to anticipate a spark by monitoring a change in the resistance value, in order to prevent a spark. Therefore, it is possible to more steadily anticipate and prevent generation of a spark with a simple structure not only by just checking for electrification, but also by using the resistance value as a parameter.

In this embodiment, the electrodes 12 and 13 are electrically conductive molds. In general, as mentioned above, metal molds consisting of various metals are preferably used. The structure of the metal mold is not particularly limited and depends on the shape of the molded articles. Also, the metal molds, regardless of the shape, can be divided into two blocks corresponding to the feeder electrode and the grounding electrode.

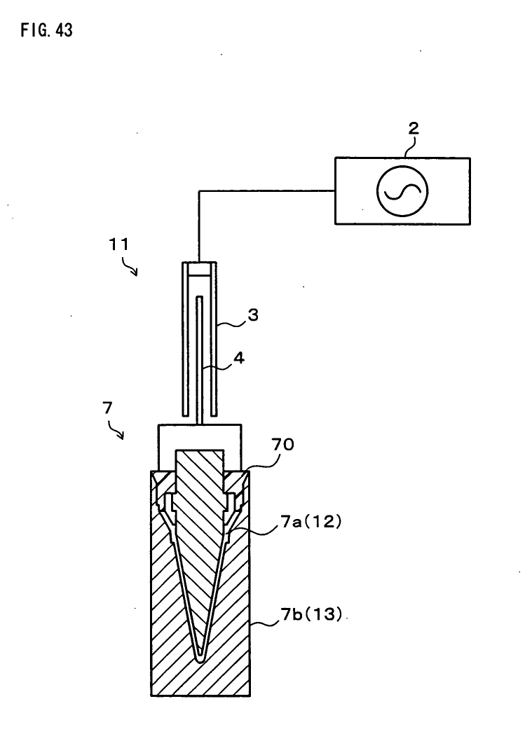

More specifically, for example, if molded articles are cone cups serving ice cream or soft ice cream, as shown in FIG. 43, the metal molds 7 can be divided into two mold halves; the inside metal mold half 7a for molding an inner surface of cone cups; and the outside metal mold half 7b for molding an outer surface of cone cups. (Refer to FIG. 3.)

The molds are not limited to the structure of the above metal molds 7. It may be consist of more than three metal mold halves depending on a shape of molded articles or a way to pick up molded articles after molding. Also in this case, the mold can be always divided into the feeder electrode block and the grounding electrode block, which can steadily apply high frequency to the raw materials as the objects 14 to be heated.

The metal molds 7 serve as the electrodes 12 and 13 in the heating units 10 to which high frequency is applied. The feeder electrode (the inside metal mold half 7a) as the electrode 12 and the grounding electrode (the outside metal mold half 7b) as the electrode 13 which constitute the metal mold 7, do not contact directly, more specifically, with an insulator 70 in between.

The insulator 70 is not particularly limited as long as it is intended to prevent the feeder electrode from contacting on the grounding electrode, and various kinds of insulator is generally used. Or, for some shapes of molded articles, a space may be formed instead of the insulator.

In this embodiment, the metal molds 7 may be equipped with a steam exhaust (not shown) to adjust an internal pressure. For baked and molded articles attained by heating and molding the starchy and watery mixture described below, since the mixture as the raw materials contains starch and moisture, steam should be exhausted out of the metal molds 7 with a heating process. However, for some shapes of the metal molds 7, steam may not be escaped. Then, by providing the steam exhaust on the metal molds 7, it is possible to properly adjust an internal pressure by escaping steam out of the metal molds 7. The structure of the steam exhauster is not particularly limited as long as it has such a shape, size, number and position that can uniformly and efficiently escape steam out of the metal molds 7.

Also, depending on properties of raw materials and molded articles, the entire heating section 1 including the metal molds 7 may form a chamber, and the internal pressure may be reduced by a vacuum pump.

In the present invention, the metal molds 7 can be continuously transferred by the moving means, and continuous heating is performed on the metal molds 7 in which the raw materials are portioned. The moving means is not particularly limited, but from a viewpoint of productivity of molded articles, a conveyer (conveyer means or transference means) represented by a belt conveyer is especially preferable.

The method for manufacturing molded articles wherein the present invention is applied, includes the following three processes; a raw material feeding process to feed the raw materials into the metal molds 7; a heating process to dielectrically heat the metal molds 7 wherein the raw materials are fed by applying high frequency for heating and molding; and a pickup process to pick up the molded articles from the metal molds 7 after heating and molding. Along the moving direction of the metal molds 7 by the conveyer, the raw material feeding zone, the heating zone, and the pick-up zone are provided.

In the heating zone, the power feeding section 3 (power feeding means) is provided, and in the metal molds 7, the power receiving section (power receiving means) in correspondence to the power feeding section 3 is provided. As shown in FIG. 42, the power feeding section 3 and the power receiving section 4 constitute the power feeding and receiving section 11.

The structure of the above power feeding section 3 is not particularly limited. For example, it consists of electrically conductive materials such as metals and has a rail shape with rough U-shaped section and the concave 31 in the center (refer to FIG. 10), as explained in the embodiment 1. Similarly, for example, the power receiving section 4 has a plate shape.

Molded articles attained in the present invention are not particularly limited. For example, in case of the metal molds 7 described above, the molded articles may be the conical cone cups 8a explained in the above embodiment 1. (Refer to FIG. 5.) Similarly, raw materials for the baked and molded articles are not particularly limited. The starchy and watery mixture in dough having plasticity or in slurry having fluidity explained in the embodiment 1 is preferably used.

In the heating apparatus in accordance with the present invention, as shown in FIG. 41, the metal molds 7 are continuously transferred by the conveyer in the direction of the arrow in the heating area with the rail-shaped power feeding section 3. The raw materials are portioned in the metal molds 7 which constitute the heating units 10 with the raw materials portioned. In the following explanation, the metal molds 7 are shown as the heating units 10 for convenience. High frequency is continuously applied to the metal molds 7 (heating units 10) to generate dielectric heating in the raw materials as the objects 14 to be heated for heating and molding.

In addition, in the neighborhood of the power feeding section 3 and also along the moving passage of the metal molds 7, the spark-sensing parts 53 are disposed at an equal interval as mentioned above. With the movement of the metal molds 7, the moving power receiving section 4 contacts on each of the spark-sensing parts 53 one after another. In other words, looking at one of the spark-sensing parts 53, since the metal molds 7 are transferred to the spark-sensing parts 53 one after another, the spark-sensing parts 53 and the metal molds 7 (the power receiving section 4) continuously repeat a contact condition and no contact condition.

By making the spark-detecting parts 50 of the above structure, it is possible to supply direct current from the spark-sensing parts 53 to the continuously moving metal molds 7, and to anticipate a spark by the spark-detecting circuit 51.

In the present invention, the high-frequency filters are individually provided for the spark-sensing parts 53 disposed in a position (position generating a potential difference) where a potential difference is generated between the adjacent metal molds 7 and 7, out of the spark-sensing parts 53 disposed along the moving passage. In FIG. 41, the high-frequency filters 55 for the spark-sensing parts (hereinafter referred to as the filter for the sensing part) are individually provided for the spark-sensing parts 53 disposed at both ends of the power feeding section 3, that is, at the positions corresponding to the neighborhood of the inlet and the outlet to the heating area.

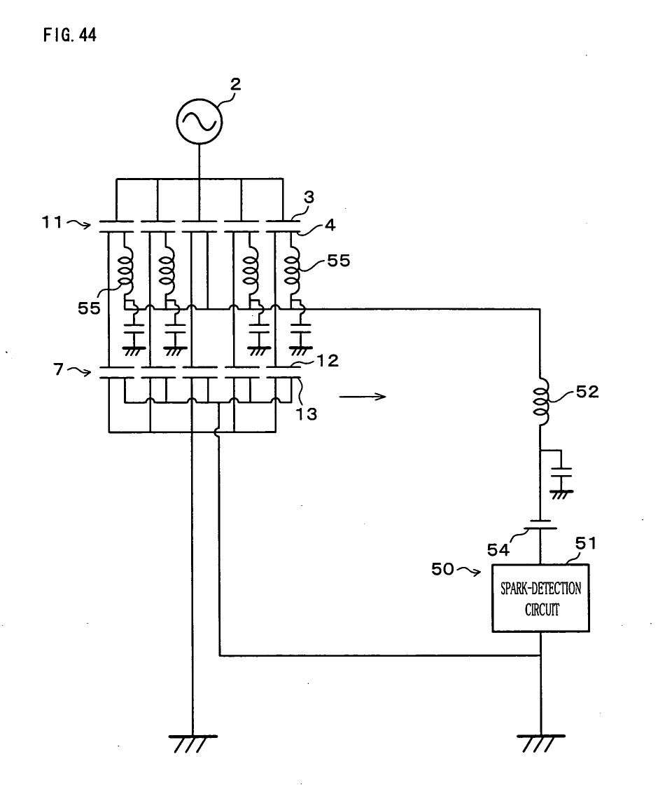

The circuit diagram showing the above heating condition is a parallel circuit of a condenser shown in FIG. 44. More specifically, the parts corresponding to the power feeding and receiving section 11 and the parts corresponding to each of the metal molds form a condenser in a parallel on the circuit. The condenser corresponding to each of the power feeding and receiving sections and the condenser corresponding to the metal molds 7 are connected in series, respectively. More specifically, the condenser corresponding to the power feeding and receiving section consists of the power feeding section 3 and the power receiving section 4. The condenser corresponding to the metal molds 7 consists of the electrode 12 (inside metal mold half 7a) and the electrode 13 (outside metal mold half 7b).

The spark-detecting circuit 51 is connected to the power receiving section 4, out of the condensers corresponding to the power feeding and receiving section 11 and also connected to the electrode 13 at the grounding electrode side out of the condensers corresponding to the metal molds 7, in order to apply direct current to the condenser corresponding to the metal molds 7. In addition, between the power receiving section 4 and the spark-detecting circuit 51, the filters 55 for spark-sensing parts are individually provided for all the condensers placed on both of the ends, out of the condensers corresponding to the power feeding and receiving sections 11 in parallel.

The above filters 55 for spark-sensing parts are different from the high-frequency filters 52 provided on the spark-detecting circuit 51. Therefore, as shown in FIG. 41 and FIG. 44, the high-frequency filters 52 are connected in series to all the spark-sensing parts 53 and the spark-detecting circuit 51 (and the direct current power source section 54). The filters 55 for spark-sensing parts are connected in series to each of the spark-sensing parts 53, the high-frequency filters 52 and the direct current power source section 54 and the spark-detecting circuit 51. Also, each of the filters 55 for the spark-sensing parts is connected in parallel.

In this structure, if a big potential difference is generated between the metal molds 7 and 7, it is possible to prevent high frequency from being applied between the adjacent spark-sensing parts 53 and 53 connected on the circuit. It is thus possible to prevent an arc at an area where and at a moment when the spark-sensing parts 53 contact on or leave the contact parts of the spark-sensing parts 53 on the metal molds 7.

In this embodiment, the positions where a potential difference is generated between the adjacent metal molds 7 and 7 include at least three positions mentioned below. In the description below, a previous position or a latter position looking from the moving direction of the metal molds 7 is just referred to as the previous position (side) or the latter position (side).

In other words, the positions where a bigger potential difference is generated between the adjacent metal molds 7 and 7 (position having a potential difference) include the following three positions; the most previous position in the heating zone, that is, the position before or after the metal molds 7 enter in the area equipped with the power feeding section 3 (hereinafter referred to as an inlet); the position located in the area just subsequent to the inlet and where a property of high frequency of the raw materials as the objects 14 to be heated changes rapidly (hereinafter referred to as an initial heating position); and the last position in the heating area, that is, the position where the metal molds 7 leave the area equipped with the power feeding section 3 (hereinafter referred to as an outlet).

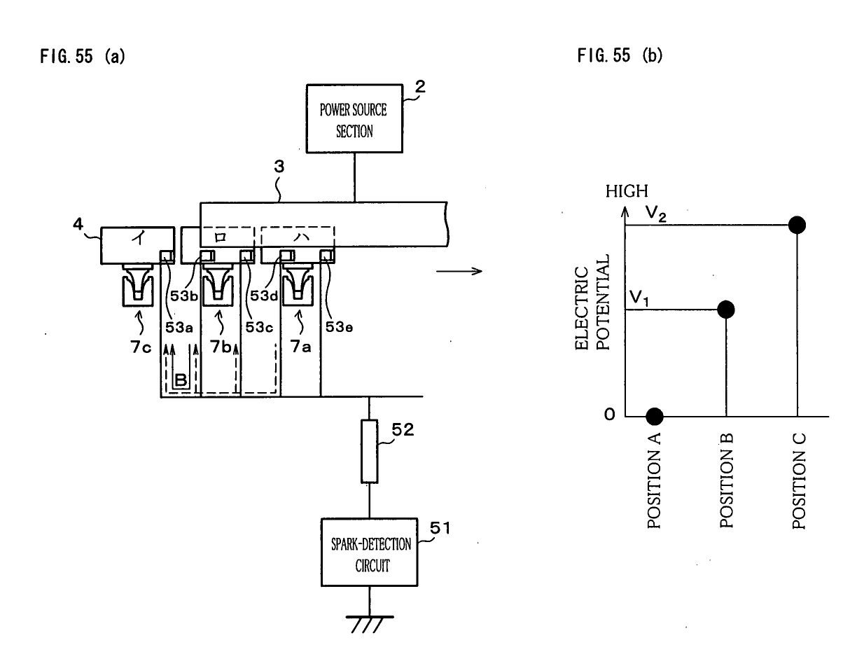

The following is more specifically described about a way to prevent an arc including the positions with a bigger potential difference. As shown in FIG. 55(a), the metal molds 7 continuously disposed in parallel, are transferred to the heating zone by the conveyer in the direction of the arrow in the figure. In FIG. 55(a), the metal molds 7a, 7b and 7c are disposed looking from the latter side, that is, the first metal mold is 7a, the second metal mold is 7b and the third metal mold is 7c in the order of movement. The position just before the heating zone is Position A, the position just after the metal molds 7 enter the heating zone is Position B, and the position just following Position B and perfectly inside the heating zone is Position C.

A potential of the metal molds 7 at Position A to C, as shown in a potential graph of FIG. 55(b), the potential becomes higher at from Position A to Position C. In other words, since the metal mold 7c at Position A does not reach the heating zone yet, high frequency is not applied from the power feeding section 3 through the power receiving section 4. Thus, the potential of the metal mold 7c is almost 1V at Position A.

However, the metal mold 7b at Position B just previous to Position A is about to enter the heating zone, where the power feeding section 3 and the power receiving section 4 are partly overlapped and high frequency starts to be applied from the power feeding section 3. Therefore, the potential of the metal mold 7b at Position B is V₁, that is, fully high.

In addition, the metal mold 7a located at Position C just previous to Position B is perfectly inside the heating zone, and the power feeding section 3 and the power receiving section 4 are perfectly overlapped and high frequency is applied from the power feeding section 3 in perfect condition. The potential of the metal mold 7a at Position C is V₂, still higher than that of the metal molds 7b at Position B.

In result, in the adjacent three metal molds 7a to 7c, the potential difference V₁ is generated between the metal molds 7c and 7b. The potential difference V₂−V₁ is generated between the metal molds 7b and 7a. This potential difference may be very high depending on an output from the power source section 2. For example, in the neighborhood of Position A, not only high frequency is fed to the spark-sensing part 53a located on the most previous position from the spark-sensing part 53b connected on the circuit, but also part of high frequency is reversibly fed to the spark-sensing part 53a from the spark-sensing part 53d (arrow B in the figure) and the spark-sensing part 53a has a higher potential since the metal mold 7a has a higher potential than the metal mold 7b. Therefore, a potential difference more than V₁ is generated between the metal mold 7c at Position A and the spark-sensing part 53a.

Accordingly, when the metal molds 7a to 7c are transferred to the inlet, the first metal mold 7a (or the next metal mold 7b) enters the heating zone. When the next metal mold 7b (or the metal mold 7c) approaches the heating zone, at the moment when the contact position of the spark-sensing part 53a on the metal mold 7b (or the metal mold 7c) contacts on the spark-sensing part 53a, a spark is generated between the spark-sensing part 53a and the contact position on the metal mold 7c with a big potential difference resulting in an arc. The same phenomenon is seen at the outlet.

Then, as shown in FIG. 41 and FIG. 44, the filters 55 for spark-sensing parts are individually provided between the spark-sensing parts 53 disposed near the inlet or the outlet and the spark-detecting circuit 51. This prevents a backflow of high frequency even if a big potential difference is generated between the adjacent metal molds 7 and 7. In result, an arc is prevented.

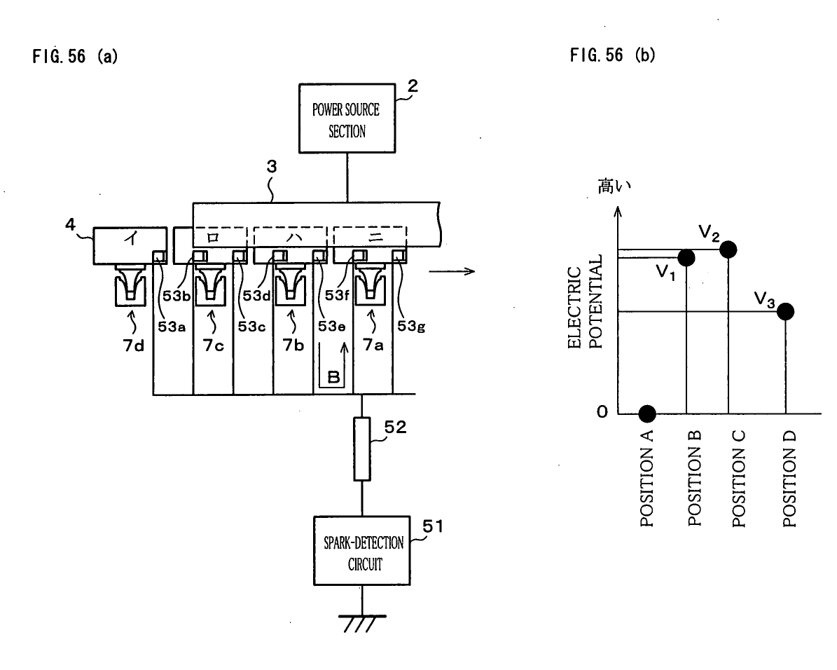

Following the condition shown in FIGS. 55(a) and (b), the metal molds 7 further go into the heating zone from the inlet and reach the initial heating position. As shown in FIG. 56(a), the first metal mold 7a already reaches Position D just following Position C. The metal molds 7b and 7c reach Position C and B, respectively, and the metal mold 7d following the metal mold 7c is moved to Position A.

Looking at a potential of the metal molds 7 at Position A to D, as shown in a potential graph of FIG. 56(b), there is a big potential difference between Position C and Position D. In the potential graphs in FIG. 55(b) and FIG. 56(b), the potential is relatively indicated to clarify a potential difference at each of the Positions for convenience of explanation, which does not show a correct relation of the values.

In FIG. 56(b), as mentioned above, the potential of the metal mold 7d at Position A is almost 0V. For the metal molds 7c and 7b at Position B and C, of course, the potential V₂ of the metal mold 7b at Position C is higher than the potential V₁ of the metal mold 7c at Position B. In this case, it is interpreted that application of high frequency goes on to some degree and there is little potential difference between Position B and C.

Simply, the metal mold 7a at Position D should have a higher potential than that of the metal mold 7b at Position C, but actually the potential V₃ is significantly lower than V₂.

This is because the raw materials used in the present invention are a starchy and watery mixture mainly containing flour and starch. Namely, the starchy and watery mixture significantly changes its property at an initial heating stage. Thus, Position B or Position C corresponding to the first stage of applying high frequency has a high potential V₁ or V₂, respectively, while Position D has a lower potential V₃ due to a rapid change in property of the raw materials.

In result, the potential difference of V₂−V₃ is generated between the metal mold 7a at Position D and the metal mold 7b at Position C. This potential difference may become larger depending on an output from the power source section 2. For example, a big potential difference of V₂−V₃ is generated between the spark-sensing part 53f located on the position corresponding to Position D and the spark-sensing part 53e located on the position corresponding to Position C just previous to Position D.

Therefore, in the process that the metal mold 7a goes from Position D further to the latter position, high frequency flows (arrow B in the figure) between the spark-sensing parts 53e and 53f connected on the circuit, at the moment when the contact position on the metal mold 7a leaves the spark-sensing part 53f. This generates a spark between the spark-sensing part 53f and the contact position on the metal mold 7a, thereby generating an arc.

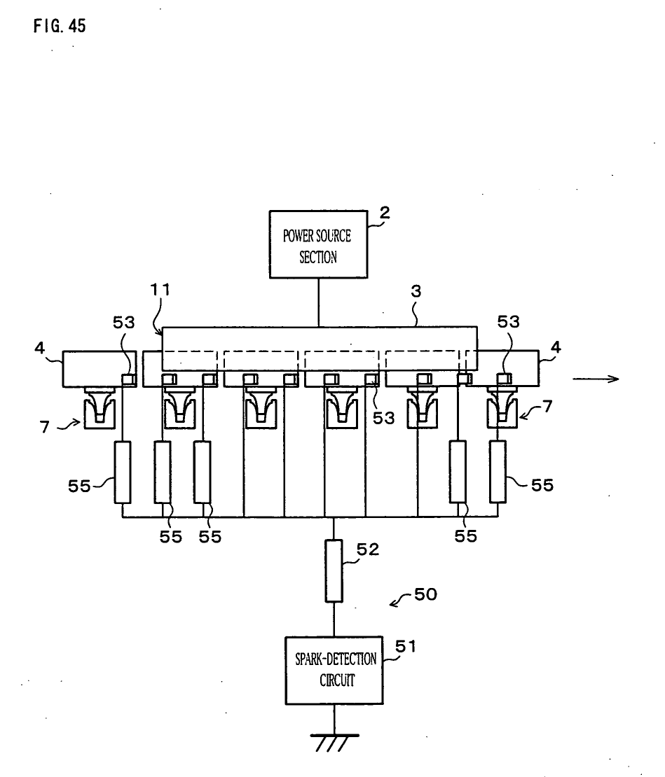

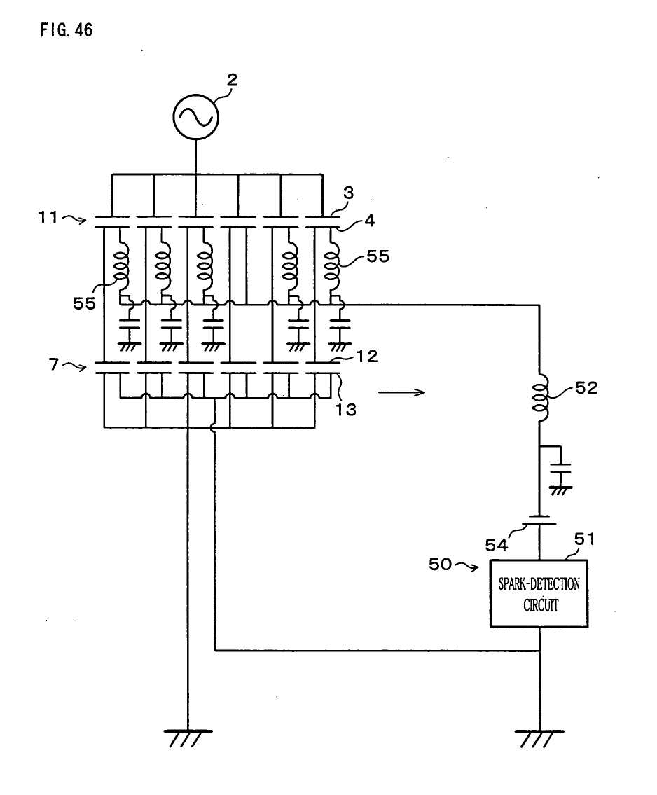

As shown in the diagrammatic illustration of FIG. 45 and in the circuit diagram of FIG. 46, it is preferable that the filters 55 for spark-sensing parts are individually provided not only for the spark-sensing parts 53 disposed in the neighborhood of the inlet or the outlet, but also between the spark-sensing parts 53 located on the position corresponding to the initial heating position and the spark-detecting circuit 51. In result, if a big potential difference is generated between the adjacent metal molds 7 and 7 as mentioned above, a backflow of high frequency is prevented, thereby preventing an arc.

FIG. 45 and FIG. 46 show almost the same structures as FIG. 41 and FIG. 44, excepting that the filters 55 for spark-sensing parts are provided for the spark-sensing parts 53 located on the position corresponding to the initial heating position, with the detailed explanation left out.

As mentioned above, in the present invention, in case that the spark-detecting part is provided for the heating apparatus to heat the continuously moving metal molds by applying high frequency, the high-frequency filters are individually provided for the spark-sensing parts located on the position where a big potential difference is generated between the adjacent metal molds, out of the spark-sensing parts contacting on the metal molds to anticipate a spark. It is thus possible to prevent high frequency from flowing between the spark-sensing parts connected on the circuit, and thereby to prevent an arc between the spark-sensing parts and the contact position of the spark-sensing parts on the metal mold.

### EMBODIMENT 9

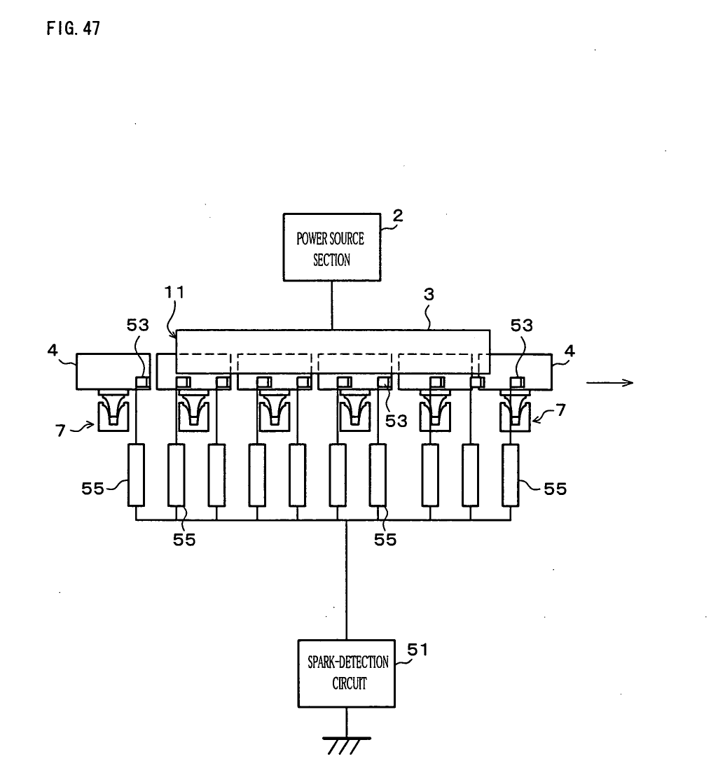

Still another embodiment of the present invention is described below referring to FIG. 47 to FIG. 50. The present invention is not limited to this embodiment. For convenience of explanation, the same numbers are shown for the members having the same function as the members used in the above embodiments 1 to 8 with the explanation left out.

In the embodiment 8, the filters 55 for spark-sensing parts are provided only for the spark-sensing parts 53 located on a position where a potential difference is generated between the adjacent metal molds 7 and 7. In this embodiment, the filters 55 for spark-sensing parts are individually provided for all the spark-sensing parts 53.

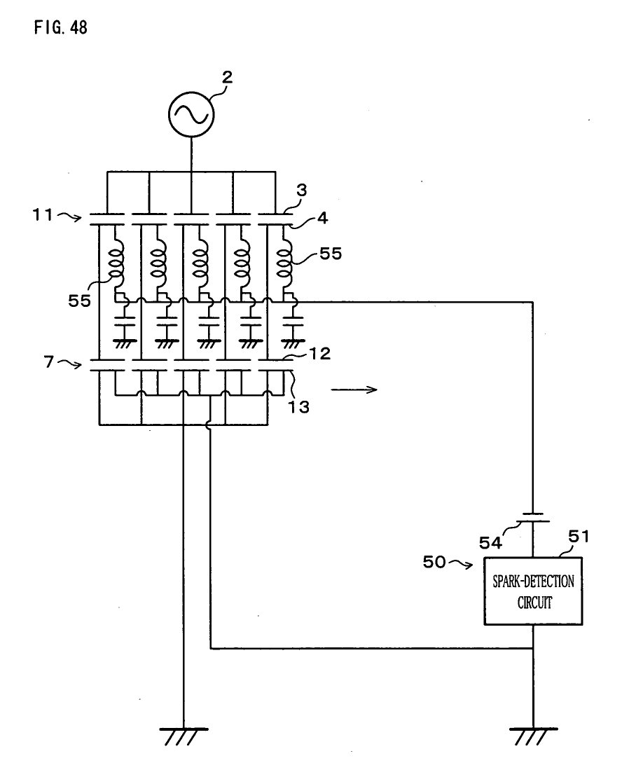

More specifically, as shown in FIG. 47 and FIG. 48, the filters 55 for spark-sensing parts are individually provided for all the spark-sensing parts 53 disposed along the moving passage. In this structure, the high-frequency filters 52 for the spark-detecting circuit 51 as shown in the embodiment 8 are not necessary.

Namely, in this embodiment, when the filters 55 for the spark-sensing parts are provided for all the spark-sensing parts 53, these filters 55 for spark-sensing parts are all connected in series with the spark-detecting circuit 51. Accordingly, the filters 55 for spark-sensing parts serve not only as a filter to cut off a flow of high frequency between the spark-sensing parts 53 and 53, but also as a filter to cut off high frequency flowing on the spark-detecting circuit 51, as the above high-frequency filter 52. Thus, it is not necessary to provide the above high-frequency filter 52.

In the above embodiment 8, the filters 55 for spark-sensing parts are provided only at the inlet, the outlet, or the initial heating position where a potential difference is likely to be generated between the metal molds 7 and 7. While this can minimize the number of filters 55 for spark-sensing parts to reduce a cost, it may be insufficient to prevent an arc more steadily in some cases, since a potential difference may be generated in the other positions.

On the other hand, in this embodiment, the filters 55 for spark-sensing parts are provided for all the spark-sensing parts 53. Even if a potential difference is generated on any of the positions between all the metal molds 7 moving in the heating zone, it is possible to prevent high frequency from flowing between the spark-sensing parts 53. In result, it is possible to prevent an arc more steadily.

For a preferable structure, it is not specifically limited to the embodiment 8 or 9 and depends on a condition in using a heating apparatus. For example, if the apparatus is very large, the structure with less spark-sensing parts 53 in the embodiment 8 is preferable since the heating zone becomes very long. If the apparatus is small, or if it is desirable to steadily restrain an arc at the spark-sensing parts 53 in the heating process, the structure of this embodiment is preferable.

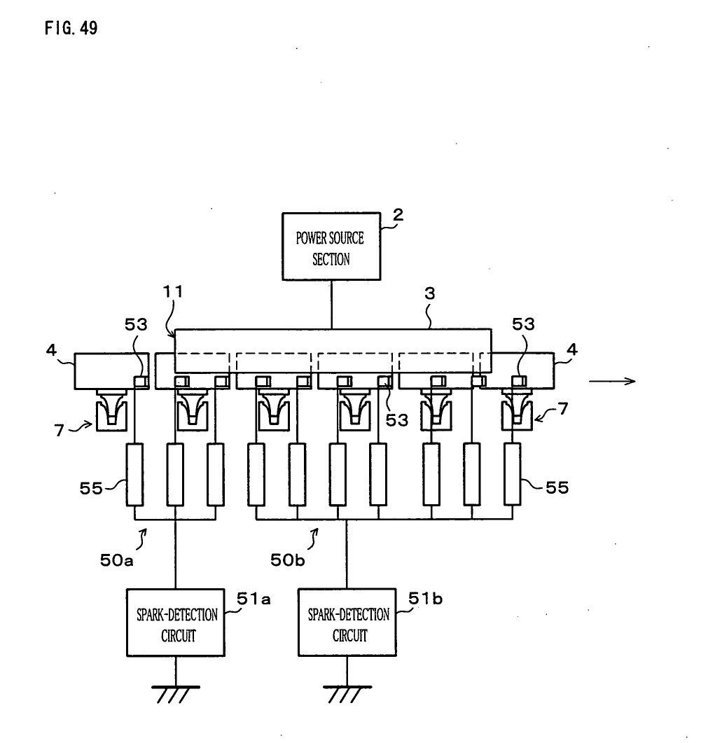

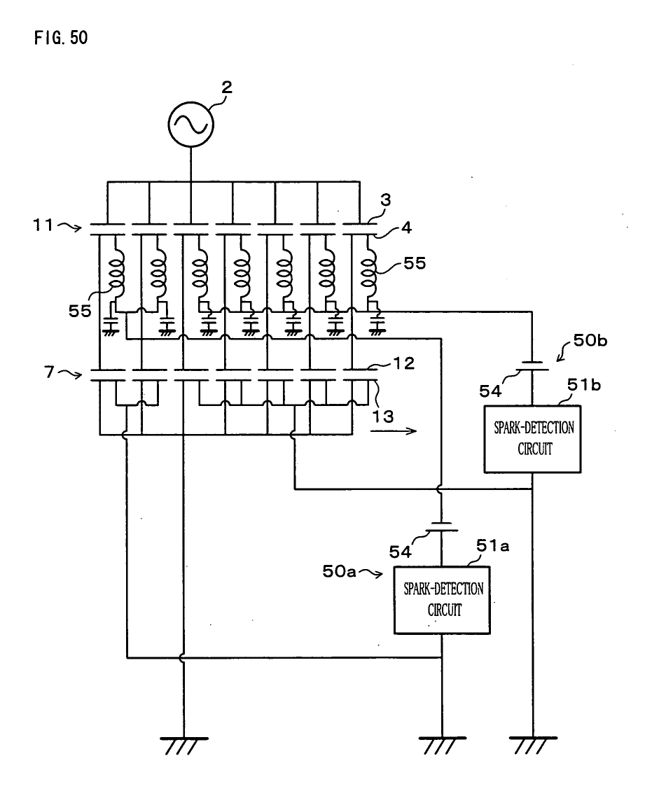

Also, in the structures shown in FIG. 47 and 48, just one spark-detecting circuit 51 (and the direct current power source section 54) is provided in the heating zone, while a plurality of spark-detecting circuits 51 may be provided as shown in FIG. 49 and FIG. 50. In FIG. 49 and FIG. 50, the spark-sensing parts 53 for the inlet and the initial heating position, and the spark-sensing parts 53 located on the other positions are independent as a first group and a second group, respectively. The spark-sensing parts 53 of the first group is connected to the spark-detecting circuit 51a constituting the first spark-detecting part 50a. The spark-sensing part 53 of the second group is connected to the spark-detecting circuit 51b constituting the second spark-detecting part 50b.

In this embodiment, as the above embodiment 8, the starchy and watery mixture is used as the raw materials. This starchy and watery mixture may contain an electrolyte such as water and salt. In this case, the above raw materials contain enough moisture at a start of heating and show a higher electrical conductivity due to the effect of electrolyte. The electrical conductivity becomes higher as the temperature rises at an initial heating stage. When moisture vapors, the electrical conductivity rapidly lowers and the raw materials finally become almost an insulator.

Therefore, in the metal molds 7 continuously moving toward the first group, the raw materials show a high electrical conductivity. It is preferable that a resistance value is set at a lower value as a parameter to anticipate a spark on a first spark-detecting circuit 51a in a first spark-detecting part 50a. On the other hand, in the second group, since the metal molds 7 pass through the initial heating position, an electrical conductivity of the raw materials lowers, substantially becoming an insulator. It is thus preferable that the above resistance value is set at a higher value on a second spark-detecting circuit 51b in a second spark-detecting part 50b.

Thus, as shown in FIG. 49 and FIG. 50, it is possible to anticipate a spark more correctly if the inlet and the initial heating position are differentiated from the others and if a condition to anticipate a spark is specified depending on a property for high frequency of the raw materials at each of the spark-detecting parts. In result, it is possible to steadily prevent high frequency from flowing between the spark-sensing parts 53 and 53, thereby preventing an arc between the contact position of the spark-sensing parts on the metal molds 7 and the spark-sensing parts 53.

Of course, a way to divide the spark-sensing parts 53 into groups is not limited to the structure that the spark-sensing parts 53 for the inlet and the initial heating position are only independent as shown in FIG. 49 and FIG. 50, as long as the positions where it is preferable to specify a different condition to anticipate a spark depending on a change in a property for high frequency of the raw materials are divided into another group.

FIG. 47 to FIG. 50 show almost the same structures as FIG. 41 and FIG. 44 to FIG. 46, excepting that the filters 55 for spark-sensing parts are provided for all the spark-sensing parts 53 and the high-frequency filters 52 for the spark-detecting circuit 51 is removed, with the detailed explanation left out.

Thus, in this embodiment, in case that the spark-detecting part is provided for a heating apparatus to heat the continuously moving metal molds by applying high frequency, the high-frequency filters are individually provided for all of the spark-sensing parts contacting on the metal molds to anticipate a spark. Since this can more steadily prevent high frequency from flowing between the spark-sensing parts connected on the circuit, it is possible to more steadily prevent an arc generated between the spark-sensing parts and the contact position on the metal molds and the spark-sensing parts.

As mentioned above, in the continuous high-frequency heating apparatus in accordance with the present invention, having heating units where objects to be heated are placed between a pair of electrodes, conveyer means which continuously transfers the heating units along a moving passage, and power feeding means for the heating area provided along the moving passage, and dielectrically heating the objects by continuously applying high-frequency alternating current to the moving heating units from the power feeding means, a spark-detecting means to anticipate a spark between the electrodes is also provided. The spark-detecting means includes the spark-sensing parts to be placed near the heating area along the moving direction of the heating units to be contacted with either of the electrodes of the moving heating units, and the high-frequency filters individually provided for each of the spark-sensing parts at least placed on the positions located corresponding to the positions where a potential difference is generated between the adjacent heating units, out of the above spark-sensing parts.

In the above structure, it is possible to prevent high-frequency alternating current from flowing between the spark-sensing parts connected on the circuit, thereby preventing an arc generated at the moment when the spark-sensing parts contact on or leave the contact position of the spark-sensing parts on the heating units. In result, it is possible to effectively prevent malfunctioned detection of a spark or damages on the spark-sensing parts.

Further to the above structure, in the continuous high-frequency heating apparatus in accordance with the present invention, the position where a potential difference is generated, include an inlet located at the first position and an outlet located at the last position, looking from the moving direction of the heating units in the heating area.

At the inlet or the outlet, high frequency alternating current is applied to some heating units though it is not applied yet or is completed to other heating units, between the adjacent heating units. Therefore, a big potential difference is likely to be generated between these heating units. In the above structure, by providing the high-frequency filters with each of the spark-sensing parts disposed in the above positions, it is possible to more steadily prevent high frequency from flowing between the spark-sensing parts, thereby preventing an arc generated at the moment when the spark-sensing parts contact on or leave the contact position on the heating units.

Further to the above structure, in the continuous high-frequency heating apparatus in accordance with the present invention, the above positions where a potential difference is generated includes a position where a property for high frequency of the raw materials changes rapidly with a heating process by applying high frequency.

In the position where a property for high frequency of the objects to be heated changes rapidly, if high-frequency alternating current is applied in the same way, a potential difference is likely to be generated between the adjacent heating units. However, in the above structure, by individually providing the high-frequency filters with each of the spark-sensing parts located in these areas, it is possible to more steadily prevent high-frequency alternating current from flowing between the spark-sensing parts, thereby preventing an arc generated at the moment when the spark-sensing parts contact on or leave the contact position on the heating units.

Further to the above structure, the continuous high-frequency heating apparatus in accordance with the present invention is constructed so that the high-frequency filters are individually provided for all of the above spark-sensing parts.

In the above structure, since the high-frequency filters are provided not only for the positions where a potential difference is likely to be generated, but also for all the spark-sensing parts, it is possible to more steadily prevent high-frequency alternating current from flowing between the spark-sensing parts connected on the circuit. Therefore, it is possible to more steadily prevent an arc generated at the moment when the spark-sensing parts contact on or leave the contact position on the heating units.

Further to the above structure, in the continuous high-frequency heating apparatus in accordance with the present invention, the above spark-sensing parts are divided into groups based on the above positions where a potential difference is generated, and the spark-detecting means is provided for each of the groups.

In the above structure, it is possible to change conditions to anticipate a spark by dividing into groups by the group-depending on a change in a property for high frequency of the objects to be heated. Therefore, it is possible to steadily prevent high-frequency alternating current from flowing between the spark-sensing parts. It is thus possible to more steadily prevent an arc generated at the moment when the spark-sensing parts contact on or leave the contact position on the heating units and to anticipate a spark more correctly by setting a sensitivity to anticipate a spark suitable for each of the groups.

Further to the above structure, in the continuous high-frequency heating apparatus in accordance with the present invention, the above spark-detecting means includes a direct current power source section to apply direct current between a pair of electrodes. The spark-detecting means checks for electrification from a resistance value between the above electrodes where direct current is applied in order to anticipate a spark based on the electrification.

In the above structure, a resistance value between the electrodes is measured based on direct current applied therein. If the resistance value is beyond the standard value, it is determined that there is no electrification. If the resistance value is below the standard value, it is determined that there is any electrification. In addition, it is possible to anticipate a spark by monitoring a change in the resistance value, thereby preventing a spark. Thus, it does not just monitor any electrification, but it is possible to anticipate and prevent a spark more steadily with a simple structure by using the resistance value as a parameter.

Further to the above structure, in the continuous high-frequency heating apparatus in accordance with the present invention, the electrodes are electrically conductive molds and the objects to be heated are the raw materials for molding.

In the above structure, since the continuous high-frequency heating apparatus in accordance with the present invention is used for manufacturing molded articles by heating and molding, it is possible to produce high quality molded articles with high production efficiency.

Further to the above structure, in the continuous high-frequency heating apparatus in accordance with the present invention, the starchy and watery mixture having fluidity and plasticity containing starch and water are used as the raw materials, and baked and molded articles are molded by dielectrically heating the raw materials.

In the above structure, in case that the baked and molded articles are manufactured by heating and molding the starchy and watery mixture containing starch and water, the continuous high-frequency heating apparatus in accordance with the present invention is used and high quality baked and molded articles can be manufactured with high production efficiency.

In the above structure of the continuous high-frequency heating apparatus in accordance with the present invention, flour is used for the starchy and watery mixture as starch, and the above baked and molded articles are molded confectioneries mainly containing flour.

In the above structure, in case that the starchy and watery mixture using flour as starch is baked to make edible containers and molded and baked confectioneries such as cookies and biscuits, the continuous high-frequency heating apparatus in accordance with the present invention is used and high quality baked confectioneries are manufactured with high production efficiency.

Further to the above structure, in the continuous high-frequency heating apparatus in accordance with the present invention, the above power feeding means is shaped like a rail continuously disposed along the heating area in the moving passage. The above electrodes include the feeder electrode receiving power supply from the power feeding means and the grounding electrode grounded to the earth. In addition, the above feeder electrode is equipped with the power receiving section receiving alternating current with no contact from the rail-shaped power feeding means.

In the above structure, the rail-shaped power feeding means is provided in the heating area and the power receiving means is provided in correspondence to the above power feeding means. After the heating units enter into the heating area by the moving means, the heating units equipped with the power receiving means move along the rail-shaped power feeding means with the movement of the moving means. Therefore, it is possible to smoothly and steadily continue a heating and drying process until the heating units pass through the heating area, that is, until the power receiving means takes off the power feeding means.

As mentioned above, in the continuous high-frequency heating method in accordance with the present invention, having the heating units where the objects to be heated are placed between a pair of electrodes, continuously transferring the heating units along the moving passage, and dielectrically heating the objects by continuously applying high-frequency alternating current with no contact to the moving heating units from the heating area provided along the moving passage, a spark between the above electrodes are anticipated by the spark-sensing parts disposed in the neighborhood of the heating area along the moving direction of the heating units, and by the spark-detecting means including the high-frequency filters individually provided for the spark-sensing parts disposed at least on the positions where a potential difference is generated between the adjacent heating units.

In the above method, it is possible to prevent high-frequency alternating current from flowing between the spark-sensing parts connected on the circuit, which can prevent an arc generated at the moment when the spark-sensing parts contact on or leave the contact position on the heating units. In result, it is possible to effectively prevent malfunctioned detection of a spark and damages on the spark-sensing parts.

The embodiments or examples shown in “Description of the preferred embodiments” are intended to disclose technical information on the present invention, and it should not be interpreted that the present invention is limited to these examples or embodiments in narrow sense. The present invention can be executed by making various changes within the range-of the claims described below under the sprit of the present invention.

Industrial Applicability

Thus, the present invention can effectively restrain or prevent concentration of high frequency when continuously moving objects to be heated are heated through high-frequency heating in a large-scale apparatus to perform efficient and safety heating. Accordingly, as mentioned above, the present invention can be used in the field of continuously manufacturing baked and molded articles, more specifically, in various food industries manufacturing edible containers and molded and baked confectioneries, as well as cooking, heat sterilization, defrosting of frozen foods and materials, heat maturation and cure (for defrosting thick foods and materials); in the wood processing industry including drying wood, heat bonding and heat pressing; in various material industries including resinification, such as dissolution, melting and bonding, and molding of resin and production of biodegradable molded articles.

1. A method for manufacturing heated and molded articles, comprising the steps of:
feeding raw materials in electrically conductive molds;
continuously transferring the molds along a moving passage; and
dielectrically heating and molding the raw materials by continuously applying high-frequency alternating current to the moving molds with no contact in a heating area provided along the moving passage,
the heating area being divided into sub-areas, each of which has at least power source means and power feeding means.

2. The method for manufacturing heated and molded articles according to claim 1,
wherein the high-frequency alternating current is applied to the molds by rail-shaped power feeding means continuously disposed along the moving passage in the sub-areas, and
each of the molds is equipped with power receiving means for receiving the high-frequency alternating current with no contact from the rail-shaped power feeding means.

3. The method for manufacturing heated and molded articles, according to claim 2,
wherein the power receiving means is shaped like a plate,
the rail-shaped power feeding means has a surface opposite to the power receiving means, and
high-frequency alternating current is applied with no contact by placing the plate-shaped power receiving means opposite to the surface.

4. The method for manufacturing heated and molded articles according to claim 3, wherein the rail-shaped power feeding means or power receiving means is constructed so that an area where the rail-shaped power feeding means and the power receiving means oppose each other is changed along the moving passage of the molds to change a level of high-frequency alternating current applied to the molds through the power receiving means.

5. The method for manufacturing heated and molded articles according to claim 4, wherein the rail-shaped power feeding means is constructed so that the area is changed along the moving passage.

6. The method for manufacturing heated and molded articles according to claim 3, wherein the rail-shaped power feeding means is constructed so that a distance between the rail-shaped power feeding means and the power receiving means is changed along the moving passage of the molds to change a level of high-frequency alternating current applied to the molds through the power receiving means.

7. The method for manufacturing heated and molded articles according to claim 1, wherein a length of each of the sub-areas is determined so that a rate of variation of the continuously moving molds to be heated in the entire sub-area is less than 0.5.

8. The method for manufacturing heated and molded articles according to claim 7, wherein the length is determined so that the rate of variation is less than 0.1 in case that one of the sub-areas corresponds to either an initial stage or a last stage of heating the raw materials.

9. The method for manufacturing heated and molded articles according to claim 1, wherein each of the molds comprises a plurality of mold halves which can be divided into a feeder electrode block receiving power supply from the power feeding means and a grounding electrode block grounded to the earth, and each of the blocks is insulated from each other.

10. The method for manufacturing heated and molded articles according to claim 9, wherein each of the molds is a united mold integrating a plurality of molds.

11. The method for manufacturing heated and molded articles according to claim 1, wherein both dielectric heating by applying high-frequency alternating current and external heating by external heating means are used at least in part of the heating area.

12. The method for manufacturing heated and molded articles according to claim 1, wherein the heating area further includes an application suspension zone where no high-frequency alternating current is applied.

13. The method for manufacturing heated and molded articles according to claim 12, wherein the application suspension zone included in the heating area is provided-in an area corresponding to at least either an initial stage or a last stage of heating the raw materials.

14. The method for manufacturing heated and molded articles according to claim 1, wherein conditions of applying high-frequency alternating current to the molds in each of the sub-areas are differently specified.

15. The method for manufacturing heated and molded articles according to claim 14, wherein the conditions include at least one of the conditions; an output of high-frequency alternating current in each of the sub-areas, an output of high-frequency alternating current applied to each of the molds, and a length of each of the sub-areas.

16. The method for manufacturing heated and molded articles according to claim 14, wherein the conditions are specified depending on properties of the raw materials which changes by applying high-frequency alternating current.

17. The method for manufacturing heated and molded articles according to claim 1,
wherein a starchy and watery mixture including at least starch and water and having fluidity or plasticity is used as the raw materials, and
baked and molded articles are made as heated and molded articles.

18. The method for manufacturing heated and molded articles according to claim 17, wherein flour is used as starch in the starchy and watery mixture, and
the baked and molded articles are molded and baked confectioneries mainly containing flour.

19. The method for manufacturing heated and molded articles according to claim 1, wherein a conveyer rotatably stretched by axes is used as moving means.

20. A continuous high-frequency heating apparatus comprising:
a heating unit where the objects to be heated is placed between a pair of electrodes,
moving means continuously transferring heating units along a moving passage,
power feeding means provided along the moving passage,
wherein the objects to be heated are dielectrically heated by continuously applying high-frequency alternating current to the moving heating units from the power feeding means, and
further comprising a plurality of power feeding means, each of which has power source means, and
making a heating area by continuously disposing the power feeding means.

21. The continuous high-frequency heating apparatus according to claim 20, wherein the power feeding means apply high-frequency alternating current to the heating units with no contact.

22. The continuous high-frequency heating apparatus according to claim 21, wherein the power feeding means is shaped like a rail continuously disposed along the heating area of the moving passage, and
the heating units are equipped with power receiving means to receive alternating current from the rail-shaped power feeding means with no contact.

23. The continuous high-frequency heating apparatus according to claim 22,
wherein the power receiving means is shaped like a plate,
the rail-shaped power feeding means has a surface opposite to the power receiving means, and
high-frequency alternating current is applied with no contact by placing the plate-shaped power receiving means opposite to the surface.

24. The continuous high-frequency heating apparatus according to claim 23, wherein the rail-shaped power feeding means or the power receiving means is constructed so that an area between the opposite surfaces is changed along the moving passage of the heating units to change a level of high-frequency alternating current applied to the heating units through the power receiving means.

25. The continuous high-frequency heating apparatus according to claim 24, wherein the rail-shaped power feeding means is constructed so that the area between the opposite surfaces is changed along the moving passage.

26. The continuous high-frequency heating apparatus according to claim 23, wherein the rail-shaped power feeding means is constructed so that the opposite distance is changed along the moving passage of the heating units to change a level of the high-frequency alternating current applied to the heating units through the power receiving means.

27. The continuous high-frequency heating apparatus according to claim 20, wherein a length of the power feeding means is determined so that a rate of variation of the continuously moving heating units heated by the entire power feeding means is less than 0.5.

28. The continuous high-frequency heating apparatus according to claim 27, wherein the length of the power feeding means is further determined so that the rate of variation of the continuously moving heating units may be less than 0.1 in case that the power feeding means are disposed in the heating area corresponding to at least either an initial heating stage or a last heating stage in the heating area.

29. The continuous high-frequency heating apparatus according to claim 22, wherein a pair of electrodes have the power receiving means, consisting of a power feeder electrode receiving power supply from the power feeding means and a grounding electrode grounded to the earth insulated from each other.

30. The continuous high-frequency heating apparatus according to claim 20, wherein the heating area includes an application suspension zone where no high-frequency alternating current is applied.

31. The continuous high-frequency heating apparatus according to claim 30, wherein the application suspension zone included in the heating area is provided corresponding to at least either an initial heating stage or a last heating stage in the heating area.

32. The continuous high-frequency heating apparatus according to claim 20, wherein a conveyer rotatably stretched by axes is used as the moving means.

33. A continuous high-frequency heating apparatus comprising:
heating units where the objects to be heated are placed between a pair of electrodes,
moving means continuously transferring the heating units along a moving passage,
power feeding means disposed corresponding to a heating area provided along the moving passage,
wherein the objects to be heated are dielectrically heated by continuously applying high-frequency alternating current to the moving heating units from the power feeding means with no contact, and
further comprising spark-detecting means to anticipate a spark between the electrodes,
the spark-detecting means include a spark-sensing part disposed near the heating area along the moving direction of the heating units so as to contact on either of the electrodes in the moving heating units, and
a high-frequency filter for the spark-sensing part individually provided for the spark-sensing parts disposed corresponding to a position where a potential difference is generated between adjacent heating units, out of the spark-sensing parts.

34. The continuous high-frequency heating apparatus according to claim 33, wherein the position includes an inlet located in the most precedent area looking from the moving direction of the heating units in the heating area and an outlet located in the most subsequent area looking from the moving direction of the heating units in the heating area.

35. The continuous high-frequency heating apparatus according to claim 33, wherein the position further includes a part where a property for high frequency alternating current of the objects to be heated changes significantly with the progress of heating by applying high-frequency alternating current.

36. The continuous high-frequency heating apparatus according to claim 33, wherein the high-frequency filters are individually provided for all the spark-sensing parts.

37. The continuous high-frequency heating apparatus according to claim 33, wherein the spark-sensing parts are divided into groups based on the positions, each of the groups has the spark-detecting means.

38. The continuous high-frequency heating apparatus according to claim 33, wherein the spark-detecting means further includes a direct current power source section to apply direct current between a pair of electrodes,
wherein the spark-detecting means checks for electrification by a resistance value between the electrodes to which direct current is applied and anticipate a spark by checking for electrification.

39. The continuous high-frequency heating apparatus according to claim 33, wherein the electrodes are electrically conductive molds and the objects to be heated are raw materials.

40. The continuous high-frequency heating apparatus according to claim 39, wherein a starchy and watery mixture containing at least starch and water and having fluidity or plasticity is used as the raw materials, and
baked and molded articles are molded by dielectrically heating the raw materials.

41. The continuous high-frequency heating apparatus according to claim 40, wherein flour is used as starch for the starchy and watery mixture, and
the baked and molded articles are molded and baked confectioneries mainly containing flour.

42. The continuous high-frequency heating apparatus according to claim 33, wherein the power feeding means is shaped like a rail continuously disposed along the heating area of the moving passage, and
the electrodes include the power feeder electrode receiving power supply from the power feeding means and the grounding electrode grounded to the earth, and
the power feeder electrode is provided for the power receiving means for the power feeder electrode to receive alternating current with no contact from the rail-shaped power feeding means.

43. A continuous high-frequency heating apparatus:
wherein heating units where objects to be heated are placed between a pair of electrodes are- continuously transferred along a moving passage and dielectrically heated by continuously applying high-frequency alternating current to moving heating units with no contact from a heating area provided along the moving passage, and
a spark between the electrodes is anticipated by spark-sensing parts disposed near the heating area along the moving direction of the heating units to contact on either of the electrodes in the moving heating units, and spark-detecting means including a high-frequency filter individually provided for the spark-sensing parts disposed corresponding to a position where a potential difference is generated between adjacent heating units, out of the spark-sensing parts.
